(19) United States
(12) Patent Application Publication
(10) Pub. No.: US 2025/0113362 A1
(43) Pub. Date: Apr. 3, 2025

(54) UE INITIATED REPORTING

(71) Applicant: Samsung Electronics Co., Ltd., Suwon-si (KR)

(72) Inventors: Emad Nader Farag, Flanders, NJ (US); Dalin Zhu, Allen, TX (US); Eko Onggosanusi, Coppell, TX (US); Md. Saifur Rahman, Plano, TX (US); Gilwon Lee, McKinney, TX (US)

(21) Appl. No.: 18/890,185

(22) Filed: Sep. 19, 2024

Related U.S. Application Data
(60) Provisional application No. 63/542,215, filed on Oct. 3, 2023.

(51) Int. Cl. H04W 72/21; H04W 72/23

(52) U.S. Cl. CPC H04W 72/21; H04W 72/23

(57) ABSTRACT

Methods and apparatuses for user equipment (UE)-initiated reporting. A method of operating a user equipment (UE) includes transmitting a first uplink (UL) signal, receiving, in response to the first UL signal, a first downlink (DL) signal indicating resources for a second DL signal, and a second UL signal, and receiving the second DL signal based on the indicated resources for the second DL signal. The method further includes measuring the second DL signal, determining a report based on the measurement, and transmitting the report based on the indicated resources for the second UL signal. The second UL signal is a physical UL shared channel (PUSCH) or a physical uplink control channel (PUCCH).

### CROSS-REFERENCE TO RELATED AND CLAIM OF PRIORITY

The present application claims priority under 35 U.S.C. § 119 (e) to U.S. Provisional Patent Application No. 63/542,215 filed on Oct. 3, 2023, which is hereby incorporated by reference in its entirety.

### TECHNICAL FIELD

The present disclosure relates generally to wireless communication systems and, more specifically, the present disclosure relates to methods and apparatuses for user equipment (UE)-initiated reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated reporting.

In one embodiment, a UE is provided. The UE includes a transceiver configured to transmit a first uplink (UL) signal, receive, in response to the first UL signal, a first downlink (DL) signal indicating resources for a second DL signal and a second UL signal, and receive the second DL signal based on the indicated resources for the second DL signal. The UE further includes a processor operably coupled to the transceiver. The processor is configured to measure the second DL signal and determine a report based on the measurement. The transceiver is further configured to transmit the report based on the indicated resources for the second UL signal. The second UL signal is a physical UL shared channel (PUSCH) or a physical uplink control channel (PUCCH).

In another embodiment, a base station (BS) is provided. The BS includes a transceiver configured to receive a first UL signal and a processor operably coupled to the transceiver. The processor is configured to determine, in response to the first UL signal, resources for a second DL signal and a second UL signal. The transceiver is further configured to transmit a first DL signal indicating the resources for the second DL signal and the second UL signal, transmit the second DL signal based on the indicated resources for the second DL signal, and receive a report about the second DL signal based on the indicated resources for the second UL signal. The second UL signal is a PUSCH or a PUCCH.

In yet another embodiment, a method of operating a UE is provided. The method includes transmitting a first UL signal, receiving, in response to the first UL signal, a first DL signal indicating resources for a second DL signal, and a second UL signal, and receiving the second DL signal based on the indicated resources for the second DL signal. The method further includes measuring the second DL signal, determining a report based on the measurement, and transmitting the report based on the indicated resources for the second UL signal. The second UL signal is a PUSCH or a PUCCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of example higher level signaling according to embodiments of the present disclosure;

FIG. 8 illustrates a flowchart of an example procedure for UE configuration according to embodiments of the present disclosure;

FIG. 9 illustrates a flowchart of an example procedure for configuring a periodic reference signal (RS) according to embodiments of the present disclosure;

FIG. 10 illustrates a flowchart of an example procedure for configuring a semi-persistent RS according to embodiments of the present disclosure;

FIG. 11 illustrates a flowchart of an example procedure for configuring an aperiodic RS according to embodiments of the present disclosure;

FIG. 12 a flowchart of an example procedure for UE configuration according to embodiments of the present disclosure;

FIG. 13 illustrates a flowchart of an example procedure for configuring a periodic reference signal (RS) according to embodiments of the present disclosure;

FIG. 14 illustrates a flowchart of an example procedure for configuring semi-persistent (SP) RS according to embodiments of the present disclosure;

FIG. 15 illustrates a flowchart of an example procedure for configuring an aperiodic RS according to embodiments of the present disclosure;

FIG. 16 illustrates a flowchart of an example procedure for UE-initiated reporting according to embodiments of the present disclosure;

FIG. 17 illustrates a flowchart of an example procedure for signal exchange according to embodiments of the present disclosure;

FIGS. 18A, 18B, 18C, and 18D illustrate timelines for an example scheduling request (SR) response and SR retransmission according to embodiments of the present disclosure;

FIG. 19 illustrates a flowchart of an example procedure for UE-initiated reporting according to embodiments of the present disclosure;

FIG. 20 illustrates a flowchart of an example procedure for UE-initiated reporting according to embodiments of the present disclosure;

FIG. 21 illustrates a flowchart of an example procedure for UE-initiated reporting according to embodiments of the present disclosure;

FIG. 22 illustrates a flowchart of an example procedure for UE-initiated reporting according to embodiments of the present disclosure;

FIG. 23 illustrates timelines for parameter updates based on a UE report according to embodiments of the present disclosure;

FIG. 24 illustrates timelines for parameter updates based on a UE report according to embodiments of the present disclosure;

FIG. 25 illustrates timelines for parameter updates based on a UE report according to embodiments of the present disclosure;

FIG. 26 illustrates timelines for parameter updates based on a UE report according to embodiments of the present disclosure;

FIG. 27 illustrates timelines for parameter updates based on a UE report according to embodiments of the present disclosure;

FIG. 28 illustrates timelines for parameter updates based on a UE report according to embodiments of the present disclosure;

FIG. 29 illustrates timelines for parameter updates based on a UE report according to embodiments of the present disclosure;

FIG. 30 illustrates timelines for parameter updates based on a UE report according to embodiments of the present disclosure;

FIGS. 31A, 31B, and 31C illustrate timelines for example response(s) to a scheduling request (SR) according to embodiments of the present disclosure;

FIGS. 32A, 32B, and 32C illustrate timelines for example response(s) to a SR according to embodiments of the present disclosure;

FIGS. 33A, 33B, and 33C illustrate timelines for example response(s) to a SR according to embodiments of the present disclosure;

FIGS. 34A, 34B, and 34C illustrate timelines for example response(s) to a SR according to embodiments of the present disclosure; and

FIGS. 35A, 35B, and 35C illustrate timelines for example response(s) to a SR according to embodiments of the present disclosure.

### DETAILED DESCRIPTION

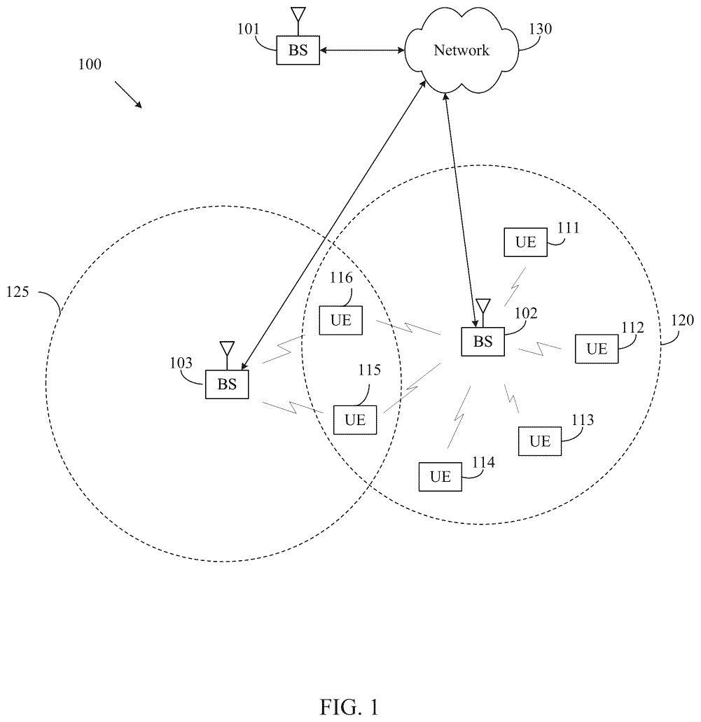

FIGS. 1-35C, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v18.3.0, “NR; Physical channels and modulation;” [2] 3GPP TS 38.212 v18.3.0, “NR; Multiplexing and Channel coding;” [3] 3GPP TS 38.213 v18.3.0, “NR; Physical Layer Procedures for Control;” [4] 3GPP TS 38.214 v18.3.0, “NR; Physical Layer Procedures for Data;” [5] 3GPP TS 38.321 v18.2.0, “NR; Medium Access Control (MAC) protocol specification;” [6] 3GPP TS 38.331 v18.2.0, “NR; Radio Resource Control (RRC) Protocol Specification;” and [7] 3GPP RP-202024, “Revised WID: Further enhancements on MIMO for NR.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UE-initiated reporting. In certain embodiments, one or more of the BSs 101-103 include circuitry, programing, or a combination thereof to support or handle UE-initiated reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

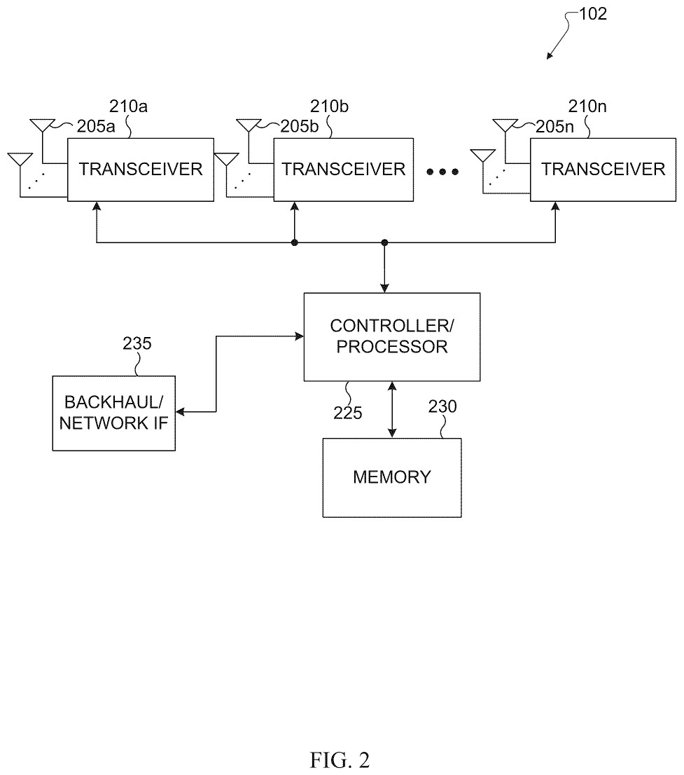

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting or handling UE-initiated reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

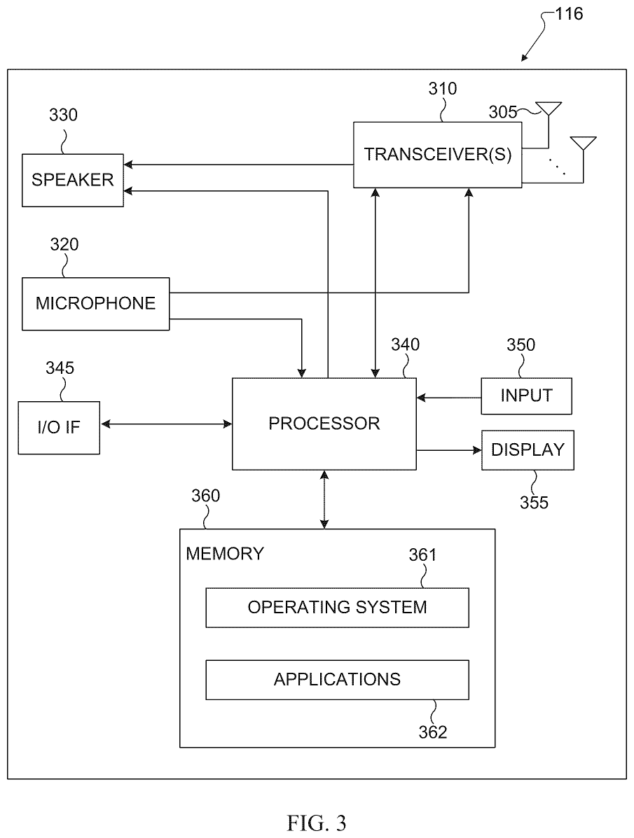

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform UE-initiated reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

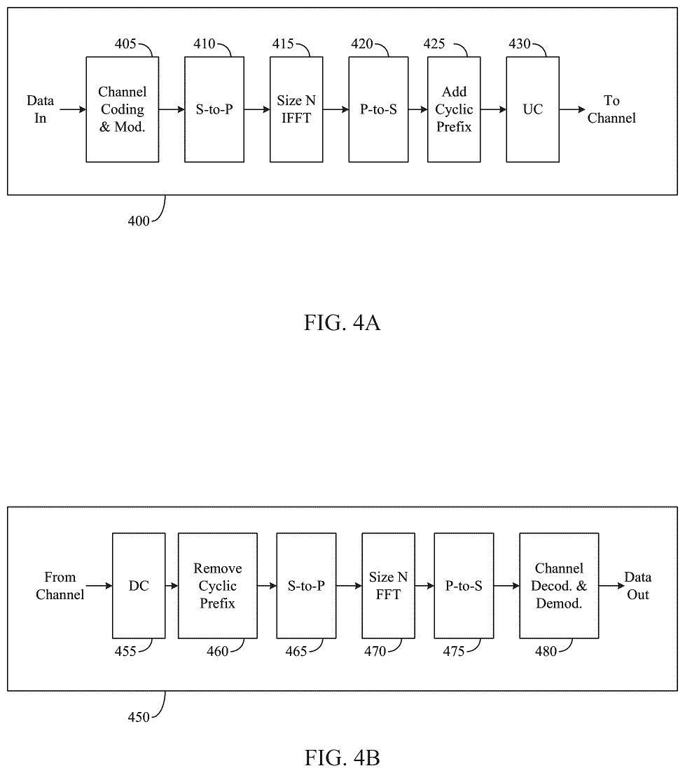

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support UE-initiated reporting as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

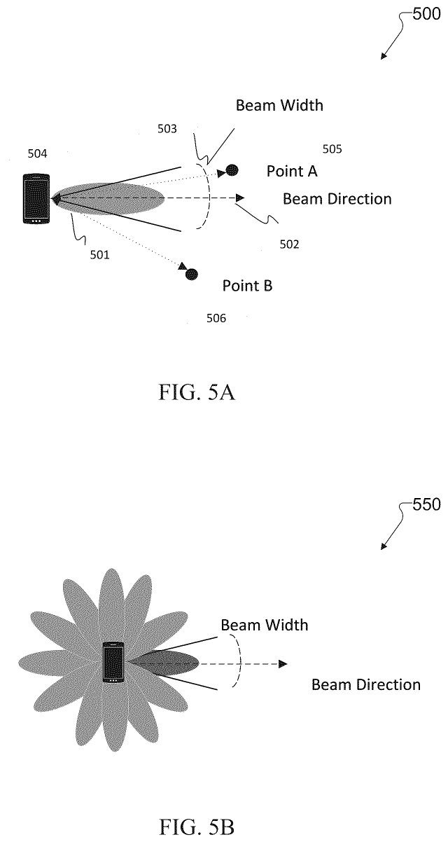

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

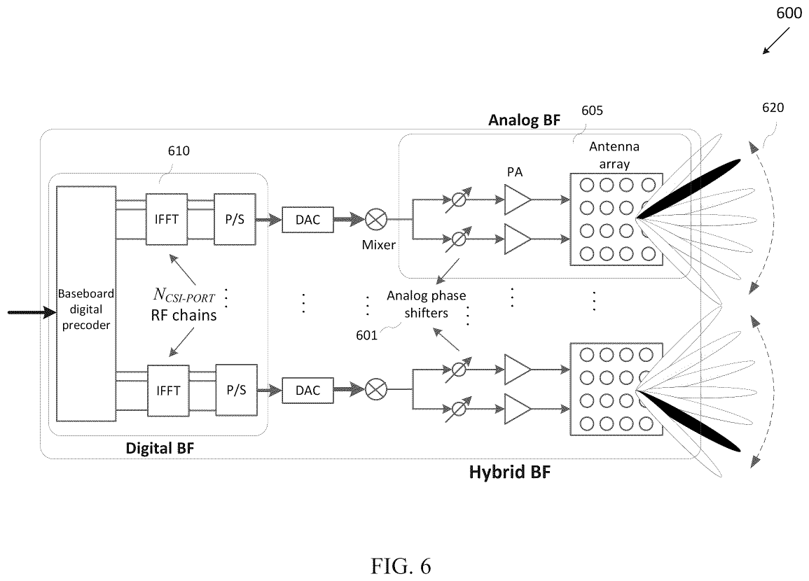

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of;
A transmission configuration indication (TCI) state, that establishes a quasi-colocation (QCL) relationship between a source reference signal (e.g. synchronization signal block (SSB) and/or CSI-RS) and/or sounding reference signal (SRS) and a target reference signal
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214 [REF4]-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and a source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicate) TCI state applies at least to UE dedicated DL and UL channels. The unified (master or main or indicated) TCI can also apply to other DL and/or UL channels and/or signals e.g. non-UE dedicated channel and SRS.

A UE (e.g., the UE 116) is indicated a TCI state by MAC CE when the CE activates one TCI state code point. The UE applies the TCI state code point after a beam application time from the corresponding hybrid automatic repeat request acknowledgement (HARQ-ACK) feedback. An UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI Format can be with a DL assignment or without a DL assignment. A TCI state (TCI state code point) indicated in a DL related DCI format is applied after a beam application time from the corresponding HARQ-ACK feedback.

In this disclosure, UE-initiated reporting is provided. Covering aspects related to acknowledgment of a UE initiated report and timing aspects related to application of parameters based on the UE initiated report at a UE and a base station. Acknowledgement can be for pre-notification channel/signal from the UE or for the UE-initiated report.

In release 15/16 a common framework is shared for CSI and beam management, while the complexity of such framework is justified for CSI in FR1, it makes beam management procedures rather cumbersome, and less efficient in FR2. Efficiency here refers to overhead associated with beam management operations and latency for reporting and indicating new beams.

Furthermore, in release 15 and release 16, the beam management framework is different for different channels. This increases the overhead of beam management, and could lead to less robust beam-based operation. For example, for PDCCH the TCI state (used for beam indication), is updated through MAC CE signaling. While the TCI state of PDSCH can be updated through a DL DCI carrying the DL assignment with codepoints configured by MAC CE, or the PDSCH TCI state can follow that of the corresponding PDCCH, or use a default beam indication. In the uplink direction, the spatialRelationInfo framework is used for beam indication for PUCCH and SRS, which is updated through RRC and MAC CE signaling. For PUSCH the SRS resource indicator (SRI), in an UL DCI with UL grants, can be used for beam indication. Embodiments of the present disclosure recognize that having different beam indications and beam indication update mechanisms increases the complexity, overhead and latency of beam management, and could lead to less robust beam-based operation.

Rel-17 introduced the unified TCI framework, wherein a unified or master or main or indicated TCI state is signaled to the UE. RRC signaling configures Rel-17 TCI states (TCI-state_r17). MAC signaling can activate one or more TCI codepoints. When one TCI state codepoint is activated by MAC CE, the UE applies the TCI state(s) associated with the activated codepoint after a beam application time. When more than one TCI codepoints are activated by MAC CE, further DCI signaling is used to indicate a TCI state codepoint to the UE. The unified TCI state can be signaled by a DCI Format (e.g., DL related DCI Format (e.g., DCI Format 1_1 or DCI Format 1_2) with a DL assignment or a DL related DCI Format (e.g., DCI Format 1_1 or DCI Format 1_2) without a DL assignment.

For UE measurement and reporting, the network (e.g., the network 130) can configure and/or activate and/or trigger a reference signal (RS) that is transmitted by the network and measured by the UE or an RS that is transmitted by the UE and measured by the network. The network can also configure and/or activate and/or trigger the channel used to report the measurement performed by the UE to the network. In some cases, such operation can lead to additional latency, as the UE has to wait for the network to configure and/or activate and/or trigger the RS and/or channel for reporting the measurement. In some cases, such operation can lead to additional overhead as resources are being configured for the measurement RS and/or channel for reporting measurement, when the report has not changed between consecutive instances of reporting leading to inefficient utilization of air interface resources.

To mitigate, the previously mentioned, latency and/or overhead issues, UE initiated measurement and reporting is provided. In various embodiments, the procedure for UE initiated measurement and/or reporting includes the following steps:
In one step, the UE can send a pre-notification or request signal to the gNB.
In another step, the network can respond with signal providing resources and configuration for transmission of a report that includes measurements performed by the UE.
In another step, the UE provides a report.
In another step, the UE and/or the base station can apply or update a parameter based on the report. In some scenarios, the timing of the application of the report should be aligned at the UE and the base station.

In this disclosure the acknowledgment of a UE initiated report is taken into account. The acknowledgment can be for the pre-notification channel/signal and/or for the channel or signal carrying a UE initiated report. In some scenarios, one or more parameters can be updated based on the UE initiated report, at the UE and the base station for example, the TCI state used for downlink and/or uplink channels or signals can be updated based on the UE initiated report. In some scenarios, the update of the one or more parameters should be aligned between the UE and base station. In this disclosure, aspects related to the timing of parameter update based on a UE initiated report are also evaluated.

The present disclosure relates to a 5G/NR communication system.

This disclosure evaluates aspects related to UE initiated reporting to reduce latency and overhead. The following components are provided:
Acknowledgement of UE initiated report and associated timing.
Timing of parameter update based on a UE initiated report.

Aspects, features, and advantages of the present disclosure are readily apparent from the following detailed description, simply by illustrating a number of particular embodiments and implementations, including the best mode contemplated for carrying out the present disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

In the following, both frequency division duplexing (FDD) and time division duplexing (TDD) are regarded as a duplex method for DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

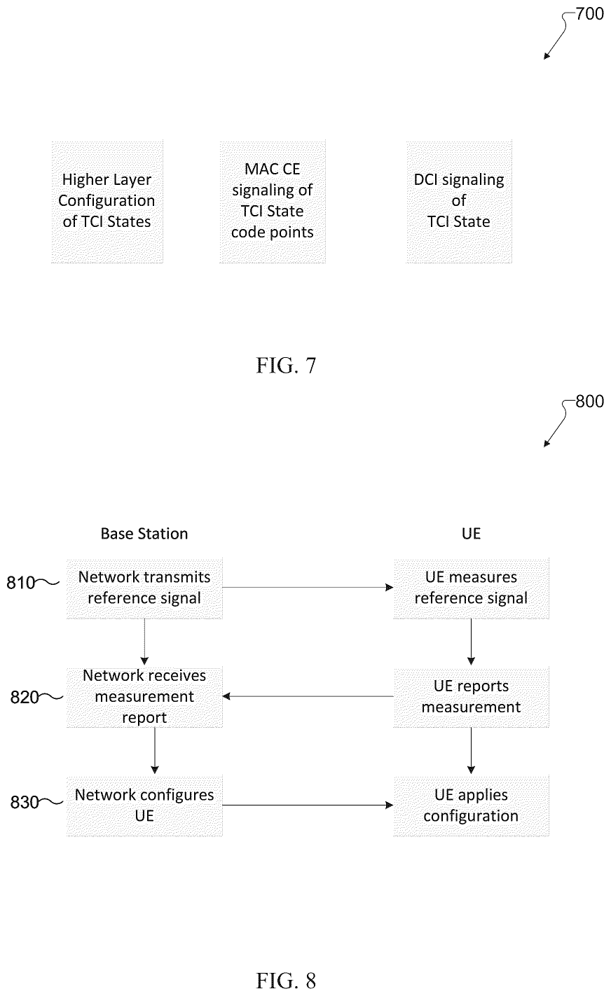

FIG. 7 illustrates a diagram of example higher level signaling 700 according to embodiments of the present disclosure. For example, higher level signaling 700 can be received by the UE 111 of FIG. 1. This example is for illustration only and other embodiments can be used without departing from the scope of the present disclosure.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the present disclosure, RRC signaling (e.g., configuration by RRC signaling) includes the following: (1) system information block (SIB)-based RRC signaling (e.g., SIB1 or other SIB) and/or (2) RRC dedicated signaling that is sent to a specific UE.

In the present disclosure, a MAC CE signaling includes: (1) DL MAC CE signaling from gNB or network to UE, when transmitted by gNB, and/or (2) UL MAC CE signaling from UE to gNB, when transmitted from UE.

In the present disclosure, an L1 control signaling includes: (1) DL control information (e.g., DCI on PDCCH) when transmitted from the gNB or network to UE, and/or (2) UL control information (e.g., UCI on PUCCH or PUSCH) when transmitted from UE.

Terminology such as TCI, TCI states, SpatialRelationInfo, target RS, reference RS, and other terms is used for illustrative purposes and is therefore not normative. Other terms that refer to same functions can also be used.

A “reference RS” corresponds to a set of characteristics of a DL beam or an UL TX beam, such as a direction, a precoding/beamforming, a number of ports, and so on.

In the following components, a TCI state is used for beam indication. It can refer to a DL TCI state for downlink (DL) channels (e.g. PDCCH and PDSCH) or DL signals, an uplink TCI state for uplink (UL) channels (e.g. PUSCH or PUCCH) or UL signals, a joint TCI state for downlink and uplink channels/signals, or separate TCI states for uplink and downlink channels/signals. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

In the following examples, with reference to FIG. 7, a UE is configured/updated through higher layer RRC signaling a set of TCI States with L elements. In one example, DL and joint TCI states are configured by higher layer parameter DLorJoint-TCIState, wherein, the number of DL and Joint TCI state is L_{DJ}. UL TCI state are configured by higher layer parameter UL-TCIState, wherein the number of UL TCI state is L_{U}. L=L_{DJ}+L_{U}, wherein L is the total number of DL, Joint and UL TCI states.

MAC CE signaling includes a subset of K (K≤L) TCI states or TCI state code points from the set of L TCI states, wherein a code point is signaled in the “transmission configuration indication” field a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e. Downlink Control Information (DCI)) updates the UE's TCI state, wherein the DCI includes a “transmission configuration indication” (beam indication) field e.g. with k bits (such that K≤2^{k}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

The TCI states can be associated, through a QCL relation, with an SSB of serving cell, or an SSB associated with a PCI different from the PCI of the serving cell. The QCL relation with a SSB can be a direct QCL relation, wherein the source RS (e.g., for a QCL Type D relation or a spatial relation) of the QCL state is the SSB. The QCL relation with a SSB can be an indirect QCL relation, wherein, the source RS (e.g., for a QCL Type D relation or a spatial relation) can be a reference signal, and the reference signal has the SSB as its source (e.g., for a QCL Type D relation or a spatial relation).

The indirect QCL relation to an SSB can involve a QCL or spatial relation chain of more than one reference signal.

The UE can use a DL related DCI (e.g., DCI Format 1_1 or DCI Format 1_2) without DL assignment, for beam indication. For example, the use of DL related DCI without DL assignment, can be configured by higher layers, or can be specified in the system specification.

Alternatively, the UE can use a DL related DCI (e.g., DCI Format 1_1 or DCI Format 1_2) with DL assignment, for beam indication. For example, the use of DL related DCI with DL assignment, can be configured by higher layers, or can be specified in the system specification.

In the following examples, the “transmission configuration indication” provided by a DCI format includes a TCI state codepoint activated by MAC CE. Wherein, the TCI state codepoint can be one of:
Joint TCI state used for UL transmissions and DL receptions by the UE.
DL TCI state used for DL receptions by the UE.
UL TCI state used for UL transmissions by the UE.
DL TCI state used for DL receptions by the UE and UL TCI states used for UL transmissions by the UE.

FIG. 8 illustrates a flowchart of an example procedure 800 for UE configuration according to embodiments of the present disclosure. For example, procedure 800 for UE configuration can be performed by the UE 116 and the gNB 102 and/or network 130 in the wireless network 100 of FIG. 1. This example is for illustration only and other embodiments can be used without departing from the scope of the present disclosure.

In 810 of FIG. 8, the measurement can be (1) beam related measurement (e.g., layer 1reference signal received power (L1-RSRP) measurement and/or layer 1 signal-to-interference-plus-noise ratio (L1-SINR) measurement). (2) Mobility (e.g., handover) measurement (e.g., L1-RSRP measurement, layer 3 (L3)-RSRP measurement, L1-SINR measurement and/or reference signal received quality (RSRQ) measurement). (3) channel state information (CSI) related measurement (e.g., for channel quality indicator (CQI) and/or for precoding matrix indicator (PMI) and/or for RI). (4) Time domain channel properties (TDCP) measurement (e.g., for Doppler profile and/or auto correlation profile. (5) Time related measurements (e.g., time of arrival difference of RS from different transmission points). (6) Other non-beam, non-mobility, non-CSI, non-TDCP, non-time related measurements.

In 820 of FIG. 8, the UE provides the measurement report to the network. The measurement report can be:
(1) Periodic measurement report. The network configures the measurement (e.g., using higher layer configuration such as RRC configuration). The UE then transmits the measurement report based on the configuration.
(2) Semi-persistent measurement report. The network configures the measurement report (e.g., using higher layer configuration such as RRC configuration). But The measurement report is not transmitted until it is activated. For example, activation signaling can be MAC CE signaling and/or L1 control signaling (e.g., DCI signaling). After the measurement report is activated, the measurement report is transmitted (e.g., periodically) until the measurement report is deactivated. For example, deactivation signaling can be MAC CE signaling and/or L1 control signaling (e.g., DCI signaling). After the measurement report is deactivated, the measurement report is not transmitted until further activation. In one example, the activation or deactivation for an RS can also activate or deactivate the measurement report or vice versa.
(3) Aperiodic measurement report. The network configures the measurement report (e.g., using higher layer configuration such as RRC configuration). But the measurement report is not transmitted until it is triggered. For example, trigger signaling can be L1 control signaling (e.g., DCI signaling) and/or MAC CE signaling. In one example, trigger signaling can trigger one transmission instance of measurement report. In another example trigger signaling can trigger N transmission instances of measurement report. Wherein, N can be specified in specifications and/or configured by higher layer signaling (e.g., RRC signaling and/or MAC CE signaling) and/or configured by L1 control signaling (e.g., DCI signaling) and/or included in the message triggering the transmission of the measurement report. In one example, the trigger for an RS can also trigger the measurement report.

In 820 of FIG. 8, the measurement report can be transmitted using at least one of the following UL transmissions: (1) PUSCH, wherein the PUSCH can be a dynamically scheduled PUSCH and/or a configure grant PUSCH (e.g., Type 1 configured grant and/or Type 2 configured grant). (2) PUCCH. (3) random access channel (RACH), wherein RACH can be Type 1 RACH and/or Type 2 RACH. Furthermore, RACH can be contention based random access (CBRA) and/or contention free random access (CFRA). Furthermore, RACH can be triggered by higher layers or triggered by a PDCCH order.

In 820 of FIG. 8, the measurement report can be: (1) a one-part (or one stage) measurement report. (2) a two-part (or two-stage) measurement report, for example the first part can have a fixed size and it provides information about the second part, e.g., size and/or content and/or resources of the second part.

In 820 of FIG. 8, the measurement report can be, or can include one or more of the following:
(1) a report for beam measurements (e.g., including L1-RSRP and/or L1-SINR and/or beam indicator).
(2) a report for mobility (or handover) measurements (e.g., including L1-RSRP and/or L3-RSRP and/or L1-SINR and/or RSRQ and/or beam indicator and/or cell indicator)
(3) a report for CSI related measurements (e.g., including CSI and/or PMI and/or RI and/or L1 and/or CQI report interval (CRI))
(4) a report for TDCP related measurements (e.g., including TDCP-related quantity/quantities and/or indicator(s) for Doppler profile and/or indicator(s) for auto-correlation profile).
(5) A report for time related measurements (e.g., including time of arrival difference of RS from different transmission points)
(6) A report for other non-beam, non-mobility, non-CSI, non-TDCP, non-time related measurements.

In one example, the contents and frequency of occurrence of the report depend on the channel conditions. In one example, in a fast changing environment the reports are more frequent. In one example, in a slow changing environment the reports are less frequent. In one example, the report can include predicted channel conditions (e.g., predicted measurements) at a time in the future.

In 830 of FIG. 8, after receiving the measurement report the network takes action based on the measurement report and the UE applies the indicated action. For example, the action be one of:
(1) Application of a new beam (e.g., TCI state or spatial relation reference signal)
(2) Trigger mobility to a target cell
(3) Update codebook related parameters
(4) Update Doppler related parameters
(5) Update TA
(6) Updated configuration based on other non-beam, non-mobility, non-CSI, non-TDCP, non-time related measurements.

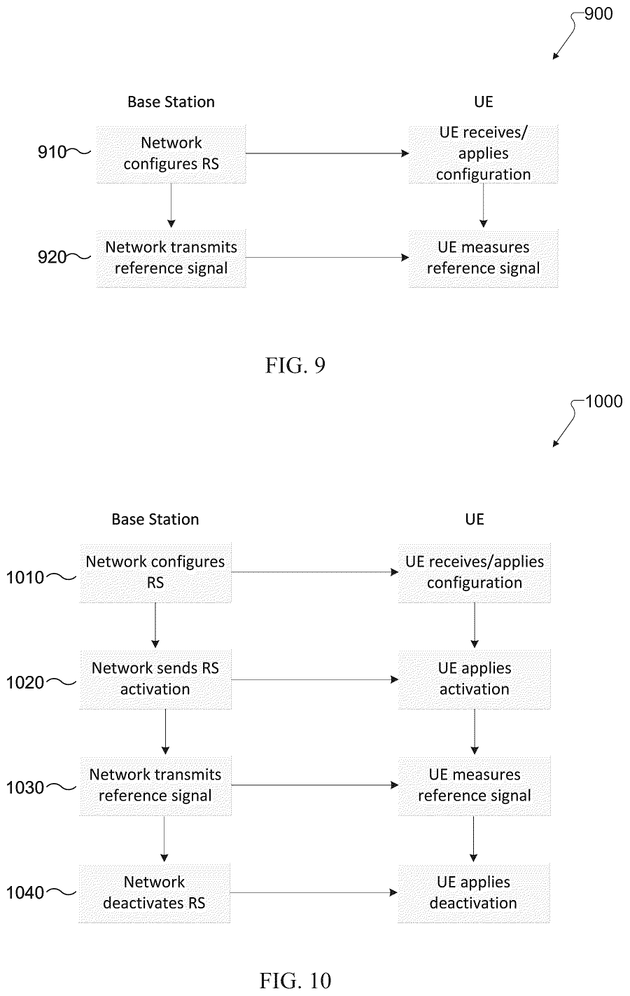

FIG. 9 illustrates a flowchart of an example procedure 900 for configuring a periodic RS according to embodiments of the present disclosure. For example, procedure 900 for configuring a periodic RS can be performed by the UE 111 and the gNB 102 and/or network 130 in the wireless network 100 of FIG. 1. This example is for illustration only and other embodiments can be used without departing from the scope of the present disclosure.

The procedure begins in 910, a network configures a RS and a UE receives/applies the configuration. In 920, the network transmits the RS to the UE and then the UE measures the RS.

FIG. 10 illustrates a flowchart of an example procedure 1000 for configuring a semi-persistent RS according to embodiments of the present disclosure. For example, procedure 1000 for configuring a semi-persistent RS can be performed by the UE 112 and the gNB 102 and/or network 130 in the wireless network 100 of FIG. 1. This example is for illustration only and other embodiments can be used without departing from the scope of the present disclosure.

The procedure begins in 1010, a network configures a RS and a UE receives/applies the configuration. In 1020, the network sends an RS activation to the UE and then the UE applies the activation. In 1030, the network transmits the RS to the UE and then the UE measures the RS. In 1040, the network deactivates the RS and the UE applies the deactivation.

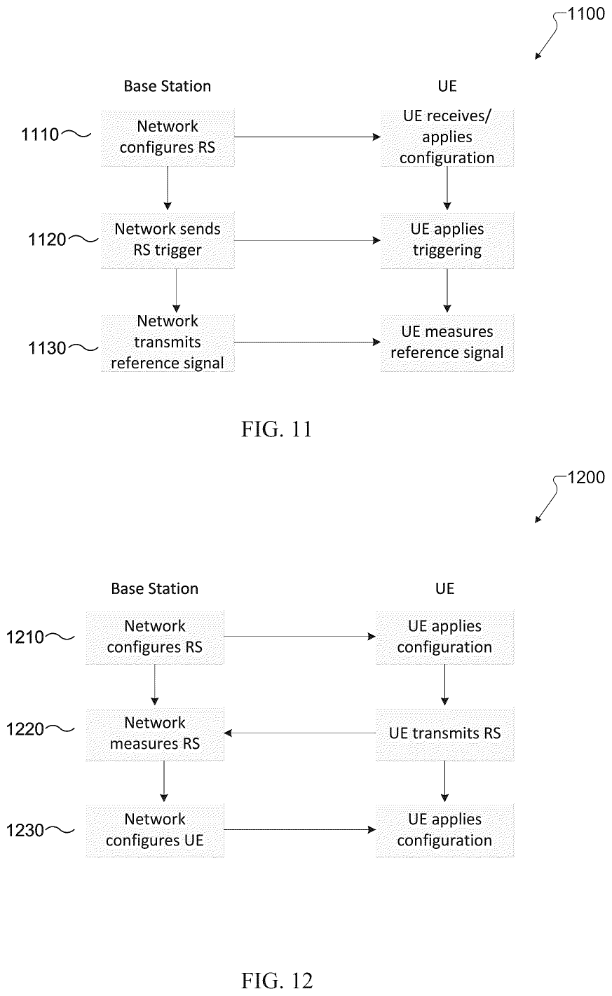

FIG. 11 illustrates a flowchart of an example procedure 1100 for configuring an aperiodic RS according to embodiments of the present disclosure. For example, procedure 1100 for configuring an aperiodic RS can be performed by the UE 113 and the gNB 102 and/or network 130 in the wireless network 100 of FIG. 1. This example is for illustration only and other embodiments can be used without departing from the scope of the present disclosure.

The procedure begins in 1110, a network configures a RS and a UE receives/applies the configuration. In 1120, the network sends an RS trigger to the UE and then the UE applies the triggering. In 1130, the network transmits the RS to the UE and then the UE measures the RS.

In one example, with reference to FIG. 12, (1) the network (e.g., base Station (BS), gNB or transmission/reception point (TRP)) transmits a reference signal (RS), and the UE measures the RS, (2) the UE reports the measurement to the network and network receives the measurement, and (3) the network further configures the UE based on the measured reference signal and the UE applies the configuration.

In 810 of FIG. 8, the RS can be (1) SSB and/or (2) a non-zero power channel state information reference signal (NZP CSI-RS) and/or (3) a demodulation reference signal (DMRS) associated with a PDSCH and/or PDCCH.

In 810 of FIG. 8, the RS can be:
(1) Periodically configured RS. This is illustrated in FIG. 9, wherein the network configures the RS (e.g., using higher layer configuration such as RRC configuration). The network then transmits the RS based on the configuration.
(2) Semi-persistent RS. This is illustrated in FIG. 10, wherein the network configures the RS (e.g., using higher layer configuration such as RRC configuration). But The RS is not transmitted until it is activated. For example, activation signaling can be MAC CE signaling and/or L1 control signaling (e.g., DCI signaling). After the RS is activated, the RS is transmitted (e.g., periodically) until the RS is deactivated. For example, deactivation signaling can be MAC CE signaling and/or L1 control signaling (e.g., DCI signaling). After the RS is deactivated, the RS is not transmitted until further activation.
(3) Aperiodic RS. This is illustrated in FIG. 11, wherein the network configures the RS (e.g., using higher layer configuration such as RRC configuration). But the RS is not transmitted until it is triggered. For example, trigger signaling can be L1 control signaling (e.g., DCI signaling) and/or MAC CE signaling. In one example, trigger signaling can trigger one transmission instance of RS. In another example trigger signaling can trigger N transmission instances of RS. Wherein, N can be specified in specifications and/or configured by higher layer signaling (e.g., RRC signaling and/or MAC CE signaling) and/or configured by L1 control signaling (e.g., DCI signaling) and/or included in the message triggering the transmission of the RS.

FIG. 12 a flowchart of an example procedure 1200 for UE configuration according to embodiments of the present disclosure. For example, procedure 1200 for UE configuration can be performed by the UE 114 and the gNB 102 and/or network 130 in the wireless network 100 of FIG. 1. This example is for illustration only and other embodiments can be used without departing from the scope of the present disclosure.

The procedure begins in 1210, a network configures RS and the UE applies the RS. In 1220, the UE transmits RS to the network and then the network measures RS. In 1230, the network configures the UE and then the UE applies the configuration.

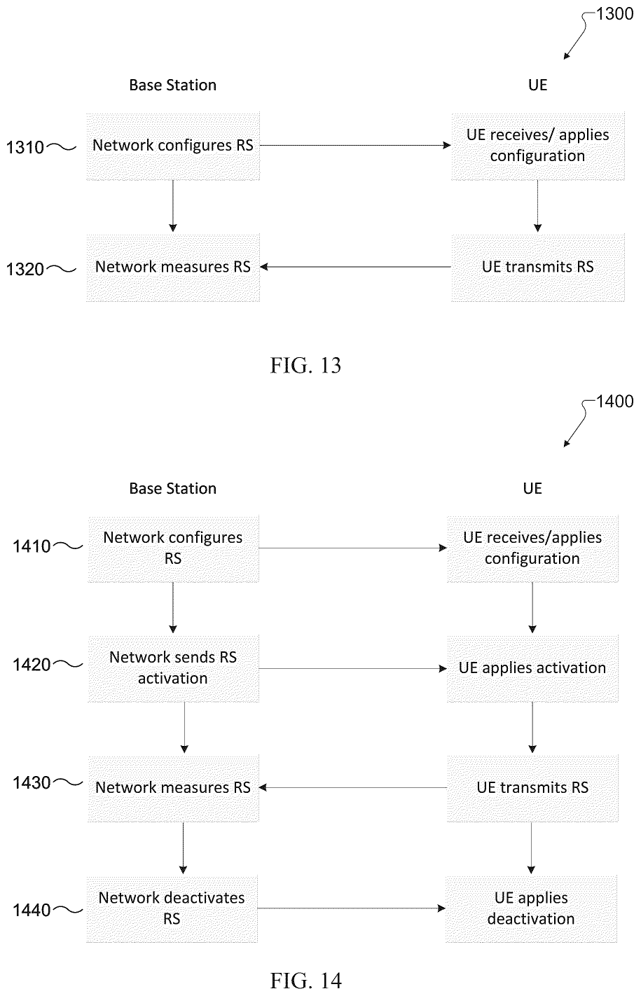

FIG. 13 illustrates a flowchart of an example procedure 1300 for configuring a periodic RS according to embodiments of the present disclosure. For example, procedure 1300 for configuring a periodic RS can be performed by the UE 115 and the gNB 102 and/or network 130 in the wireless network 100 of FIG. 1. This example is for illustration only and other embodiments can be used without departing from the scope of the present disclosure.

The procedure begins in 1310, a network configures a RS and a UE receives/applies the configuration. In 1320, the UE transmits the RS to the network and then the network measures the RS.

FIG. 14 illustrates a flowchart of an example procedure 1400 for configuring SP RS according to embodiments of the present disclosure. For example, procedure 1400 for configuring SP RS can be performed by the UE 116 and the gNB 102 and/or network 130 in the wireless network 100 of FIG. 1. This example is for illustration only and other embodiments can be used without departing from the scope of the present disclosure.

The procedure begins in 1410, a network configures a RS and a UE receives/applies the configuration. In 1420, the network sends an RS activation to the UE and then the UE applies the activation. In 1430, the UE transmits the RS to the network and then the network measures the RS. In 1440, the network deactivates the RS and the UE applies the deactivation.

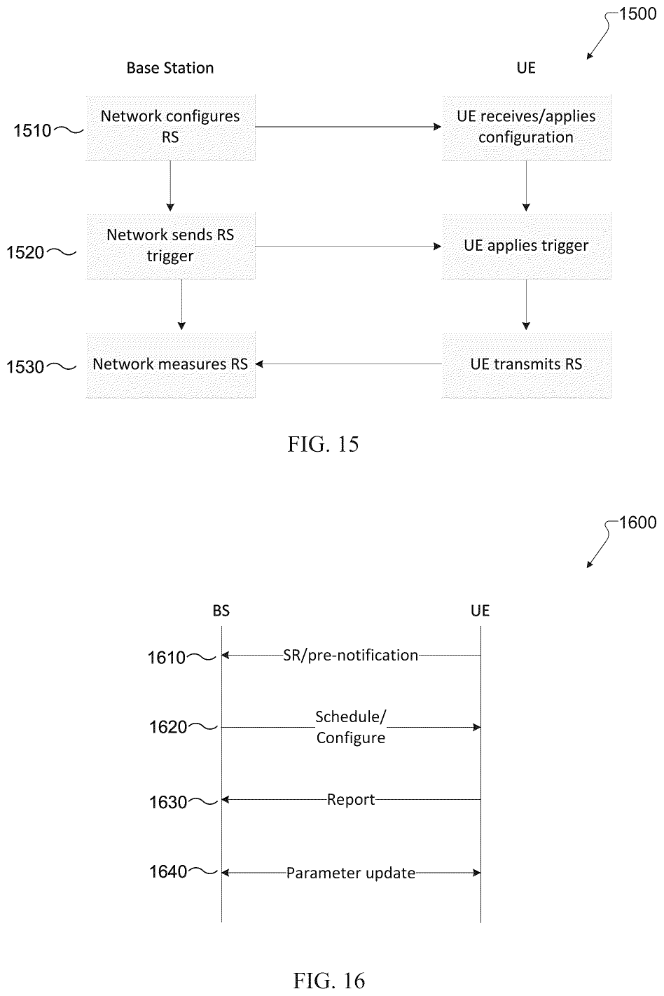

FIG. 15 illustrates a flowchart of an example procedure 1500 for configuring an aperiodic RS according to embodiments of the present disclosure. For example, procedure 1500 for configuring an aperiodic RS can be performed by the UE 111 and the gNB 102 and/or network 130 in the wireless network 100 of FIG. 1. This example is for illustration only and other embodiments can be used without departing from the scope of the present disclosure.

The procedure begins in 1510, a network configures a RS and a UE receives/applies the configuration. In 1520, the network sends an RS trigger to the UE and then the UE applies the triggering. In 1130, the network transmits the RS and the UE measures the RS. In 1530, the UE transmits the RS to the network and then the network measures the RS.

In one example as illustrated in FIG. 12, (1) the network (e.g., base Station (BS), gNB or transmission/reception point (TRP)) configures and/or activates and/or triggers a UE to transmit a reference signal (RS), and the UE receives and applies such configuration and/or activation and/or triggering. (2) The UE transmits the reference signal (RS), and the gNB measures the RS. (3) The network further configures the UE based on the measured reference signal and the UE applies the configuration.

In 1220 of FIG. 12, the RS can be (1) a SRS and/or (2) a demodulation reference signal (DMRS) associated with a PUSCH and/or PUCCH and/or (3) a random access preamble.

In 1210/1220 of FIG. 12, the RS can be:
(1) Periodically configured RS. This is illustrated in FIG. 13, wherein the network configures the RS (e.g., using higher layer configuration such as RRC configuration). The UE then transmits the RS based on the configuration.
(2) Semi-persistent RS. This is illustrated in FIG. 14, wherein the network configures the RS (e.g., using higher layer configuration such as RRC configuration). But The RS is not transmitted by the UE until it is activated. For example, activation signaling can be MAC CE signaling and/or L1 control signaling (e.g., DCI signaling). After the RS is activated, the RS is transmitted by the UE (e.g., periodically) until the RS is deactivated. For example, deactivation signaling can be MAC CE signaling and/or L1 control signaling (e.g., DCI signaling). After the RS is deactivated, the RS is not transmitted until further activation.
(3) Aperiodic RS. This is illustrated in FIG. 15, wherein the network configures the RS (e.g., using higher layer configuration such as RRC configuration). But the RS is not transmitted until it is triggered. For example, trigger signaling can be L1 control signaling (e.g., DCI signaling) and/or MAC CE signaling. In one example, trigger signaling can trigger one transmission instance of RS. In another example trigger signaling can trigger N transmission instances of RS. Wherein, N can be specified in specifications and/or configured by higher layer signaling (e.g., RRC signaling and/or MAC CE signaling) and/or configured by L1 control signaling (e.g., DCI signaling) and/or included in the message triggering the transmission of the RS.

In 1120 of FIG. 11, the measurement can be (1) beam related measurement (e.g., L1-RSRP measurement and/or L1-SINR measurement). (2) Mobility (e.g., handover) measurement (e.g., L1-RSRP measurement, L3-RSRP measurement, L1-SINR measurement and/or RSRQ measurement). (3) channel state information (CSI) related measurement (e.g., to determine a channel quality and/or precoding matrix and/or a rank for the channel). (4) Time domain channel properties (TDCP) measurement (e.g., for Doppler profile and/or auto correlation profile. (5) Time related measurements (e.g., time of arrival difference of RS from UE). (6) Other non-beam, non-mobility, non-CSI, non-TDCP, non-time related measurements.

In 1230 of FIG. 12, after performing the measurement on the RS transmitted by the UE, the network takes action based on the measurement and the UE (e.g., the UE 116) applies the indicated action. For example, the action be one of:
(1) Application of a new beam (e.g., TCI state or spatial relation reference signal)
(2) Trigger mobility to a target cell
(3) Update codebook related parameters
(4) Update Doppler related parameters
(5) Update TA
(6) Updated configuration based on other non-beam, non-mobility, non-CSI, non-TDCP, non-time related measurements.

Based on the previous description, the network can configure and/or activate and/or trigger the reference signal (RS) that is transmitted by the network and measured by the UE or the RS that is transmitted by the UE and measured by the network. The network can also configure and/or activate and/or trigger the channel used to report the measurement performed by the UE to the network. In some cases, such operation can lead to additionally latency, as the UE has to wait for the network (e.g., the network 130) to configure the RS and/or channel for reporting the measurement. In some cases, such operation can lead to additional overhead as resources are being configured for the measurement RS and/or channel for reporting measurement, when the report has not changed between consecutive instances of reporting leading to inefficient utilization of air interface resources.

To mitigate, the previously mentioned, latency and/or overhead issues, UE initiated measurement and reporting is provided. With reference to FIG. 16, the procedure for UE initiated measurement and/or reporting is shown. In 1610, the UE can send a pre-notification or request signal to the gNB. The pre-notification message or request message can be sent in anticipation of the report or as the report is being prepared. In 1620, the network can respond with signal providing resources and configuration for transmission of a report that includes measurements performed by the UE. In 1630, the UE provides a report. In some scenarios, the network can acknowledge the reception of the report. In 1640, the UE and/or the base station can apply or update a parameter based on the report. In some scenarios, the timing of the application of the report should be aligned at the UE and the base station.

One or more of the aforementioned steps can be omitted.
In one example, 1610 is omitted, the base station (gNB) configures and/or activates and/or triggers a report from the UE. In one example, RRC configuration can configured and allocate resources for the UE. In one example, MAC CE (and/or L1 control signaling (e.g., DCI Format) can activate reporting from the UE. In another example, L1 control signaling (e.g., DCI Format) (and/or MAC CE signaling) can trigger reporting from the UE (e.g., trigger a pre-configured report, or include a UL grant). The condition to trigger the report can be up to the network implementation (e.g., based on channel conditions and/or block error ratio (BLER) and/or other measurements the gNB has acquired based on its own measurements and/or measurements of another gNB/base station/TRP and/or measurements from a UE). The configuration/activation/triggering of a report can also include or be associated with configuration/activation/triggering of RS that can be used for measurement.
In one example, 1610 and 1620 are omitted. The UE provides the report without triggering and/or activation by the network and without pre-notification to the network. The network can still configure resources to be used by the UE for such reporting (for example, PUSCH and/or PUCCH and/or RACH resources). In one example, multiple report configurations are configured, wherein a UE can select a report configuration based on the report payload size and/or the report type.
In one example, 1620 is omitted. The UE provides the network per-notification that it would transmit the report and transmits the report without getting activation or triggering from the network. The network can still configure resources to be used by the UE for such reporting (for example, PUSCH and/or PUCCH and/or RACH resources). The network can also configure resources to use for pre-notification.
In one example, 1620 and 1630 are omitted. For example, the SR or pre-notification (1610) can provide an indication from the UE to the network for the network to perform a certain action. Such action can be for example to perform a beam switch or to perform mobility (e.g., handover) to a target cell. The network can configure resources to use for pre-notification.
In one example, after 1630, the network acknowledges reception of a message or report from the UE. The UE and network can update one or more parameters, based on the report, after a time T, or within a time T, or after a time T (for example, first symbol or slot or sub-frame or frame boundary at or after a time T) from the report or from the acknowledgement.
In one example, after 1630, the UE and network can update one or more parameters, based on the report, at a time T, or within a time T, or after a time T (for example, first symbol or slot or sub-frame or frame boundary at or after a time T) from the report.

In 1630 of FIG. 16, report can be one of:
In one example, a one part or one stage report.
In one example a two part or two stage report.

In this disclosure a UE initiates a reporting (e.g., 1610 or 1630 of FIG. 16) based on a metric M. For example, the metric M can be one of the following examples.
The block error rate.
The L1-RSRP and/or L1-SINR and/or L3-RSRP and/or RSRQ of an indicated TCI state
The L1-RSRP and/or L1-SINR and/or L3-RSRP and/or RSRQ of an activated TCI state that is not indicated
The L1-RSRP and/or L1-SINR and/or L3-RSRP and/or RSRQ of TCI state that is not indicated
The L1-RSRP and/or L1-SINR and/or L3-RSRP and/or RSRQ of reference signal
The L1-RSRP and/or L1-SINR and/or L3-RSRP and/or RSRQ of reference signal not associated with an indicated TCI state
The L1-RSRP and/or L1-SINR and/or L3-RSRP and/or RSRQ of TCI state associated with a non-serving cell (e.g., candidate cell or target cell)
The L1-RSRP and/or L1-SINR and/or L3-RSRP and/or RSRQ of a non-serving cell (e.g., candidate cell or target cell).
Difference in time of arrival between an RS and a reference RS. For example, the reference RS can be that of a serving cell or a TRP of a serving cell.
CQI metric
Difference in CQI metric between measured CQI and (e.g., last) reported CQI.
PMI metric.
Difference in PMI between measured PMI and (e.g., last) reported PMI
RI metric.
Difference in rank between last measured rank and (e.g., last) reported rank
Difference in TDCP between measured TDCP and (e.g., last) reported TDCP.
Doppler shift
Doppler spread
Difference in Doppler shift between measured Doppler shift and Doppler shift associated with (e.g., last) report.

Difference in Doppler spread between measured Doppler spread and Doppler spread associated with (e.g., last) report

A UE can have a threshold T, wherein, T can be specified in system specification (e.g., in one example T=0) and/or configured and/or updated by RRC signaling and/or MAC CE signaling and/or L1 control (e.g., DCI Format) signaling. In one example, a report is initiated by the UE if:
M>T
M≥T
M<T
M≤T
M=T
M≠T

A UE can have a first threshold T₁ and a second threshold T₂. Wherein, T₁<T₂, and wherein, T₁ and/or T₂ can be specified in system specification and/or configured and/or updated by RRC signaling and/or MAC CE signaling and/or L1 control (e.g., DCI Format) signaling. In one example T₁=−T₂. In one example report is initiated by the UE if one of the following is satisfied:

$${T}_{1} < M < {T}_{2}$$

$${T}_{1} \leq M < {T}_{2}$$

$${T}_{1} < M \leq {T}_{2}$$

$${T}_{1} \leq M < {T}_{2}$$

$${T}_{1} > M or {T}_{2} < M$$

$${T}_{1} \geq M or {T}_{2} < M$$

$${T}_{1} > M or {T}_{2} \leq M$$

$${T}_{1} \geq M or {T}_{2} \leq$$

FIG. 16 illustrates a flowchart of an example procedure 1600 for UE-initiated reporting according to embodiments of the present disclosure. For example, procedure 1600 for UE-initiated reporting can be performed by the UE 112 and the gNB 102 and/or network 130 in the wireless network 100 of FIG. 1. This example is for illustration only and other embodiments can be used without departing from the scope of the present disclosure.

The procedure begins in 1610, a UE sends to a network SR/pre-notification. In 1620, the network schedules/configures the UE. In 1630, the UE sends a report to the network. In 1650, a parameter update is done by the network and/or UE.

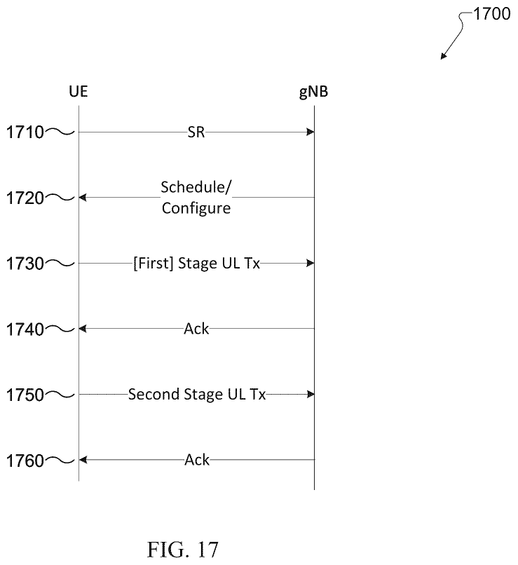

FIG. 17 illustrates a flowchart of an example procedure 1700 for signal exchange according to embodiments of the present disclosure. For example, procedure 1700 for signal exchange can be performed by the UE 113 and the gNB 102 and/or network 130 in the wireless network 100 of FIG. 1. This example is for illustration only and other embodiments can be used without departing from the scope of the present disclosure.

The procedure begins in 1710, a UE sends a SR to a BS. In 1720, the BS schedules/configures the UE. In 1730, the UE sends a (first) stage UL TX to the BS. In 1740, the BS sends an ACK to the UE. In 1750, the UE sends a second stage UL TX to the BS. In 1760, the BS sends an ACK to the UE.

The network can acknowledge the transmissions from UE. With reference to FIG. 17, the signaling exchange between the network and the UE is shown. Some of these steps may be omitted (e.g., the second stage UL Tx and associated Ack can be omitted).

In the examples of this disclosure, a UE transmits a scheduling request (SR) or a pre-notification. This can be transmitted in one or more the following:
Uplink control information (UCI) on PUCCH or PUSCH. In one example, UCI is transmitted on PUCCH Format 0 or PUCCH Format 1 (e.g., UCI is one bit or UCI is two bits). In one example UCI is transmitted on PUCCH Format 2 or PUCCH Format 3 or PUCCH Format 4.
MAC CE on PUSCH.

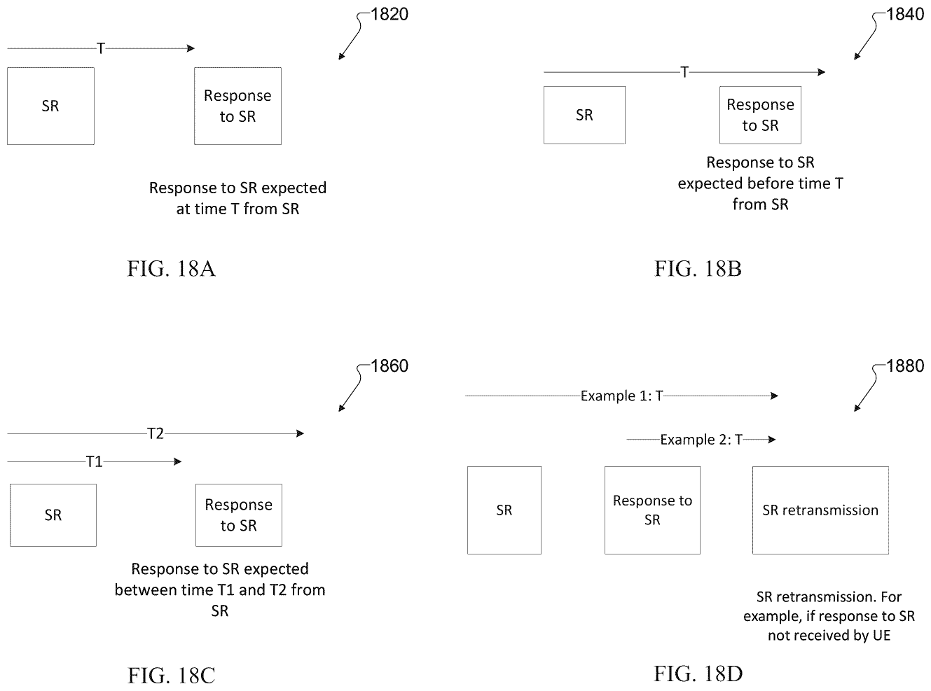

FIGS. 18A, 18B, and 18C, and 18D illustrate timelines 1820, 1840, 1860, and 1880, respectively, for an example SR response and SR retransmission according to embodiments of the present disclosure. For example, timelines 1820, 1840, 1860, and 1880, respectively, for an example SR response and SR retransmission can be followed by the BS 103 of FIG. 1. This example is for illustration only and other embodiments can be used without departing from the scope of the present disclosure.

In the following examples, a report can be an uplink transmission from a UE, which can include a report including information based on measurements performed by the UE as aforementioned, and/or an uplink transmission from a UE, which can include a reference signal for measurement to be performed at the gNB (e.g., sounding reference signal).

In one example, the UE can send a signal to the gNB/TRP/network, wherein the signal can be a scheduling request for the gNB/TRP/network to allocated/schedule UL resources for the transmission of the report from the UE. In this scenario, the response of the gNB/TRP/network to the scheduling request, by allocating/scheduling UL resources, can be considered as an acknowledgement for the scheduling request, where the UL resource can be for (1) transmission of a report from the UE e.g., on PUCCH or PUSCH using MAC CE or UCI, or (2) transmission of reference signal for measurement, e.g., SRS, from the UE. In an alternative example, the response to the scheduling request is transmission of CSI-RS to the UE.

In one example, after sending the scheduling request if the UE doesn't receive the acknowledgment (e.g., channel/signal allocating/scheduling UL resources for report from UE), the UE can retransmit a scheduling request.

In one example, after sending the scheduling request, the UE expects the acknowledgment (e.g., channel/signal allocating/scheduling UL resources for report from UE) at time T, or after a time T (for example, first symbol or slot or sub-frame or frame boundary at or after a time T) from scheduling request. In one example, T is from the start of the signal/channel with the scheduling request. In one example, T is from the end of the signal/channel with the scheduling request. In one example T, is to the start of the signal/channel with acknowledgment to the UE. In one example T, is to the end of the signal/channel with acknowledgment to the UE. In one example T, is to the start of the slot/subframe/frame containing the signal/channel with acknowledgment to the UE. In one example T, is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example T, depends on the sub-carrier spacing of the signal/channel of the scheduling request and/or signal/channel with acknowledgement to the UE and/or channel of report from UE. In one example, T depends on the minimum (smallest) sub-carrier spacing of the signal/channel of the scheduling request and/or the signal/channel with acknowledgement to the UE and/or channel of report from UE. In one example, T depends on the maximum (largest) sub-carrier spacing of the signal/channel of the scheduling request and/or the signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment (e.g., channel/signal allocating/scheduling UL resources for report from UE) at time T as aforementioned, the UE can retransmit the scheduling request. FIG. 18A illustrates an example, where at time T from an SR a response to SR is expected. In FIG. 18A, the time T is from the start of the SR to the start of the response to SR. Various alternatives can be implemented for the start and end of time T as aforementioned. The response to the SR can be: (1) acknowledgment to the SR; (2) DCI format scheduling a transmission from the UE, for example (2) a, an uplink transmission (in PUCCH or PUSCH in UCI or MAC CE) containing UE report as aforementioned, (2) b a reference signal (e.g., SRS) transmission from a UE; (3) a NZP CSI-RS transmission from the UE (e.g., semi-persistent NZP CSI-RS or aperiodic CSI-RS).

In one example, after sending the scheduling request, the UE expects the acknowledgment (e.g., channel/signal allocating/scheduling UL resources for report from UE) before time T (or before or at time T) from scheduling request. In one example, T is from the start of the signal/channel with the scheduling request. In one example, T is from the end of the signal/channel with the scheduling request. In one example, Tis to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel of the scheduling request and/or signal/channel with acknowledgement to the UE and/or channel of report from UE. In one example, T depends on the minimum (smallest) sub-carrier spacing of the signal/channel of the scheduling request and/or the signal/channel with acknowledgement to the UE and/or channel of report from UE. In one example, T depends on the maximum (largest) sub-carrier spacing of the signal/channel of the scheduling request and/or the signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment (e.g., channel/signal allocating/scheduling UL resources for report from UE) before time T (or before or at time T) as aforementioned, the UE can retransmit the scheduling request. With reference to FIG. 18B, before time T from an SR a response to SR is expected is shown. With reference to FIG. 18B, the time T is from the start of the SR to the start of the response to SR. Various alternatives can be implemented for the start and end of time T as aforementioned. The response to the SR can be: (1) acknowledgment to the SR; (2) DCI format scheduling a transmission from the UE, for example (2) a, an uplink transmission (in PUCCH or PUSCH in UCI or MAC CE) containing UE report as aforementioned, (2) b a reference signal (e.g., SRS) transmission from a UE; (3) a NZP CSI-RS transmission from the UE (e.g., semi-persistent NZP CSI-RS or aperiodic CSI-RS).

In one example, after sending the scheduling request, the UE expects the acknowledgment (e.g., channel/signal allocating/scheduling UL resources for report from UE) at time t, or after a time t (for example, first symbol or slot or sub-frame or frame boundary at or after a time t) from scheduling request, such that one of (1) T1<t<T2, or (2) T1≤t≤T2 or (3) T1<t≤T2 or (4) T1≤t<T2. In one example, T1 and/or T2 is/are from the start of the signal/channel with the scheduling request. In one example, T1 and/or T2 is/are from the end of the signal/channel with the scheduling request. In one example, T1 and/or T2 is/are to the start of the signal/channel with acknowledgment to the UE. In one example, T1 and/or T2 is/are to the end of the signal/channel with acknowledgment to the UE. In one example, T1 and/or T2 is/are to the start of the slot/subframe/frame containing the signal/channel with acknowledgment to the UE. In one example, T1 and/or T2 is/are to the end of the slot/subframe/frame containing the signal/channel with acknowledgement to the UE. In one example, T1 and/or T2 is specified by system specifications and/or configured or updated by RRC signaling and/or MAC CE signaling and/or L1 control (e.g., DCI Format) signaling. In one example T1 and/or T2 depends on the sub-carrier spacing of the signal/channel of the scheduling request and/or signal/channel with acknowledgement to the UE and/or channel of report from UE. In one example, T1 and/or T2 depends on the minimum (smallest) sub-carrier spacing of the signal/channel of the scheduling request and/or the signal/channel with acknowledgement to the UE and/or channel of report from UE. In one example, T1 and/or T2 depends on the maximum (largest) sub-carrier spacing of the signal/channel of the scheduling request and/or the signal/channel with acknowledgement to the UE and/or channel of report from UE. In one example, T1 and/or T2 depends on a UE capability. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, if the UE doesn't receive an acknowledgment (e.g., channel/signal allocating/scheduling UL resources for report from UE) at time t, the UE can retransmit the scheduling request, such that one of (1) T1<t<T2, or (2) T1≤t≤T2 or (3) T1<t≤T2 or (4) T1≤t<T2. In one example, T1 and/or T2 can be in units of symbols. In one example, T1 and/or T2 can be in units of slots. In one example, T1 and/or T2 can be in units of sub-frames. In one example, T1 and/or T2 can be in units of frames. With reference to FIG. 18C, between time T1 and T2 from an SR a response to SR is expected is shown. With reference to FIG. 18C, the time T1 and time T2 are from the start of the SR to the start of the response to SR is shown. Various alternatives are feasible for the start and end of time T1 and T2 as aforementioned. The response to the SR can be: (1) acknowledgment to the SR; (2) DCI format scheduling a transmission from the UE, for example (2) a, an uplink transmission (in PUCCH or PUSCH in UCI or MAC CE) containing UE report as aforementioned, (2) b a reference signal (e.g., SRS) transmission from a UE; (3) a NZP CSI-RS transmission from the UE (e.g., semi-persistent NZP CSI-RS or aperiodic CSI-RS).

In one example, after sending a first scheduling request if the UE doesn't receive the acknowledgment (e.g., channel/signal allocating/scheduling UL resources for report from UE), the UE can transmit a second scheduling request after time T (or at or after time T, or at time T). In one example, T is from the start of the signal/channel with the first scheduling request. In one example, T is from the end of the signal/channel with the first scheduling request. In one example T, is from the start of the signal/channel with acknowledgment to the UE of the first scheduling request (e.g., this can be based on the latest expected acknowledgement to the first scheduling request). In one example T, is from the end of the signal/channel with acknowledgment to the UE of the first scheduling request (e.g., this can be based on the latest expected acknowledgement to the first scheduling request). In one example, T is specified by system specifications and/or configured or updated by RRC signaling and/or MAC CE signaling and/or L1 control (e.g., DCI Format) signaling. In one example, T depends on the sub-carrier spacing of the signal/channel of the scheduling request and/or signal/channel with acknowledgement to the UE and/or channel of report from UE. In one example, T depends on the minimum (smallest) sub-carrier spacing of the signal/channel of the scheduling request and/or the signal/channel with acknowledgement to the UE and/or channel of report from UE. In one example, T depends on the maximum (largest) sub-carrier spacing of the signal/channel of the scheduling request and/or the signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). With reference to FIG. 18D, at T an SR is retransmitted is shown. With reference to FIG. 18D, two examples are shown for time T, in the first example T is from start of SR to start of retransmission of SR, in the second example T is from start of response to SR to start of retransmission of SR. Various alternatives are feasible for the start and end of time T as aforementioned. The response to the SR can be: (1) acknowledgment to the SR; (2) DCI format scheduling a transmission from the UE, for example (2) a, an uplink transmission (in PUCCH or PUSCH in UCI or MAC CE) containing UE report as aforementioned, (2) b a reference signal (e.g., SRS) transmission from a UE; (3) a NZP CSI-RS transmission from the UE (e.g., semi-persistent NZP CSI-RS or aperiodic CSI-RS). In one example, the retransmission of SR can depend on whether or not the response to SR is received, for example of the response to SR is not received, there is an SR retransmission, if SR is received, there no SR retransmission. In one example, the retransmission of the SR can happen independent of the response to SR. For example, the SR is transmitted for N times, where N can be specified in the systems specifications and/or configured or updated by RRC signaling and/or MAC CE signaling and/or L1 control (e.g., DCI Format) signaling.

In one example, the acknowledgement to the scheduling request can be a channel/signal that is separate from the channel/signal allocating/scheduling UL resources for report from UE. For example, the acknowledgement can be a DCI Format acknowledging the reception of the scheduling request.

In one example, the scheduling request is semi-persistent, wherein the UE sends the scheduling request with a periodicity P and until a timer T expires or for N instances. The gNB/TRP/network can acknowledge the scheduling request (e.g., by sending a channel/signal allocating/scheduling UL resources for report from UE). In one example, T and/or P and/or N can be specified by system specifications and/or configured or updated by RRC signaling and/or MAC CE signaling and/or L1 control (e.g., DCI Format) signaling.

In one example, the scheduling request is semi-persistent, wherein the UE sends the scheduling request with a periodicity P and for N times. The gNB/TRP/network can acknowledge the scheduling request (e.g., by sending a channel/signal allocating/scheduling UL resources for report from UE). In one example, P and/or N can be specified by system specifications and/or configured or updated by RRC signaling and/or MAC CE signaling and/or L1 control (e.g., DCI Format) signaling.

In one example, the scheduling request is semi-persistent, wherein the UE sends the scheduling request with a periodicity P and until one of the following events occurs: (1) a timer T expires and/or for N instances (2) the UE receives an acknowledgement from the gNB/TRP/network (e.g., by receiving a channel/signal allocating/scheduling UL resources for report from UE). In one example, T and/or P and/or N can be specified by system specifications and/or configured or updated by RRC signaling and/or MAC CE signaling and/or L1 control (e.g., DCI Format) signaling.

In one example, the scheduling request is semi-persistent, wherein the UE sends the scheduling request with a periodicity P and until one of the following events occurs: (1) N transmissions of the scheduling request occur (2) the UE receives an acknowledgement from the gNB/TRP/network (e.g., by receiving a channel/signal allocating/scheduling UL resources for report from UE). In one example, N and/or P can be specified by system specifications and/or configured or updated by RRC signaling and/or MAC CE signaling and/or L1 control (e.g., DCI Format) signaling.

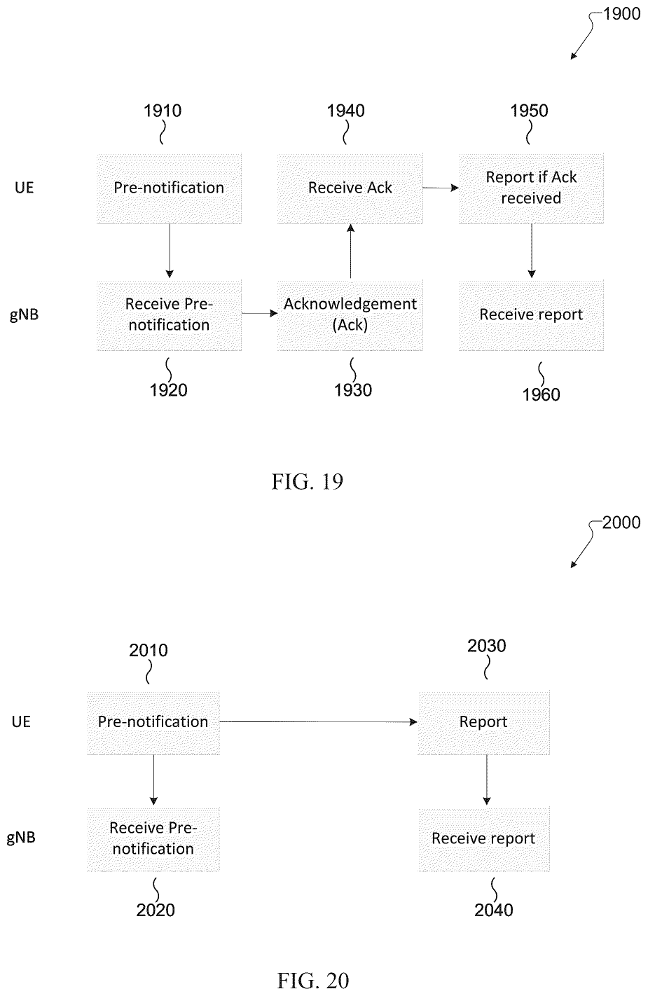

FIG. 19 illustrates a flowchart of an example procedure 1900 for UE-initiated reporting according to embodiments of the present disclosure. For example, procedure 1900 for UE-initiated reporting can be performed by the UE 114 and the gNB 102 and/or network 130 in the wireless network 100 of FIG. 1. This example is for illustration only and other embodiments can be used without departing from the scope of the present disclosure.

The procedure begins in 1910, a UE sends a pre-notification to a BS. In 1920, the BS receives the pre-notification. In 1930, the BS sends an ACK to the UE. In one example, the ACK includes resource allocation information e.g., UL grant for report. In one example, the ACK is for pre-configured resources. In 1940, the UE receives the Ack. In 1950, the UE reports if the ACK was received. In 1960, the BS receives the report from the UE.

In one example, with reference to FIG. 19, the UE (e.g., the UE 116) can send a channel/signal to the gNB/TRP/network, wherein the channel/signal can be pre-notification channel/signal. The pre-notification channel/signal is for an UL transmission that includes a report from the UE. The network (e.g., the network 130) acknowledges the pre-notification channel/signal. After the UE receives the acknowledgement, the UE transmits the report. In an alternative example, after the UE receives the acknowledgement, the UE transmits a reference signal, e.g., a SRS.

In one example, after sending the pre-notification channel/signal, if the UE doesn't receive an acknowledgement, the UE can re-transmit a pre-notification channel/signal.

In one example, after sending the pre-notification channel/signal, the UE expects an acknowledgment at time T, or after a time T (for example, first symbol or slot or sub-frame or frame boundary at or after a time T) from the pre-notification channel/signal. In one example, T is from the start of the signal/channel with the pre-notification channel/signal. In one example T, is from the end of the signal/channel with the pre-notification channel/signal. In one example, T is to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel of the pre-notification channel/signal and/or signal/channel with acknowledgement to the UE and/or channel of report from UE. In one example, T depends on the minimum (smallest) sub-carrier spacing of the signal/channel of the pre-notification channel/signal and/or the signal/channel with acknowledgement to the UE and/or channel of report from UE. In one example, T depends on the maximum (largest) sub-carrier spacing of the signal/channel of the pre-notification channel/signal and/or the signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment at time T, as aforementioned, the UE can retransmit the pre-notification channel/signal. In one example, if the UE receives an acknowledgment at time T, as aforementioned, the UE can transmit a report.

In one example, after sending the pre-notification channel/signal, the UE expects an acknowledgment before time T (or before or at time T) from the pre-notification channel/signal. In one example, T is from the start of the signal/channel with the pre-notification channel/signal. In one example, T is from the end of the signal/channel with the pre-notification channel/signal. In one example, T is to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel of the pre-notification channel/signal and/or signal/channel with acknowledgement to the UE and/or channel of report from UE. In one example, T depends on the minimum (smallest) sub-carrier spacing of the signal/channel of the pre-notification channel/signal and/or the signal/channel with acknowledgement to the UE and/or channel of report from UE. In one example, T depends on the maximum (largest) sub-carrier spacing of the signal/channel of the pre-notification channel/signal and/or the signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment before time T (or before or at time T), as aforementioned, the UE can retransmit the pre-notification channel/signal. In one example, if the UE receives an acknowledgment before time T (or before or at time T), as aforementioned, the UE transmits a report.

In one example, after sending the pre-notification channel/signal, the UE expects an acknowledgment at time t, or after a time t (for example, first symbol or slot or sub-frame or frame boundary at or after a time t) from the pre-notification channel/signal, such that one of (1) T1<t<T2, or (2) T1≤t≤ T2 or (3) T1<<T2 or (4) T1≤t<T2. In one example, T1 and/or T2 is from the start of the signal/channel with the pre-notification channel/signal. In one example, T1 and/or T2 is from the end of the signal/channel with the pre-notification channel/signal. In one example, T1 and/or T2 is to the start of the signal/channel with acknowledgment to the UE. In one example, T1 and/or T2 is to the end of the signal/channel with acknowledgment to the UE. In one example, T1 and/or T2 is to the start of the slot/subframe/frame containing the signal/channel with acknowledgment to the UE. In one example T1 and/or T2 is to the end of the slot/subframe/frame containing the signal/channel with acknowledgement to the UE. In one example, T1 and/or T2 is specified by system specifications and/or configured or updated by RRC signaling and/or MAC CE signaling and/or L1 control (e.g., DCI Format) signaling. In one example, T1 and/or T2 depends on the sub-carrier spacing of the signal/channel of the pre-notification channel/signal and/or signal/channel with acknowledgement to the UE and/or channel of report from UE. In one example, T1 and/or T2 depends on the minimum (smallest) sub-carrier spacing of the signal/channel of the pre-notification channel/signal and/or the signal/channel with acknowledgement to the UE and/or channel of report from UE. In one example, T1 and/or T2 depends on the maximum (largest) sub-carrier spacing of the signal/channel of the pre-notification channel/signal and/or the signal/channel with acknowledgement to the UE and/or channel of report from UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, if the UE doesn't receive an acknowledgment at time t, the UE can retransmit the pre-notification channel/signal, such that one of (1) T1<t<T2, or (2) T1≤t≤T2 or (3) T1<t≤T2 or (4) T1≤t<T2. In one example, if the UE receives an acknowledgment at time t, as aforementioned, the UE can transmit a report.

In one example, after sending the pre-notification channel/signal, and after receiving an acknowledgement, the UE can transmit a report. In another example, after sending the pre-notification channel/signal, and after receiving an acknowledgement, the UE can transmit a reference signal, e.g., SRS.

In one example, after sending the pre-notification channel/signal, and after receiving an acknowledgement, the UE transmits a report and/or reference signal (e.g., SRS) at time t, or after a time t (for example, first symbol or slot or sub-frame or frame boundary at or after a time t). In one example, time t is a duration T from the start of the signal/channel with the pre-notification channel/signal. In one example, time t is a duration T from the end of the signal/channel with the pre-notification channel/signal. In one example, time t is a duration T from the start of the signal/channel with the acknowledgment to the UE. In one example, time t is a duration T from the end of the signal/channel with the acknowledgment to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel of the pre-notification channel/signal and/or signal/channel with acknowledgement to the UE and/or channel of report from UE. In one example, T depends on the minimum (smallest) sub-carrier spacing of the signal/channel of the pre-notification channel/signal and/or the signal/channel with acknowledgement to the UE and/or channel of report from UE. In one example, T depends on the maximum (largest) sub-carrier spacing of the signal/channel of the pre-notification channel/signal and/or the signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, after sending the pre-notification channel/signal, and after receiving an acknowledgement, the UE transmits a report and/or reference signal (e.g., SRS) at time t, or after a time t (for example, first symbol or slot or sub-frame or frame boundary at or after a time t). In one example, time t is between a duration T1 (inclusive or exclusive) and a duration T2 (inclusive or exclusive) from the start of the signal/channel with the pre-notification channel/signal. In one example, time t is between a duration T1 (inclusive or exclusive) and a duration T2 (inclusive or exclusive) from the end of the signal/channel with the pre-notification channel/signal. In one example, time t is between a duration T1 (inclusive or exclusive) and a duration T2 (inclusive or exclusive) from the start of the signal/channel with the acknowledgment to the UE. In one example, time t is between a duration T1 (inclusive or exclusive) and a duration T2 (inclusive or exclusive) from the end of the signal/channel with the acknowledgment to the UE. In one example, T1 and/or T2 is specified by system specifications and/or configured or updated by RRC signaling and/or MAC CE signaling and/or L1 control (e.g., DCI Format) signaling. In one example, T1 and/or T2 depends on the sub-carrier spacing of the signal/channel of the pre-notification channel/signal and/or signal/channel with acknowledgement to the UE and/or channel of report from UE. In one example, T1 and/or T2 depends on the minimum (smallest) sub-carrier spacing of the signal/channel of the pre-notification channel/signal and/or the signal/channel with acknowledgement to the UE and/or channel of report from UE. In one example, T1 and/or T2 depends on the maximum (largest) sub-carrier spacing of the signal/channel of the pre-notification channel/signal and/or the signal/channel with acknowledgement to the UE and/or channel of report from UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, T1 can be zero. In one example, T2 can be infinity.

In one example, after sending a first pre-notification channel/signal if the UE doesn't receive the acknowledgment, the UE can transmit a second pre-notification channel/signal after time T (or at or after time T, or at time T). In one example, T is from the start of the first pre-notification channel/signal. In one example, T is from the end of the first pre-notification channel/signal. In one example T, is from the start of the signal/channel with acknowledgment to the UE of the first pre-notification channel/signal (e.g., this can be based on the latest expected acknowledgement to the first pre-notification channel/signal). In one example T, is from the end of the signal/channel with acknowledgment to the UE of the first pre-notification channel/signal (e.g., this can be based on the latest expected acknowledgement to the first pre-notification channel/signal). In one example, T is specified by system specifications and/or configured or updated by RRC signaling and/or MAC CE signaling and/or L1 control (e.g., DCI Format) signaling. In one example, T depends on the sub-carrier spacing of the signal/channel of the scheduling request and/or signal/channel with acknowledgement to the UE and/or channel of report from UE. In one example, T depends on the minimum (smallest) sub-carrier spacing of the signal/channel of the pre-notification channel/signal and/or the signal/channel with acknowledgement to the UE and/or channel of report from UE. In one example, T depends on the maximum (largest) sub-carrier spacing of the signal/channel of the pre-notification channel/signal and/or the signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, the acknowledgement to the pre-notification channel/signal can be a DCI Format acknowledging the reception of the pre-notification channel/signal.

In one example, the pre-notification signal/channel is semi-persistent, wherein the UE sends the pre-notification signal/channel with a periodicity P and until a timer T expires. The gNB/TRP/network can acknowledge the pre-notification signal/channel. In one example, T and/or P can be specified by system specifications and/or configured or updated by RRC signaling and/or MAC CE signaling and/or L1 control (e.g., DCI Format) signaling.

In one example, the pre-notification signal/channel is semi-persistent, wherein the UE sends the pre-notification signal/channel with a periodicity P and for N times. The gNB/TRP/network can acknowledge the pre-notification signal/channel. In one example, P and/or N can be specified by system specifications and/or configured or updated by RRC signaling and/or MAC CE signaling and/or L1 control (e.g., DCI Format) signaling.

In one example, the pre-notification signal/channel is semi-persistent, wherein the UE sends the pre-notification signal/channel with a periodicity P and until one of the following events occurs: (1) a timer T expires (2) the UE receives an acknowledgement from the gNB/TRP/network. In one example, T and/or P can be specified by system specifications and/or configured or updated by RRC signaling and/or MAC CE signaling and/or L1 control (e.g., DCI Format) signaling.

In one example, the pre-notification signal/channel is semi-persistent, wherein the UE sends the pre-notification signal/channel with a periodicity P and until one of the following events occurs: (1) N transmissions of the pre-notification signal/channel (2) the UE receives an acknowledgement from the gNB/TRP/network. In one example, P and/or N can be specified by system specifications and/or configured or updated by RRC signaling and/or MAC CE signaling and/or L1 control (e.g., DCI Format) signaling.

FIG. 20 illustrates a flowchart of an example procedure 2000 for UE-initiated reporting according to embodiments of the present disclosure. For example, procedure 2000 for UE-initiated reporting can be performed by the UE 115 and the gNB 102 and/or network 130 in the wireless network 100 of FIG. 1. This example is for illustration only and other embodiments can be used without departing from the scope of the present disclosure.

The procedure begins in 2010, a UE sends a pre-notification to a BS. In 2020, the BS receives the pre-notification. In 2030, the UE sends a report to the BS. In 2040, the BS receives the report from the UE.

In one example, with reference to FIG. 20, the UE can send a signal to the gNB/TRP/network, wherein the signal can be a pre-notification channel/signal. The pre-notification channel/signal is for an UL transmission that includes a report from the UE. There is no acknowledgment for the pre-notification channel/signal. The UE sends the report after sending the pre-notification channel/signal. In an alternative example, the UE transmits a reference signal, e.g., a SRS.

In one example, after sending the pre-notification channel/signal, the UE transmits a report at time t, or after a time t (for example, first symbol or slot or sub-frame or frame boundary at or after a time t). In one example, time t is a duration T from the start of the signal/channel with the pre-notification channel/signal. In one example, time t is a duration T from the end of the signal/channel with the pre-notification channel/signal. In one example, T is specified by system specifications and/or configured or updated by RRC signaling and/or MAC CE signaling and/or L1 control (e.g., DCI Format) signaling. In one example, T depends on the sub-carrier spacing of the signal/channel of the pre-notification channel/signal and/or channel of report from UE. In one example, T depends on the minimum (smallest) sub-carrier spacing of the signal/channel of the pre-notification channel/signal and/or channel of report from UE. In one example, T depends on the maximum (largest) sub-carrier spacing of the signal/channel of the pre-notification channel/signal and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, after sending the pre-notification channel/signal, the UE transmits a report at time t, or after a time t (for example, first symbol or slot or sub-frame or frame boundary at or after a time t). In one example, time t is between a duration T1 (inclusive or exclusive) and a duration T2 (inclusive or exclusive) from the start of the signal/channel with the pre-notification channel/signal. In one example, time t is between a duration T1 (inclusive or exclusive) and a duration T2 (inclusive or exclusive) from the end of the signal/channel with the pre-notification channel/signal. In one example, T1 and/or T2 is specified by system specifications and/or configured or updated by RRC signaling and/or MAC CE signaling and/or L1 control (e.g., DCI Format) signaling. In one example T1 and/or T2, depends on the sub-carrier spacing of the signal/channel of the pre-notification channel/signal and/or channel of report from UE. In one example, T1 and/or T2 depends on the minimum (smallest) sub-carrier spacing of the signal/channel of the pre-notification channel/signal and/or channel of report from UE. In one example, T1 and/or T2 depends on the maximum (largest) sub-carrier spacing of the signal/channel of the pre-notification channel/signal and/or channel of report from UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, T1 can be zero. In one example, T2 can be infinity.

In one example, the gNB/TRP/network can send signal/channel to the UE to configure or schedule an UL transmission from the UE that includes a report and/or reference signal (e.g., SRS) transmission.

In one example, the signal/channel from the gNB/TRP/network to configure/activated/trigger/schedule an UL transmission that includes a report from a UE is in response to a scheduling request (SR) from the UE.

In one example, after receiving a scheduling request from a UE, the gNB/TRP/network transmits a channel/signal allocating/scheduling UL resources for report from UE at time T from the scheduling request. In one example, Tis from the start of the signal/channel with the scheduling request. In one example, T is from the end of the signal/channel with the scheduling request. In one example T, is to the start of the signal/channel allocating/scheduling UL resources for report from UE. In one example T, is to the end of the signal/channel allocating/scheduling UL resources for report from UE. In one example T, is to the start of the slot/subframe/frame containing the signal/channel allocating/scheduling UL resources for report from UE. In one example T, is to the end of the slot/subframe/frame containing the signal/channel allocating/scheduling UL resources for report from UE. In one example, T is specified by system specifications and/or configured or updated by RRC signaling and/or MAC CE signaling and/or L1 control (e.g., DCI Format) signaling. In one example T, depends on the sub-carrier spacing of the signal/channel of the scheduling request and/or signal/channel allocating/scheduling UL resources for report from UE and/or channel of report from UE. In one example, T depends on the minimum (smallest) sub-carrier spacing of the signal/channel of the scheduling request and/or signal/channel allocating/scheduling UL resources for report from UE and/or channel of report from UE. In one example, T depends on the maximum (largest) sub-carrier spacing of the signal/channel of the scheduling request and/or signal/channel allocating/scheduling UL resources for report from UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, after receiving a scheduling request from a UE, the gNB/TRP/network transmits a channel/signal allocating/scheduling UL resources for report from UE before time T (or before or at time T) from the scheduling request. In one example, T is from the start of the signal/channel with the scheduling request. In one example, T is from the end of the signal/channel with the scheduling request. In one example, T is to the start of the signal/channel allocating/scheduling UL resources for report from UE. In one example, T is to the end of the signal/channel allocating/scheduling UL resources for report from UE. In one example, T is to the start of the slot/subframe/frame containing the signal/channel allocating/scheduling UL resources for report from UE. In one example, T is to the end of the slot/subframe/frame containing the signal/channel allocating/scheduling UL resources for report from UE. In one example, T is specified by system specifications and/or configured or updated by RRC signaling and/or MAC CE signaling and/or L1 control (e.g., DCI Format) signaling. In one example, T depends on the sub-carrier spacing of the signal/channel of the scheduling request and/or signal/channel allocating/scheduling UL resources for report from UE and/or channel of report from UE. In one example, T depends on the minimum (smallest) sub-carrier spacing of the signal/channel of the scheduling request and/or signal/channel allocating/scheduling UL resources for report from UE and/or channel of report from UE. In one example, T depends on the maximum (largest) sub-carrier spacing of the signal/channel of the scheduling request and/or signal/channel allocating/scheduling UL resources for report from UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, after receiving a scheduling request from a UE, the gNB/TRP/network transmits a channel/signal allocating/scheduling UL resources for report from UE at time t from the scheduling request, such that one of (1) T1<t<T2, or (2) T1≤t≤T2 or (3) T1<t≤T2 or (4) T1≤t<T2. In one example, T1 and/or T2 is/are from the start of the signal/channel with the scheduling request. In one example, T1 and/or T2 is/are from the end of the signal/channel with the scheduling request. In one example, T1 and/or T2 is/are to the start of the signal/channel allocating/scheduling UL resources for report from UE. In one example, T1 and/or T2 is/are to the end of the signal/channel allocating/scheduling UL resources for report from UE. In one example, T1 and/or T2 is/are to the start of the slot/subframe/frame containing the signal/channel allocating/scheduling UL resources for report from UE. In one example, T1 and/or T2 is/are to the end of the slot/subframe/frame containing the signal/channel allocating/scheduling UL resources for report from UE. In one example, T1 and/or T2 is specified by system specifications and/or configured or updated by RRC signaling and/or MAC CE signaling and/or L1 control (e.g., DCI Format) signaling. In one example T1 and/or T2 depends on the sub-carrier spacing of the signal/channel of the scheduling request and/or signal/channel allocating/scheduling UL resources for report from UE and/or channel of report from UE. In one example, T1 and/or T2 depends on the minimum (smallest) sub-carrier spacing of the signal/channel of the scheduling request and/or signal/channel allocating/scheduling UL resources for report from UE and/or channel of report from UE. In one example, T1 and/or T2 depends on the maximum (largest) sub-carrier spacing of the signal/channel of the scheduling request and/or signal/channel allocating/scheduling UL resources for report from UE and/or channel of report from UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ).

In one example, the signal/channel from the gNB/TRP/network to configure/activate/trigger/schedule an UL transmission that includes a report and/or reference signal (e.g., SRS) transmission from a UE is autonomously generated by the gNB/TRP/network.

In the following examples, a report can be an uplink transmission from a UE, which can include a report including information based on measurements performed by the UE as aforementioned, and/or an uplink transmission from a UE, which can include a reference signal for measurement to be performed at the gNB (e.g., the gNB 102) (e.g., sounding reference signal).

In one example, a UE can send a report to the gNB/TRP/Network on uplink resources. The report can include one part or one stage.

In one example, the UE can send a report to the gNB/TRP/Network on uplink resources based on a channel/signal, from gNB/TRP/Network, allocating/scheduling UL resources for a report from the UE. The channel/signal, from gNB/TRP/Network, allocating/scheduling UL resources for a report from the UE can be sent in response to a scheduling request from the UE.

In one example, the UE can send a report to the gNB/TRP/Network on uplink resources based on a channel/signal, from gNB/TRP/Network, allocating/scheduling UL resources for a report from the UE. The channel/signal, from gNB/TRP/Network, allocating/scheduling UL resources for a report from the UE can be sent autonomously from the gNB/TRP/Network.

In one example, the UE can send a report to the gNB/TRP/Network on uplink resources based on a pre-notification channel/signal from UE and after an acknowledgment of the pre-notification channel/signal is received from the gNB/TRP/Network.

In one example, the UE can send a report to the gNB/TRP/Network on uplink resources based on a pre-notification channel/signal from UE. The notification channel/signal may not be acknowledged from the gNB/TRP/Network.

In one example, the UE can send a report to the gNB/TRP/Network on uplink resources without sending a scheduling request or a pre-notification channel/signal and without receiving a channel/signal, from gNB/TRP/Network, allocating/scheduling UL resources for the report from the UE.

In one example, the UE (e.g., the UE 116) can send a report in UL resources to the gNB/TRP/Network. If the gNB/TRP/Network receives the UE report, the gNB/TRP/Network can acknowledge UE report.

In one example, after sending the report, if the UE doesn't receive an acknowledgement, the UE can re-transmit the UE report or transmit a new UE report.

In one example, after sending the report, the UE expects an acknowledgment at time T from the report. In one example, T is from the start of the signal/channel that includes the report. In one example T, is from the end of the signal/channel that includes the report. In one example, T is to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel that includes the report and/or signal/channel with acknowledgement to the UE. In one example, T depends on the minimum (smallest) sub-carrier spacing of the signal/channel that includes the report and/or signal/channel with acknowledgement to the UE. In one example, T depends on the maximum (largest) sub-carrier spacing of the signal/channel that includes the report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment at time T, as aforementioned, the UE can retransmit the report or a new report. In one example, if the UE receives an acknowledgment at time T, as aforementioned, the UE can update a parameter based on the report as described later in this disclosure.

In one example, after sending the report, the UE expects an acknowledgment before time T (or before or at time T) from the report. In one example, T is from the start of the signal/channel that includes the report. In one example, T is from the end of the signal/channel that includes the report. In one example, T is to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel that includes the report and/or signal/channel with acknowledgement to the UE. In one example, T depends on the minimum (smallest) sub-carrier spacing of the signal/channel that includes the report and/or signal/channel with acknowledgement to the UE. In one example, T depends on the maximum (largest) sub-carrier spacing of the signal/channel that includes the report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment before time T (or before or at time T), as aforementioned, the UE can retransmit the report or a new report. In one example, if the UE receives an acknowledgment before time T (or before or at time T), as aforementioned, the UE can update a parameter based on the report as described later in this disclosure.

In one example, after sending the report, the UE expects an acknowledgment at time t from the report, such that one of (1) T1<t<T2, or (2) T1≤t≤T2 or (3) T1<t≤T2 or (4) T1≤t<T2. In one example, T1 and/or T2 is from the start of the signal/channel that includes the report. In one example, T1 and/or T2 is from the end of the signal/channel that includes the report. In one example, T1 and/or T2 is to the start of the signal/channel with acknowledgment to the UE. In one example, T1 and/or T2 is to the end of the signal/channel with acknowledgment to the UE. In one example, T1 and/or T2 is to the start of the slot/subframe/frame containing the signal/channel with acknowledgment to the UE. In one example T1 and/or T2 is to the end of the slot/subframe/frame containing the signal/channel with acknowledgement to the UE. In one example, T1 and/or T2 is specified by system specifications and/or configured or updated by RRC signaling and/or MAC CE signaling and/or L1 control (e.g., DCI Format) signaling. In one example, T1 and/or T2 depends on the sub-carrier spacing of the signal/channel that includes the report and/or signal/channel with acknowledgement to the UE. In one example, T1 and/or T2 depend on the minimum (smallest) sub-carrier spacing of the signal/channel that includes the report and/or signal/channel with acknowledgement to the UE. In one example, T1 and/or T2 depend on the maximum (largest) sub-carrier spacing of the signal/channel that includes the report and/or signal/channel with acknowledgement to the UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, if the UE doesn't receive an acknowledgment at time t, the UE can retransmit the report or a new report, such that one of (1) T1<t<T2, or (2) T1≤t≤T2 or (3) T1<t≤T2 or (4) T1≤ t<T2. If the UE receives an acknowledgment at time t, as aforementioned, the UE can update a parameter based on the report as described later in this disclosure.

In one example, after sending a first report if the UE doesn't receive the acknowledgement, the UE can transmit a second report after time T (or at or after time T, or at time T), e.g., the second report can be a re-transmission of the first report or a new report. In one example, T is from the start of the signal/channel that includes the first report. In one example, T is from the end of the signal/channel with that includes the first report. In one example T, is from the start of the signal/channel with acknowledgment to the UE of the first report (e.g., this can be based on the latest expected acknowledgement to the first report). In one example T, is from the end of the signal/channel with acknowledgment to the UE of the first report (e.g., this can be based on the latest expected acknowledgement to the first report). In one example, T is specified by system specifications and/or configured or updated by RRC signaling and/or MAC CE signaling and/or L1 control (e.g., DCI Format) signaling. In one example, T depends on the sub-carrier spacing of the signal/channel of the scheduling request and/or signal/channel with acknowledgement to the UE and/or channel of report from UE. In one example, T depends on the minimum (smallest) sub-carrier spacing of the signal/channel that includes the report and/or signal/channel with acknowledgement to the UE. In one example, T depends on the maximum (largest) sub-carrier spacing of the signal/channel that includes the report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, the acknowledgement to the report from the UE can be a DCI Format acknowledging the reception of the report from the UE.

In one example, there is no acknowledgement to the report from the UE.

In one example, the report from the UE is semi-persistent, wherein the UE sends the report with a periodicity P and until a timer T expires and/or for N instances. The gNB/TRP/network can acknowledge the UE report. In one example, T and/or P and/or N can be specified by system specifications and/or configured or updated by RRC signaling and/or MAC CE signaling and/or L1 control (e.g., DCI Format) signaling.

In one example, the report from the UE is semi-persistent, wherein the UE sends the report with a periodicity P and for N times. The gNB/TRP/network can acknowledge the UE report. In one example, P and/or N can be specified by system specifications and/or configured or updated by RRC signaling and/or MAC CE signaling and/or L1 control (e.g., DCI Format) signaling.

In one example, the report from the UE is semi-persistent, wherein the UE sends the report with a periodicity P and until one of the following events occurs: (1) a timer T expires and/or for N instances (2) the UE receives an acknowledgement from the gNB/TRP/network. In one example, T and/or P and/or N can be specified by system specifications and/or configured or updated by RRC signaling and/or MAC CE signaling and/or L1 control (e.g., DCI Format) signaling.

In one example, the report from the UE is semi-persistent, wherein the UE sends the report with a periodicity P and until one of the following events occurs: (1) N transmissions of the report (2) the UE receives an acknowledgement from the gNB/TRP/network. In one example, P and/or N can be specified by system specifications and/or configured or updated by RRC signaling and/or MAC CE signaling and/or L1 control (e.g., DCI Format) signaling.

In the following examples, a report can be an uplink transmission from a UE, which can include a report including information based on measurements performed by the UE as aforementioned, and/or an uplink transmission from a UE, which can include a reference signal for measurement to be performed at the gNB (e.g., SRS).

In one example of the following examples, the sub-carrier spacing of the signal/channel of the first stage/part of the report and the sub-carrier spacing of the signal/channel of the second stage/part of the report are the same. In one example of the following examples, the sub-carrier spacing of the signal/channel of the first stage/part of the report and the sub-carrier spacing of the signal/channel of the second stage/part of the report can be different.

In one example, a UE can send a report to the gNB/TRP/Network on uplink resources. The report can include two parts or two stages. The two parts or stages can be transmitted in the same slot (similar to two-part CSI/UCI reporting). Or the two parts or stages can be transmitted in two different slots. Or the two parts or stages can be transmitted in the same slot (similar to two-part CSI/UCI reporting) or in two different slots, e.g., depending on the UL resources allocated for the report.

In one example, the UE can send a two-stage report or two-part report to the gNB/TRP/Network on uplink resources based on a channel/signal, from gNB/TRP/Network, allocating/scheduling UL resources for a report from the UE. The channel/signal, from gNB/TRP/Network, allocating/scheduling UL resources for a report from the UE can be sent in response to a scheduling request from the UE.

In one example, the UE can send a two-stage report or two-part report to the gNB/TRP/Network on uplink resources based on a channel/signal, from gNB/TRP/Network, allocating/scheduling UL resources for a report from the UE. The channel/signal, from gNB/TRP/Network, allocating/scheduling UL resources for a report from the UE can be sent autonomously from the gNB/TRP/Network.

In one example, the UE can send a two-stage report or two-part report to the gNB/TRP/Network on uplink resources based on a pre-notification channel/signal from UE and after an acknowledgment of the pre-notification channel/signal is received from the gNB/TRP/Network.

In one example, the UE can send a two-stage report or two-part report to the gNB/TRP/Network on uplink resources based on a pre-notification channel/signal from UE. The notification channel/signal may not be acknowledged from the gNB/TRP/Network.

In one example, the UE can send a two-stage report or two-part report to the gNB/TRP/Network on uplink resources without sending a scheduling request or a pre-notification channel/signal and without receiving a channel/signal, from gNB/TRP/Network, allocating/scheduling UL resources for the report from the UE.

In one example, the report from the UE can be a one-part report (e.g., single stage) or a two-part report (e.g., with two-parts or two stages). Whether to have one-part or two-parts can depend on a condition. The condition can be based on one or more of the following:
Depends on amount of UL resources. If there are sufficient uplink resources, two-part UE report is used, else a one-part UE report is used. The threshold to switch between a two-part UE report and a one-part UE can be specified by system specifications and/or configured or updated by RRC signaling and/or MAC CE signaling and/or L1 control (e.g., DCI Format) signaling.
Depends on the report type. For example, some report types can be one-part, while other report types can be two-part. This can be based on system specifications and/or configuration or update by RRC signaling and/or MAC CE signaling and/or L1 control (e.g., DCI Format) signaling. For example, a beam report or a wideband (WB) CSI report can be configured as one-part report, while a subband (SB)-CSI report can be configured as a two-part report.
Depends on payload size of report. If the payload size is larger than or (larger than or equal to) a threshold two-part report is used, else one-part report is used. The payload size threshold to switch between a two-part UE report and a one-part UE can be specified by system specifications and/or configured or updated by RRC signaling and/or MAC CE signaling and/or L1 control (e.g., DCI Format) signaling
Determined based on UE's implementation.
Depends on the type of UL transmissions, e.g., whether the UL transmissions is or contains a report or a signal for measurement at the gNB. In one example, if the UL transmission contains a report, the UL transmission is two-parts. In one example, if the UL transmission contains a report, the UL transmission is one-part. In one example, if the UL transmission contains a signal for measurement at the gNB, the UL transmission is one-part. In one example, if the UL transmission contains a signal for measurement at the gNB, the UL transmission is two-parts.
. . .

In one example, a flag or indication in the first stage/part can indicate whether or not there is a second stage/part.

In one example, it can be determined implicitly based on information in the first stage/part whether or not there is a second stage/part (e.g., based on report type and/or report size).

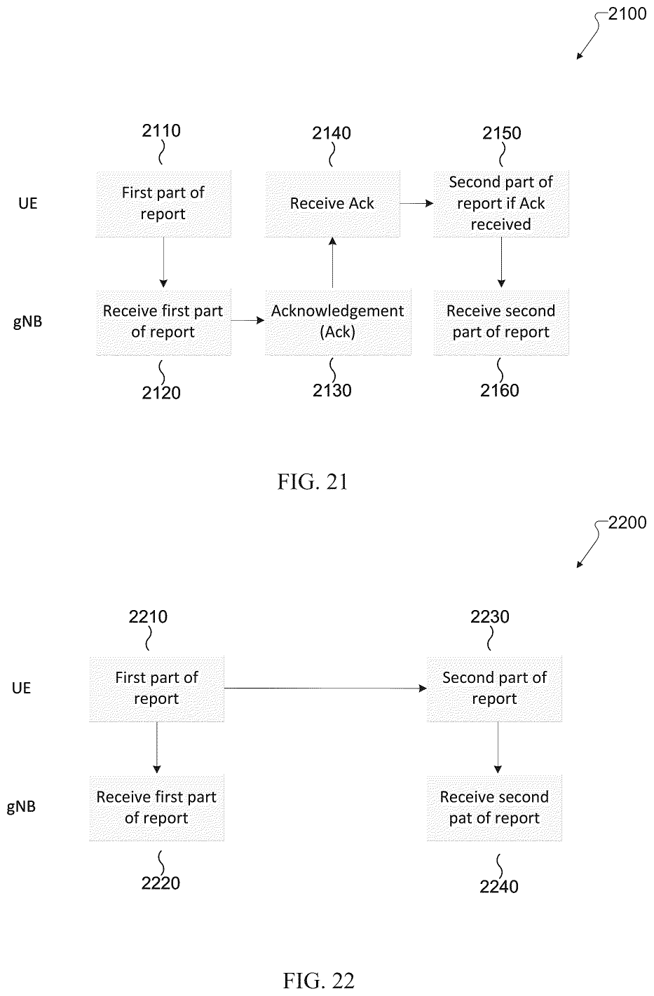

FIG. 21 illustrates a flowchart of an example procedure 2100 for UE-initiated reporting according to embodiments of the present disclosure. For example, procedure 2100 for UE-initiated reporting can be performed by the UE 116 and the gNB 102 and/or network 130 in the wireless network 100 of FIG. 1. This example is for illustration only and other embodiments can be used without departing from the scope of the present disclosure.

The procedure begins in 2110, a UE sends a first part of a report to a BS. In 2120, the BS receives the first part of the report. In 2130, the BS sends an ACK to the UE. In 2140, the UE receives the ACK. In 2150, the UE sends a second part of the report if the ACK is received. In 2160, the BS receives the second part of the report.

In one example, with reference to FIG. 21, the UE can send a channel/signal to the gNB/TRP/network, wherein the channel/signal can be a first stage or a first part report from the UE. The network (e.g., the network 130) acknowledges the first stage or the first part report from the UE. After the UE receives the acknowledgment, the UE transmits a second stage or a second part report.

In one example, after sending the first stage or the first part of report, if the UE doesn't receive an acknowledgement, the UE can re-transmit the first stage or the first part of report or a new first stage or first part of report.

In one example, after sending the first stage or the first part of report, the UE expects an acknowledgment at time T from the first stage or the first part of report. In one example, T is from the start of the signal/channel of the first stage or the first part of report. In one example T, is from the end of the signal/channel of the first stage or the first part of report. In one example, T is to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel of the first stage or the first part of report and/or signal/channel with acknowledgement to the UE and/or signal/channel of the second stage or the second part of report. In one example, T depends on the minimum (smallest) sub-carrier spacing of the signal/channel of the first stage or the first part of report and/or signal/channel with acknowledgement to the UE and/or signal/channel of the second stage or the second part of report. In one example, T depends on the maximum (largest) sub-carrier spacing of the signal/channel of the first stage or the first part of report and/or signal/channel with acknowledgement to the UE and/or signal/channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment at time T, as aforementioned, the UE can retransmit the first stage or the first part of report or transmit a new first stage or first part of report. In one example, if the UE receives an acknowledgment at time T, as aforementioned, the UE can transmit a second stage or a second part of report.

In one example, after sending the first stage or the first part of report, the UE expects an acknowledgment before time T (or before or at time T) from the first stage or the first part of report. In one example, T is from the start of the signal/channel of the first stage or the first part of report. In one example, T is from the end of the signal/channel of the first stage or the first part of report. In one example, Tis to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel of the first stage or the first part of report and/or signal/channel with acknowledgement to the UE and/or channel of the second stage or the second part of report. In one example, T depends on the minimum (smallest) sub-carrier spacing of the signal/channel of the first stage or the first part of report and/or signal/channel with acknowledgement to the UE and/or signal/channel of the second stage or the second part of report. In one example, T depends on the maximum (largest) sub-carrier spacing of the signal/channel of the first stage or the first part of report and/or signal/channel with acknowledgement to the UE and/or signal/channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment before time T (or before or at time T), as aforementioned, the UE can retransmit the first stage or the first part of report or transmit a new first stage or first part of report. In one example, if the UE receives an acknowledgment before time T (or before or at time T), as aforementioned, the UE transmits a second stage or a second part of report.

In one example, after sending the first stage or the first part of report, the UE expects an acknowledgment at time t from the first stage or the first part of report, such that one of (1) T1<t<T2, or (2) T1≤t≤ T2 or (3) T1<t≤ T2 or (4) T1≤t<T2. In one example, T1 and/or T2 is from the start of the signal/channel of the first stage or the first part of report. In one example, T1 and/or T2 is from the end of the signal/channel of the first stage or the first part of report. In one example, T1 and/or T2 is to the start of the signal/channel with acknowledgment to the UE. In one example, T1 and/or T2 is to the end of the signal/channel with acknowledgment to the UE. In one example, T1 and/or T2 is to the start of the slot/subframe/frame containing the signal/channel with acknowledgment to the UE. In one example T1 and/or T2 is to the end of the slot/subframe/frame containing the signal/channel with acknowledgement to the UE. In one example, T1 and/or T2 is specified by system specifications and/or configured or updated by RRC signaling and/or MAC CE signaling and/or L1 control (e.g., DCI Format) signaling. In one example, T1 and/or T2 depends on the sub-carrier spacing of the signal/channel of the first stage or the first part of report and/or signal/channel with acknowledgement to the UE and/or channel of a second stage or a second part of report. In one example, T1 and/or T2 depends on the minimum (smallest) sub-carrier spacing of the signal/channel of the first stage or the first part of report and/or signal/channel with acknowledgement to the UE and/or signal/channel of the second stage or the second part of report. In one example, T1 and/or T2 depends on the maximum (largest) sub-carrier spacing of the signal/channel of the first stage or the first part of report and/or signal/channel with acknowledgement to the UE and/or signal/channel of the second stage or the second part of report. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, if the UE doesn't receive an acknowledgment at time t, the UE can retransmit the first stage or the first part of report or a new first stage or first part of report, such that one of (1) T1<t<T2, or (2) T1≤t≤T2 or (3) T1<<T2 or (4) T1<<T2. In one example, if the UE receives an acknowledgment at time t, as aforementioned, the UE can transmit a report a second stage or a second part of report.

In one example, after sending a first stage or a first part of report, and after receiving an acknowledgement, the UE can transmit a second stage or a second part of report.

In one example, after sending a first stage or a first part of report, and after receiving an acknowledgement, the UE transmits a second stage or a second part of report at time t. In one example, time t is a duration T from the start of the signal/channel of the first stage or the first part of report. In one example, time t is a duration T from the end of the signal/channel of the first stage or the first part of report. In one example, time t is a duration T from the start of the signal/channel with the acknowledgment to the UE. In one example, time t is a duration T from the end of the signal/channel with the acknowledgment to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel of the first stage or the first part of report and/or signal/channel with acknowledgement to the UE and/or channel of the second stage or the second part of report. In one example, T depends on the minimum (smallest) sub-carrier spacing of the signal/channel of the first stage or the first part of report and/or signal/channel with acknowledgement to the UE and/or signal/channel of the second stage or the second part of report. In one example, T depends on the maximum (largest) sub-carrier spacing of the signal/channel of the first stage or the first part of report and/or signal/channel with acknowledgement to the UE and/or signal/channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, after sending a first stage or a first part of report, and after receiving an acknowledgement, the UE transmits a second stage or a second part of report at time t. In one example, time t is between a duration T1 (inclusive or exclusive) and a duration T2 (inclusive or exclusive) from the start of the signal/channel of the first stage or the first part of report. In one example, time t is between a duration T1 (inclusive or exclusive) and a duration T2 (inclusive or exclusive) from the end of the signal/channel of the first stage or the first part of report. In one example, time t is between a duration T1 (inclusive or exclusive) and a duration T2 (inclusive or exclusive) from the start of the signal/channel with the acknowledgment to the UE. In one example, time t is between a duration T1 (inclusive or exclusive) and a duration T2 (inclusive or exclusive) from the end of the signal/channel with the acknowledgment to the UE. In one example, T1 and/or T2 is specified by system specifications and/or configured or updated by RRC signaling and/or MAC CE signaling and/or L1 control (e.g., DCI Format) signaling. In one example, T1 and/or T2 depends on the sub-carrier spacing of the signal/channel of the first stage or the first part of report and/or signal/channel with acknowledgement to the UE and/or signal/channel of the second stage or the second part of report. In one example, T1 and/or T2 depends on the minimum (smallest) sub-carrier spacing of the signal/channel of the first stage or the first part of report and/or signal/channel with acknowledgement to the UE and/or signal/channel of the second stage or the second part of report. In one example, T1 and/or T2 depends on the maximum (largest) sub-carrier spacing of the signal/channel of the first stage or the first part of report and/or signal/channel with acknowledgement to the UE and/or signal/channel of the second stage or the second part of report. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, T1 can be zero. In one example, T2 can be infinity.

In one example, after sending a first first-stage or a first first-part of report if the UE doesn't receive the acknowledgment, the UE can transmit a second first-stage or a second first-part of report after time T (or at or after time T, or at time T). In one example, T is from the start of the first first-stage or a first first-part of report. In one example, T is from the end of the first first-stage or the first first-part of report. In one example T, is from the start of the signal/channel with acknowledgment to the UE (e.g., the UE 116) of the first first-stage or a first first-part of report (e.g., this can be based on the latest expected acknowledgement to the first first-stage or the first first-part of report). In one example T, is from the end of the signal/channel with acknowledgment to the UE of the first first-stage or the first first-part of report channel/signal (e.g., this can be based on the latest expected acknowledgement to the first first-stage or the first first-part of report). In one example, T is specified by system specifications and/or configured or updated by RRC signaling and/or MAC CE signaling and/or L1 control (e.g., DCI Format) signaling. In one example, T depends on the sub-carrier spacing of the signal/channel of the scheduling request and/or signal/channel with acknowledgement to the UE and/or channel of report from UE (first and/or second state/part). In one example, T depends on the minimum (smallest) sub-carrier spacing of the signal/channel of the first stage or the first part of report and/or signal/channel with acknowledgement to the UE and/or signal/channel of the second stage or the second part of report. In one example, T depends on the maximum (largest) sub-carrier spacing of the signal/channel of the first stage or the first part of report and/or signal/channel with acknowledgement to the UE and/or signal/channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, the acknowledgement to the first stage or the first part of report can be a DCI Format acknowledging the reception of the first stage or the first part of report.

In one example, the acknowledgement to the first stage or the first part of report can be a channel/signal allocating/scheduling UL resources for the second stage or the second part of report from UE. For example, this can be a DCI Format in PDCCH transmission that includes UL grant. For example, this can be DCI Format 0_0 or DCI Format 0_1 or DCI Format 0_2.

In one example, the first stage/part of report from the UE is semi-persistent, wherein the UE sends the first stage/part of report with a periodicity P and until a timer T expires. The gNB/TRP/network can acknowledge the first stage/part UE report. In one example, T and/or P can be specified by system specifications and/or configured or updated by RRC signaling and/or MAC CE signaling and/or L1 control (e.g., DCI Format) signaling.

In one example, the first stage/part of report from the UE is semi-persistent, wherein the UE sends the first stage/part of report with a periodicity P and for N times. The gNB/TRP/network can acknowledge the first stage/part UE report. In one example, P and/or N can be specified by system specifications and/or configured or updated by RRC signaling and/or MAC CE signaling and/or L1 control (e.g., DCI Format) signaling.

In one example, the first stage/part of report from the UE is semi-persistent, wherein the UE sends the first stage/part of report with a periodicity P and until one of the following events occurs: (1) a timer T expires (2) the UE receives an acknowledgement from the gNB/TRP/network. In one example, T and/or P can be specified by system specifications and/or configured or updated by RRC signaling and/or MAC CE signaling and/or L1 control (e.g., DCI Format) signaling.

In one example, the first stage/part of report from the UE is semi-persistent, wherein the UE sends the first stage/part of report with a periodicity P and until one of the following events occurs: (1) N transmissions of the first stage/part of report (2) the UE receives an acknowledgement from the gNB/TRP/network. In one example, N and/or P can be specified by system specifications and/or configured or updated by RRC signaling and/or MAC CE signaling and/or L1 control (e.g., DCI Format) signaling.

FIG. 22 illustrates a flowchart of an example procedure 2200 for UE-initiated reporting according to embodiments of the present disclosure. For example, procedure 2200 for UE-initiated reporting can be performed by the UE 111 and the gNB 102 and/or network 130 in the wireless network 100 of FIG. 1. This example is for illustration only and other embodiments can be used without departing from the scope of the present disclosure.

The procedure begins in 2210, a UE sends a first part of a report to a BS. In 2220, the BS receives the first part of the report. In 2230, the UE sends a second part of the report. In 2240, the BS receives the second part of the report.

In one example, with reference to FIG. 22, the UE can send a signal to the gNB/TRP/network, wherein the signal can be a first stage or a first part report from the UE. There is no acknowledgment for the first stage or the first part report from the UE. The UE sends a second stage or a second part report after sending the first stage or the first part of report.

In one example, after sending the first stage or the first part of report, the UE transmits a second stage or a second part of report at time t. In one example, time t is a duration T from the start of the signal/channel of the first stage or the first part of report. In one example, time t is a duration T from the end of the signal/channel of the first stage or the first part of report. In one example, T is specified by system specifications and/or configured or updated by RRC signaling and/or MAC CE signaling and/or L1 control (e.g., DCI Format) signaling. In one example, T depends on the sub-carrier spacing of the signal/channel of the first stage or the first part of report and/or signal/channel of the second stage or the second part of report. In one example, T depends on the minimum (smallest) sub-carrier spacing of the signal/channel of the first stage or the first part of report and/or signal/channel of the second stage or the second part of report. In one example, T depends on the maximum (largest) sub-carrier spacing of the signal/channel of the first stage or the first part of report and/or signal/channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, after sending the first stage or the first part of report, the UE transmits a second stage or a second part of report at time t. In one example, time t is between a duration T1 (inclusive or exclusive) and a duration T2 (inclusive or exclusive) from the start of the signal/channel of the first stage or the first part of report. In one example, time t is between a duration T1 (inclusive or exclusive) and a duration T2 (inclusive or exclusive) from the end of the signal/channel of the first stage or the first part of report. In one example, T1 and/or T2 is specified by system specifications and/or configured or updated by RRC signaling and/or MAC CE signaling and/or L1 control (e.g., DCI Format) signaling. In one example T1 and/or T2, depends on the sub-carrier spacing of the signal/channel of the first stage or the first part of report and/or signal/channel of the second stage or the second part of report. In one example, T1 and/or T2 depends on the minimum (smallest) sub-carrier spacing of the signal/channel of the first stage or the first part of report and/or signal/channel of the second stage or the second part of report. In one example, T1 and/or T2 depends on the maximum (largest) sub-carrier spacing of the signal/channel of the first stage or the first part of report and/or signal/channel of the second stage or the second part of report. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, T1 can be zero. In one example, T2 can be infinity.

In one example, the UE can send a second stage or a second part of report in UL resources to the gNB/TRP/Network. If the gNB/TRP/Network receives the second stage or the second part of report, the gNB/TRP/Network can acknowledge the second stage or the second part of report.

In one example, after sending the second stage or the second part of report, if the UE doesn't receive an acknowledgement, the UE can re-transmit the second stage or the second part of report or transmit a new second stage or second part of report.

In one example, after sending the second stage or the second part of report, the UE expects an acknowledgment at time T from the second stage or the second part of report. In one example, T is from the start of the signal/channel that includes the second stage or the second part of report. In one example T, is from the end of the signal/channel that includes the second stage or the second part of report. In one example, T is to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel that includes the second stage or the second part of report and/or signal/channel with acknowledgement to the UE. In one example, T depends on the minimum (smallest) sub-carrier spacing of the sub-carrier spacing of the signal/channel that includes the second stage or the second part of report and/or signal/channel with acknowledgement to the UE. In one example, T depends on the maximum (largest) sub-carrier spacing of the sub-carrier spacing of the signal/channel that includes the second stage or the second part of report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment at time T, as aforementioned, the UE can retransmit the second stage or the second part of report or a new second stage or second part of report. In one example, if the UE receives an acknowledgment at time T, as aforementioned, the UE can update a parameter based on the report as described later in this disclosure.

In one example, after sending the second stage or the second part of report, the UE expects an acknowledgment before time T (or before or at time T) from the second stage or the second part of report. In one example, T is from the start of the signal/channel that includes the second stage or the second part of report. In one example, T is from the end of the signal/channel that includes the second stage or the second part of report. In one example, T is to the start of the signal/channel with acknowledgment to the UE. In one example, T is to the end of the signal/channel with acknowledgment to the UE. In one example, T is to the start of the slot/subframe/frame containing the signal/channel with acknowledgment to the UE. In one example, T is to the end of the slot/subframe/frame containing the signal/channel with acknowledgement to the UE. In one example, T is specified by system specifications and/or configured or updated by RRC signaling and/or MAC CE signaling and/or L1 control (e.g., DCI Format) signaling. In one example, T depends on the sub-carrier spacing of the signal/channel that includes the second stage or the second part of report and/or signal/channel with acknowledgement to the UE. In one example, T depends on the minimum (smallest) sub-carrier spacing of the sub-carrier spacing of the signal/channel that includes the second stage or the second part of report and/or signal/channel with acknowledgement to the UE. In one example, T depends on the maximum (largest) sub-carrier spacing of the sub-carrier spacing of the signal/channel that includes the second stage or the second part of report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive an acknowledgment before time T (or before or at time T), as aforementioned, the UE can retransmit the second stage or the second part of report or a new second stage or second part of report. In one example, if the UE receives an acknowledgment before time T (or before or at time T), as aforementioned, the UE can update a parameter based on the report as described later in this disclosure.

In one example, after sending the second stage or the second part of report, the UE expects an acknowledgment at time t from the second stage or the second part of report, such that one of (1) T1<t<T2, or (2) T1≤t≤T2 or (3) T1<t≤T2 or (4) T1≤t<T2. In one example, T1 and/or T2 is from the start of the signal/channel that includes the second stage or the second part of report. In one example, T1 and/or T2 is from the end of the signal/channel that includes the second stage or the second part of report. In one example, T1 and/or T2 is to the start of the signal/channel with acknowledgment to the UE. In one example, T1 and/or T2 is to the end of the signal/channel with acknowledgment to the UE. In one example, T1 and/or T2 is to the start of the slot/subframe/frame containing the signal/channel with acknowledgment to the UE. In one example T1 and/or T2 is to the end of the slot/subframe/frame containing the signal/channel with acknowledgement to the UE. In one example, T1 and/or T2 is specified by system specifications and/or configured or updated by RRC signaling and/or MAC CE signaling and/or L1 control (e.g., DCI Format) signaling. In one example, T1 and/or T2 depends on the sub-carrier spacing of the signal/channel that includes the second stage or the second part of report and/or signal/channel with acknowledgement to the UE. In one example, T1 and/or T2 depends on the minimum (smallest) sub-carrier spacing of the sub-carrier spacing of the signal/channel that includes the second stage or the second part of report and/or signal/channel with acknowledgement to the UE. In one example, T1 and/or T2 depends on the maximum (largest) sub-carrier spacing of the sub-carrier spacing of the signal/channel that includes the second stage or the second part of report and/or signal/channel with acknowledgement to the UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, . . . ). In one example, if the UE doesn't receive an acknowledgment at time t, the UE can retransmit the second stage or the second part of report or a new second stage or second part of report, such that one of (1) T1<t<T2, or (2) T1≤t≤T2 or (3) T1<t≤ T2 or (4) T1≤t<T2. If the UE receives an acknowledgment at time t, as aforementioned, the UE can update a parameter based on the report as described later in this disclosure.

In one example, after sending a first second-stage or the first second-part of report if the UE doesn't receive the acknowledgement, the UE can transmit a second second-stage or a second second-part of report after time T (or at or after time T, or at time T), e.g., the second second-stage or the second second-part of report can be a re-transmission of the first second-stage or the first second-part of report or a new second-stage or second-part of report. In one example, T is from the start of the signal/channel that includes the first second-stage or the first second-part of report. In one example, T is from the end of the signal/channel that includes the first second-stage or the first second-part of report. In one example T, is from the start of the signal/channel with acknowledgment to the UE of the first second-stage or the first second-part of report (e.g., this can be based on the latest expected acknowledgement to the first report). In one example T, is from the end of the signal/channel with acknowledgment to the UE of the first second-stage or the first second-part of report (e.g., this can be based on the latest expected acknowledgement to the first report).

In one example, after sending a first second-stage/part of report (for example this can be associated with a first first-stage/part of report that is not acknowledged) if the UE doesn't receive the acknowledgement for the first second-stage/part of report, the UE can transmit a second first-stage/part of UE report followed by a second of second-stage/part of UE report after time T (or at or after time T, or at time T), e.g., the second first-stage part of report and/or the second second-stage part of report can be a re-transmission of the first first-stage/part of report or the first second-stage/part of report respectively, or a new first-stage/part of report and/or second-stage part of report. In one example, T is from the start of the signal/channel that includes the first second-stage/part of report. In one example, T is from the end of the signal/channel that includes the first second-stage/part of report. In one example T, is from the start of the signal/channel with acknowledgment to the UE of the first second-stage/part of report (e.g., this can be based on the latest expected acknowledgement to the first report). In one example T, is from the end of the signal/channel with acknowledgment to the UE of the first second-stage/part of report (e.g., this can be based on the latest expected acknowledgement to the first report). In one example, T is specified by system specifications and/or configured or updated by RRC signaling and/or MAC CE signaling and/or L1 control (e.g., DCI Format) signaling. In one example, T depends on the sub-carrier spacing of the signal/channel of the scheduling request and/or signal/channel with acknowledgement to the UE and/or channel of report (e.g., second stage) from UE. In one example, T depends on a UE capability. In one example, T depends on the minimum (smallest) sub-carrier spacing of the sub-carrier spacing of the signal/channel that includes the second stage or the second part of report and/or signal/channel with acknowledgement to the UE. In one example, T depends on the maximum (largest) sub-carrier spacing of the sub-carrier spacing of the signal/channel that includes the second stage or the second part of report and/or signal/channel with acknowledgement to the UE. In one example, T can be in units of symbols. In one example, T can be in units of slots. In one example, T can be in units of sub-frames. In one example, T can be in units of frames. In one example, T can be in units of time (e.g., millisecond, seconds, . . . ).

In one example, the acknowledgement to the second stage or the second part of report from the UE can be a DCI Format acknowledging the reception of the second stage or the second part of report from the UE.

In one example, there is no acknowledgement to the second stage or the second part of report from the UE.

In one example, the second stage/part of report from the UE is semi-persistent, wherein the UE sends the second stage/part of report with a periodicity P and until a timer T expires. The gNB/TRP/network can acknowledge the second stage/part UE report. In one example, T and/or P can be specified by system specifications and/or configured or updated by RRC signaling and/or MAC CE signaling and/or L1 control (e.g., DCI Format) signaling.

In one example, the second stage/part of report from the UE is semi-persistent, wherein the UE sends the second stage/part of report with a periodicity P and for N times. The gNB/TRP/network can acknowledge the second stage/part UE report. In one example, N and/or P can be specified by system specifications and/or configured or updated by RRC signaling and/or MAC CE signaling and/or L1 control (e.g., DCI Format) signaling.

In one example, the second stage/part of report from the UE is semi-persistent, wherein the UE sends the second stage/part of report with a periodicity P and until one of the following events occurs: (1) a timer T expires (2) the UE receives an acknowledgement from the gNB/TRP/network. In one example, T and/or P can be specified by system specifications and/or configured or updated by RRC signaling and/or MAC CE signaling and/or L1 control (e.g., DCI Format) signaling.

In one example, the second stage/part of report from the UE is semi-persistent, wherein the UE sends the second stage/part of report with a periodicity P and until one of the following events occurs: (1) N transmission of the second stage/part of report (2) the UE receives an acknowledgement from the gNB/TRP/network. In one example, N and/or P can be specified by system specifications and/or configured or updated by RRC signaling and/or MAC CE signaling and/or L1 control (e.g., DCI Format) signaling.

In one example, with reference to FIG. 22, the UE can send a signal to the gNB/TRP/network, wherein the signal can be a first stage/part of report from the UE. There is no acknowledgment for the first stage/part of report from the UE. The UE sends a second stage/part pf report from UE after sending the first stage/part of report from UE. There can be one acknowledgment sent after the second stage/part of report from UE. This acknowledgement can be associated with the first stage/part of report from UE and the second stage/part of report from UE.
In one example, if first stage/part of report from UE is not received (e.g., not successfully decoded or detected) by the gNB/TRP/Network, there is no acknowledgement sent from the gNB/TRP/Network to the UE.
In one example, if first stage/part of report from UE is received (e.g., successfully decoded or detected) by the gNB/TRP/Network, but second stage/part of report from UE is not received (e.g., not successfully decoded or detected) by the gNB/TRP/Network, there is an acknowledgement indicating that the first stage/part of report from UE has been received, but the second stage/part of report from UE has not been received. For example, this can be a negative acknowledgement (NACK).
In one example, if first stage/part of report from UE is received (e.g., successfully decoded or detected) by the gNB/TRP/Network, and second stage/part of report from UE is received (e.g., successfully decoded or detected) by the gNB/TRP/Network, there is an acknowledgement indicating that the first and second stage/part of report from UE has been received. For example, this can be a positive acknowledgement (e.g., ACK).

The timing of the acknowledgement and re-transmissions, if any, or new transmissions, if any, that is associated with the first and second stage/part of report from UE can follow the timing of the acknowledgement or re-transmissions or new transmissions associated with the second stage/part of report from UE as aforementioned.

In one example, the first and second stage/part of report from the UE are semi-persistent, wherein the UE sends the first and second stage/part of report with a periodicity P and until a timer T expires. The gNB/TRP/network can acknowledge the first and second stage/part UE report. In one example, T and/or P can be specified by system specifications and/or configured or updated by RRC signaling and/or MAC CE signaling and/or L1 control (e.g., DCI Format) signaling.

In one example, the first and second stage/part of report from the UE are semi-persistent, wherein the UE sends the first and second stage/part of report with a periodicity P and for N times. The gNB/TRP/network can acknowledge the first and second stage/part UE report. In one example, N and/or P can be specified by system specifications and/or configured or updated by RRC signaling and/or MAC CE signaling and/or L1 control (e.g., DCI Format) signaling.

In one example, the first and second stage/part of report from the UE are semi-persistent, wherein the UE sends the first and second stage/part of report with a periodicity P and until one of the following events occurs: (1) a timer T expires (2) the UE receives an acknowledgement from the gNB/TRP/network. In one example, T and/or P can be specified by system specifications and/or configured or updated by RRC signaling and/or MAC CE signaling and/or L1 control (e.g., DCI Format) signaling.

In one example, the first and second stage/part of report from the UE are semi-persistent, wherein the UE sends the first and second stage/part of report with a periodicity P and until one of the following events occurs: (1) N transmissions of the first and second stage/part of report (2) the UE receives an acknowledgement from the gNB/TRP/network. In one example, N and/or P can be specified by system specifications and/or configured or updated by RRC signaling and/or MAC CE signaling and/or L1 control (e.g., DCI Format) signaling.

After a report or message from the UE has been sent to the network, one or more parameters can be updated based on that report.

In one example, the TCI state or states used for DL channels or DL signals or the TCI state or states used for UL channels or UL signals can be updated based on the report or message from the UE.

In one example, handover or mobility can be triggered based on the report or message from the UE.

In one example, UL timing (e.g., TA value) can be updated based on the report or message from the UE.

In one example, the parameter(s) for a CSI report can be selected/updated/configured.
For example, the codebook type can be updated from Type I to Type II or vice versa.
For example, the rank (RI) value(s) for the report can be selected/updated.

In one example, the parameter(s) for the DL transmission (e.g. PDSCH) can be selected/updated/configured.
For example, modulation and coding scheme (MCS), DMRS precoding, number of layers etc. can be selected.

In one example, the parameter(s) for the UL transmission (e.g. PUSCH) can be selected/updated/configured.
For example, MCS, DMRS precoding, number of layers etc. can be selected.

In one example, the parameter(s) for the DL RS (e.g. CSI-RS, DMRS) can be selected/updated/configured.

In one example, the parameter(s) for the UL RS (e.g. SRS, DMRS) can be selected/updated/configured.

In some of these instances when parameters are updated in the UE and the gNB/TRP/Network, the timing of the update should be synchronized.

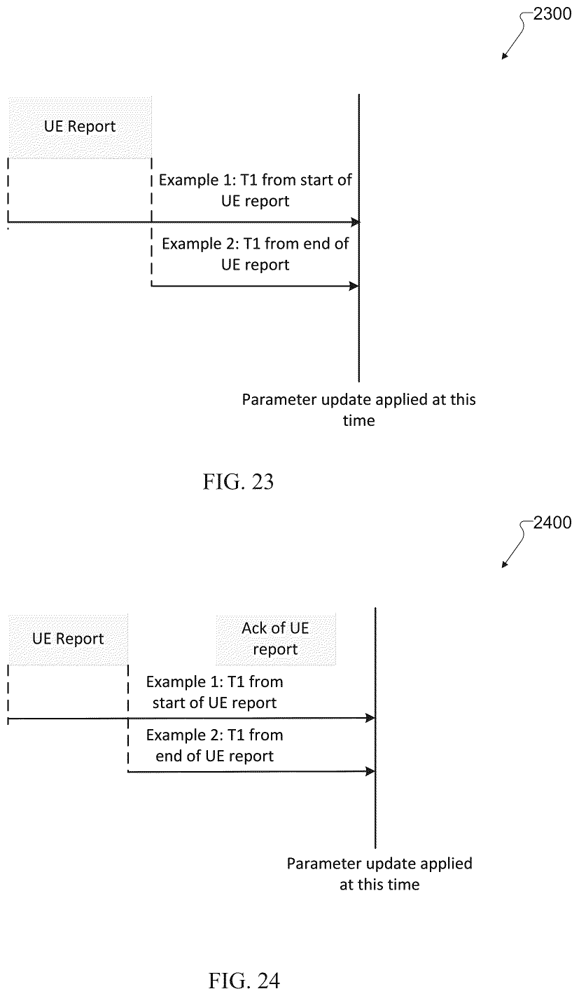

FIG. 23 illustrates timelines 2300 for parameter updates based on a UE report according to embodiments of the present disclosure. For example, timelines 2300 for parameter updates based on a UE report can be followed by any of the UEs 111-116 of FIG. 1, such as the UE 112, and/or the gNB 102 and/or network 130 in the wireless network 100 of FIG. 1. This example is for illustration only and other embodiments can be used without departing from the scope of the present disclosure.

In one example, a UE report includes one part or one stage. A parameter is updated based on the UE report. The parameter is updated after a time T1 from the UE report. In one example, the UE report has an acknowledgement, but the parameter update takes effect regardless of the acknowledgement. In one example, the UE report has no acknowledgement.

In one example, with reference to FIG. 23 Example 1, the update of the parameter is at time T1 from the start of the one part or one stage UE report.

In one example, with reference to FIG. 23 Example 2, the update of the parameter is at time T1 from the end of the one part or one stage UE report.

In one example, the update of the parameter is at the first symbol boundary at or after time T1 from the start of the UE report.

In one example, the update of the parameter is at the first symbol boundary at or after time T1 from the end of the UE (e.g., the UE 116) report.

In one example, the update of the parameter is at the first slot boundary at or after time T1 from the start of the UE report.

In one example, the update of the parameter is at the first slot boundary at or after time T1 from the end of the UE report.

In one example, the update of the parameter is at the first sub-frame boundary at or after time T1 from the start of the UE report.

In one example, the update of the parameter is at the first sub-frame boundary at or after time T1 from the end of the UE report.

In one example, the update of the parameter is at the first frame boundary at or after time T1 from the start of the UE report.

In one example, the update of the parameter is at the first frame boundary at or after time T1 from the end of the UE report.

In one example, the update of the parameter is at the first single frequency network (SFN) roll-over boundary (SFN=0) at or after time T1 from the start of the UE report.

In one example, the update of the parameter is at the first SFN roll-over boundary (SFN=0) at or after time T1 from the end of the UE report.

In one example, T1 is specified by system specifications and/or configured or updated by RRC signaling and/or MAC CE signaling and/or L1 control (e.g., DCI Format) signaling.

In one example, T1 can depend on the sub-carrier spacing of the signal/channel that includes the report and/or bandwidth part (BWP) or carrier to which the parameter update is associated. In one example, T1 depends on the minimum (smallest) sub-carrier spacing of the signal/channel that includes the report and/or BWP or carrier to which the parameter update is associated. In one example, T1 depends on the maximum (largest) sub-carrier spacing of the signal/channel that includes the report and/or BWP or carrier to which the parameter update is associated.

In one example, T1 can depend on a UE capability.

In one example, T1 can be in units of symbols.

In one example, T1 can be in units of slots.

In one example, T1 can be in units of sub-frames.

In one example, T1 can be in units of frames.

In one example, T1 can be in units of time (e.g., millisecond, seconds, . . . ).

FIG. 24 illustrates timelines 2400 for parameter updates based on a UE report according to embodiments of the present disclosure. For example, timelines 2400 for parameter updates based on a UE report can be followed by any of the UEs 111-116 of FIG. 1, such as the UE 113, and/or the gNB 102 and/or network 130 in the wireless network 100 of FIG. 1. This example is for illustration only and other embodiments can be used without departing from the scope of the present disclosure.

In one example, a UE report includes one part or one stage. A parameter is updated based on the UE report.

The parameter is updated after a time T1 from the UE report and after acknowledgement of the UE report.

In one example, with reference to FIG. 24 Example 1, the update of the parameter is at time T1 from the start of the one part or one stage UE report as long as an acknowledgement for the UE report is transmitted by the gNB/TRP/network or an acknowledgement for the UE report is received by the UE.

In one example, with reference to FIG. 24 Example 2, the update of the parameter is at time T1 from the end of the one part or one stage UE report as long as an acknowledgement for the UE report is transmitted by the gNB/TRP/network or an acknowledgement for the UE report is received by the UE.

In one example, the update of the parameter is at the first symbol boundary at or after time T1 from the start of the UE report, and as long as an acknowledgement for the UE report is transmitted by the gNB/TRP/network or an acknowledgement for the UE report is received by the UE.

In one example, the update of the parameter is at the first symbol boundary at or after time T1 from the end of the UE report, and as long as an acknowledgement for the UE report is transmitted by the gNB/TRP/network or an acknowledgement for the UE report is received by the UE.

In one example, the update of the parameter is at the first slot boundary at or after time T1 from the start of the UE report, and as long as an acknowledgement for the UE report is transmitted by the gNB/TRP/network or an acknowledgement for the UE report is received by the UE.

In one example, the update of the parameter is at the first slot boundary at or after time T1 from the end of the UE report, and as long as an acknowledgement for the UE report is transmitted by the gNB/TRP/network or an acknowledgement for the UE report is received by the UE.

In one example, the update of the parameter is at the first sub-frame boundary at or after time T1 from the start of the UE report, and as long as an acknowledgement for the UE report is transmitted by the gNB/TRP/network or an acknowledgement for the UE report is received by the UE.

In one example, the update of the parameter is at the first sub-frame boundary at or after time T1 from the end of the UE report, and as long as an acknowledgement for the UE report is transmitted by the gNB/TRP/network or an acknowledgement for the UE report is received by the UE.

In one example, the update of the parameter is at the first frame boundary at or after time T1 from the start of the UE report, and as long as an acknowledgement for the UE report is transmitted by the gNB/TRP/network or an acknowledgement for the UE report is received by the UE.

In one example, the update of the parameter is at the first frame boundary at or after time T1 from the end of the UE report, and as long as an acknowledgement for the UE report is transmitted by the gNB/TRP/network or an acknowledgement for the UE report is received by the UE.

In one example, the update of the parameter is at the first SFN roll-over boundary (SFN=0) at or after time T1 from the start of the UE report, and as long as an acknowledgement for the UE report is transmitted by the gNB/TRP/network or an acknowledgement for the UE report is received by the UE.

In one example, the update of the parameter is at the first SFN roll-over boundary (SFN=0) at or after time T1 from the end of the UE report, and as long as an acknowledgement for the UE report is transmitted by the gNB/TRP/network or an acknowledgement for the UE report is received by the UE.

In one example, T1 is specified by system specifications and/or configured or updated by RRC signaling and/or MAC CE signaling and/or L1 control (e.g., DCI Format) signaling.

In one example, T1 can depend on the sub-carrier spacing of the signal/channel that includes the report and/or the signal/channel of the acknowledgment and/or BWP or carrier to which the parameter update is associated. In one example, T1 depends on the minimum (smallest) sub-carrier spacing of the signal/channel that includes the report and/or the signal/channel of the acknowledgment and/or BWP or carrier to which the parameter update is associated. In one example, T1 depends on the maximum (largest) sub-carrier spacing of the signal/channel that includes the report and/or the signal/channel of the acknowledgment and/or BWP or carrier to which the parameter update is associated.

In one example, T1 can depend on a UE capability.

In one example, T1 can be in units of symbols.

In one example, T1 can be in units of slots.

In one example, T1 can be in units of sub-frames.

In one example, T1 can be in units of frames.

In one example, T1 can be in units of time (e.g., millisecond, seconds, . . . ).

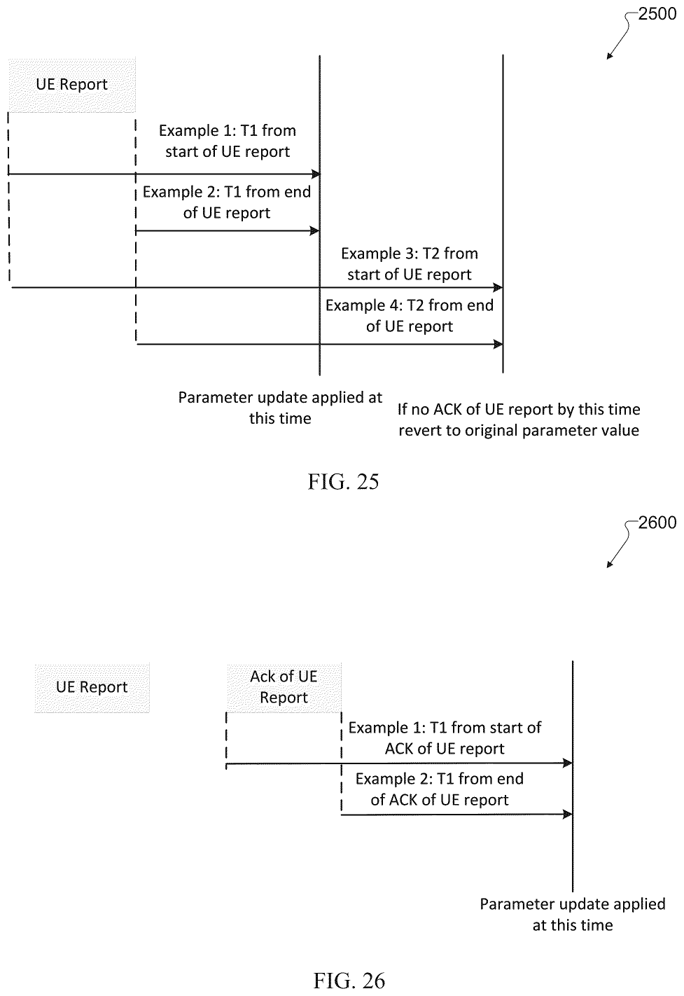

FIG. 25 illustrates timelines 2500 for parameter updates based on a UE report according to embodiments of the present disclosure. For example, timelines 2500 for parameter updates based on a UE report can be followed by any of the UEs 111-116 of FIG. 1, such as the UE 114, and/or the gNB 102 and/or network 130 in the wireless network 100 of FIG. 1. This example is for illustration only and other embodiments can be used without departing from the scope of the present disclosure.

In one example, a UE report includes one part or one stage. A parameter is updated based on the UE report. The parameter is updated after a time T1 from the UE report. If no acknowledgement is received by time T2 for the UE report, or if the UE doesn't perceive that the parameter has changed at the gNB (e.g., the gNB 102) by time T2, the UE reverts back to the original parameter setting.

In one example, with reference to FIG. 25 Example 1, the update of the parameter is at time T1 from the start of the one part or one stage UE report.

In one example, with reference to FIG. 25 Example 2, the update of the parameter is at time T1 from the end of the one part or one stage UE report.

In one example, with reference to FIG. 25 Example 3, parameter reverts back to original value (original parameter setting) at (or at or after) time T2 from the start of the one part or one stage UE report, if no acknowledgement is received for the UE report, or if the UE doesn't perceive that the parameter has changed at the gNB.

In one example, with reference to FIG. 25 Example 4, parameter reverts back to original value (original parameter setting) at (or at or after) time T2 from the end of the one part or one stage UE report, if no acknowledgement is received for the UE report, or if the UE doesn't perceive that the parameter has changed at the gNB.

In one example, the update of the parameter is at the first symbol boundary at or after time T1 from the start of the UE report. If no acknowledgement is received by time T2 for the UE report, or if the UE doesn't perceive that the parameter has changed at the gNB by time T2, the UE reverts back to the original parameter setting.

In one example, the update of the parameter is at the first symbol boundary at or after time T1 from the end of the UE report. If no acknowledgement is received by time T2 for the UE report, or if the UE doesn't perceive that the parameter has changed at the gNB by time T2, the UE reverts back to the original parameter setting.

In one example, the update of the parameter is at the first slot boundary at or after time T1 from the start of the UE report. If no acknowledgement is received by time T2 for the UE report, or if the UE doesn't perceive that the parameter has changed at the gNB by time T2, the UE reverts back to the original parameter setting.

In one example, the update of the parameter is at the first slot boundary at or after time T1 from the end of the UE report. If no acknowledgement is received by time T2 for the UE report, or if the UE doesn't perceive that the parameter has changed at the gNB by time T2, the UE reverts back to the original parameter setting.

In one example, the update of the parameter is at the first sub-frame boundary at or after time T1 from the start of the UE report. If no acknowledgement is received by time T2 for the UE report, or if the UE doesn't perceive that the parameter has changed at the gNB by time T2, the UE reverts back to the original parameter setting.

In one example, the update of the parameter is at the first sub-frame boundary at or after time T1 from the end of the UE report. If no acknowledgement is received by time T2 for the UE report, or if the UE doesn't perceive that the parameter has changed at the gNB by time T2, the UE reverts back to the original parameter setting.

In one example, the update of the parameter is at the first frame boundary at or after time T1 from the start of the UE report. If no acknowledgement is received by time T2 for the UE report, or if the UE doesn't perceive that the parameter has changed at the gNB by time T2, the UE reverts back to the original parameter setting.

In one example, the update of the parameter is at the first frame boundary at or after time T1 from the end of the UE report. If no acknowledgement is received by time T2 for the UE report, or if the UE doesn't perceive that the parameter has changed at the gNB by time T2, the UE reverts back to the original parameter setting.

In one example, the update of the parameter is at the first SFN roll-over boundary (SFN=0) at or after time T1 from the start of the UE report. If no acknowledgement is received by time T2 for the UE report, or if the UE doesn't perceive that the parameter has changed at the gNB by time T2, the UE reverts back to the original parameter setting.

In one example, the update of the parameter is at the first SFN roll-over boundary (SFN=0) at or after time T1 from the end of the UE report. If no acknowledgement is received by time T2 for the UE report, or if the UE doesn't perceive that the parameter has changed at the gNB by time T2, the UE reverts back to the original parameter setting.

In one example, T1 and/or T2 is/are specified by system specifications and/or configured or updated by RRC signaling and/or MAC CE signaling and/or L1 control (e.g., DCI Format) signaling.

In one example, T1 and/or T2 can depend on the sub-carrier spacing of the signal/channel that includes the report and/or BWP or carrier to which the parameter update is associated. In one example, T1 and/or T2 depends on the minimum (smallest) sub-carrier spacing of the signal/channel that includes the report and/or BWP or carrier to which the parameter update is associated. In one example, T1 and/or T2 depends on the maximum (largest) sub-carrier spacing of the signal/channel that includes the report and/or BWP or carrier to which the parameter update is associated.

In one example, T1 and/or T2 can depend on a UE capability.

In one example, T1 and/or T2 can be in units of symbols.

In one example, T1 and/or T2 can be in units of slots.

In one example, T1 and/or T2 can be in units of sub-frames.

In one example, T1 and/or T2 can be in units of frames.

In one example, T1 and/or T2 can be in units of time (e.g., millisecond, seconds, . . . ).

FIG. 26 illustrates timelines 2600 for parameter updates based on a UE report according to embodiments of the present disclosure. For example, timelines 2600 for parameter updates based on a UE report can be followed by any of the UEs 111-116 of FIG. 1, such as the UE 115, and/or the gNB 102 and/or network 130 in the wireless network 100 of FIG. 1. This example is for illustration only and other embodiments can be used without departing from the scope of the present disclosure.

In one example, a UE report includes one part or one stage. A parameter is updated based on the UE report.

The parameter is updated after a time T1 from the acknowledgment of the UE report.

In one example, with reference to FIG. 26 Example 1, the update of the parameter is at time T1 from the start of the acknowledgement of the UE report.

In one example, with reference to FIG. 26 Example 2, the update of the parameter is at time T1 from the end of the acknowledgement of the UE report. In one example, the update of the parameter is at the first symbol boundary at or after time T1 from the start of the acknowledgement of the UE report.

In one example, the update of the parameter is at the first symbol boundary at or after time T1 from the end of the acknowledgement of the UE report.

In one example, the update of the parameter is at the first slot boundary at or after time T1 from the start of the acknowledgement of the UE report.

In one example, the update of the parameter is at the first slot boundary at or after time T1 from the end of the acknowledgement of the UE report.

In one example, the update of the parameter is at the first sub-frame boundary at or after time T1 from the start of the acknowledgement of the UE report.

In one example, the update of the parameter is at the first sub-frame boundary at or after time T1 from the end of the acknowledgement of the UE report.

In one example, the update of the parameter is at the first frame boundary at or after time T1 from the start of the acknowledgement of the UE report.

In one example, the update of the parameter is at the first frame boundary at or after time T1 from the end of the acknowledgement of the UE report.

In one example, the update of the parameter is at the first SFN roll-over boundary (SFN=0) at or after time T1 from the start of the acknowledgement of the UE report.

In one example, the update of the parameter is at the first SFN roll-over boundary (SFN=0) at or after time T1 from the end of the acknowledgement of the UE report.

In one example, T1 is specified by system specifications and/or configured or updated by RRC signaling and/or MAC CE signaling and/or L1 control (e.g., DCI Format) signaling.

In one example, T1 can depend on the sub-carrier spacing of the signal/channel that includes the report and/or the signal/channel of the acknowledgment and/or BWP or carrier to which the parameter update is associated. In one example, T1 depends on the minimum (smallest) sub-carrier spacing of the signal/channel that includes the report and/or the signal/channel of the acknowledgment and/or BWP or carrier to which the parameter update is associated. In one example, T1 depends on the maximum (largest) sub-carrier spacing of the signal/channel that includes the report and/or the signal/channel of the acknowledgment and/or BWP or carrier to which the parameter update is associated.

In one example, T1 can depend on the sub-carrier spacing of the signal/channel of the acknowledgment and/or BWP or carrier to which the parameter update is associated. In one example, T1 depends on the minimum (smallest) sub-carrier spacing of the signal/channel of the acknowledgment and/or BWP or carrier to which the parameter update is associated. In one example, T1 depends on the maximum (largest) sub-carrier spacing of the signal/channel of the acknowledgment and/or BWP or carrier to which the parameter update is associated.

In one example, T1 can depend on a UE capability.

In one example, T1 can be in units of symbols.

In one example, T1 can be in units of slots.

In one example, T1 can be in units of sub-frames.

In one example, T1 can be in units of frames.

In one example, T1 can be in units of time (e.g., millisecond, seconds, . . . ).

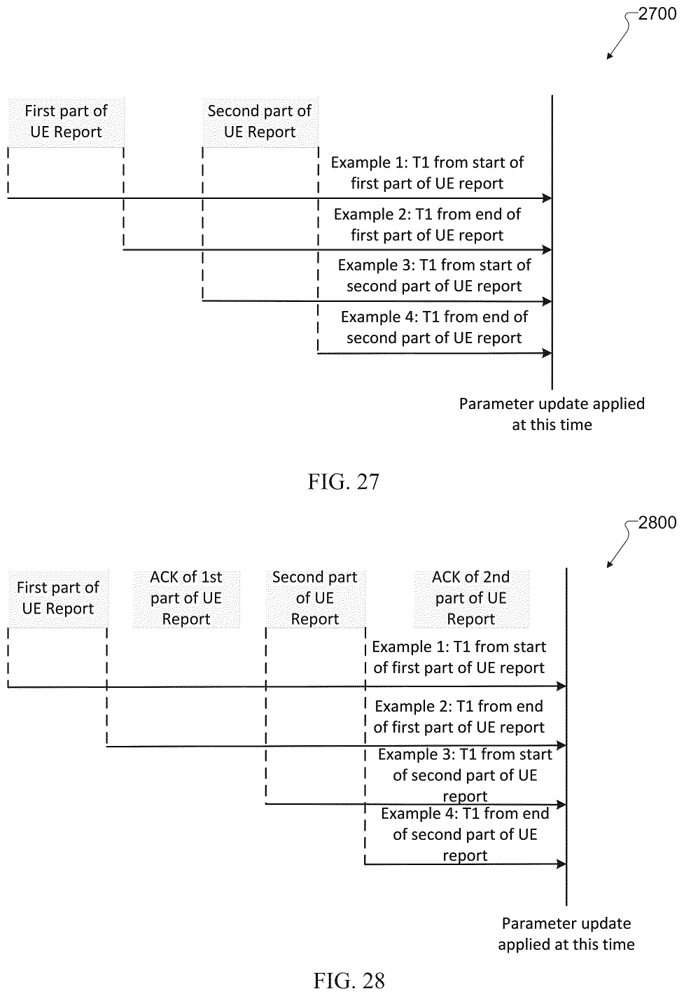

FIG. 27 illustrates timelines 2700 for parameter updates based on a UE report according to embodiments of the present disclosure. For example, timelines 2700 for parameter updates based on a UE report can be followed by any of the UEs 111-116 of FIG. 1, such as the UE 116, and/or the gNB 102 and/or network 130 in the wireless network 100 of FIG. 1. This example is for illustration only and other embodiments can be used without departing from the scope of the present disclosure.

In one example, a UE report includes two parts or two stages. A parameter is updated based on the UE report. The parameter is updated after a time T1 from the UE report. In one example, the UE report has an acknowledgement, but the parameter update takes effect regardless of the acknowledgement. In one example, the UE report has no acknowledgement. In one example, the acknowledgement can be for the first part/stage only. In one example, the acknowledgment can be for the second part/stage only. In one example, there is an acknowledgment for the first part/stage and an acknowledgement for the second part/stage.

In one example, with reference to FIG. 27 Example 1, the update of the parameter is at time T1 from the start of the first part/stage of the UE report.

In one example, with reference to FIG. 27 Example 2, the update of the parameter is at time T1 from the end of the first part/stage of the UE report.

In one example, with reference to FIG. 27 Example 3, the update of the parameter is at time T1 from the start of the second part/stage of the UE report.

In one example, with reference to FIG. 27 Example 2, the update of the parameter is at time T1 from the end of the second part/stage of the UE report.

In one example, the update of the parameter is at the first symbol boundary at or after time T1 from the start of the first part/stage of the UE report.

In one example, the update of the parameter is at the first symbol boundary at or after time T1 from the end of the first part/stage of the UE report.

In one example, the update of the parameter is at the first symbol boundary at or after time T1 from the start of the second part/stage of the UE report.

In one example, the update of the parameter is at the first symbol boundary at or after time T1 from the end of the second part/stage of the UE report.

In one example, the update of the parameter is at the first slot boundary at or after time T1 from the start of the first part/stage of the UE report.

In one example, the update of the parameter is at the first slot boundary at or after time T1 from the end of the first part/stage of the UE report.

In one example, the update of the parameter is at the first slot boundary at or after time T1 from the start of the second part/stage of the UE report.

In one example, the update of the parameter is at the first slot boundary at or after time T1 from the end of the second part/stage of the UE report.

In one example, the update of the parameter is at the first sub-frame boundary at or after time T1 from the start of the first part/stage of the UE report.

In one example, the update of the parameter is at the first sub-frame boundary at or after time T1 from the end of the first part/stage of the UE report.

In one example, the update of the parameter is at the first sub-frame boundary at or after time T1 from the start of the second part/stage of the UE report.

In one example, the update of the parameter is at the first sub-frame boundary at or after time T1 from the end of the second part/stage of the UE report.

In one example, the update of the parameter is at the first frame boundary at or after time T1 from the start of the first part/stage of the UE report.

In one example, the update of the parameter is at the first frame boundary at or after time T1 from the end of the first part/stage of the UE report.

In one example, the update of the parameter is at the first frame boundary at or after time T1 from the start of the second part/stage of the UE report.

In one example, the update of the parameter is at the first frame boundary at or after time T1 from the end of the second part/stage of the UE report.

In one example, the update of the parameter is at the first SFN roll-over boundary (SFN=0) at or after time T1 from the start of the first part/stage of the UE report.

In one example, the update of the parameter is at the first SFN roll-over boundary (SFN=0) at or after time T1 from the end of the first part/stage of the UE report.

In one example, the update of the parameter is at the first SFN roll-over boundary (SFN=0) at or after time T1 from the start of the second part/stage of the UE report.

In one example, the update of the parameter is at the first SFN roll-over boundary (SFN=0) at or after time T1 from the end of the second part/stage of the UE report.

In one example, T1 is specified by system specifications and/or configured or updated by RRC signaling and/or MAC CE signaling and/or L1 control (e.g., DCI Format) signaling.

In one example, T1 can depend on the sub-carrier spacing of the signal/channel that includes the report (first part/stage and/or second part/stage) and/or BWP or carrier to which the parameter update is associated. In one example, T1 depends on the minimum (smallest) sub-carrier spacing of the signal/channel that includes the report (first part/stage and/or second part/stage) and/or BWP or carrier to which the parameter update is associated. In one example, T1 depends on the maximum (largest) sub-carrier spacing of the signal/channel that includes the report (first part/stage and/or second part/stage) and/or BWP or carrier to which the parameter update is associated.

In one example, T1 can depend on a UE capability.

In one example, T1 can be in units of symbols.

In one example, T1 can be in units of slots.

In one example, T1 can be in units of sub-frames.

In one example, T1 can be in units of frames.

In one example, T1 can be in units of time (e.g., millisecond, seconds, . . . ).

FIG. 28 illustrates timelines 2800 for parameter updates based on a UE report according to embodiments of the present disclosure. For example, timelines 2800 for parameter updates based on a UE report can be followed by any of the UEs 111-116 of FIG. 1, such as the UE 111, and/or the gNB 102 and/or network 130 in the wireless network 100 of FIG. 1. This example is for illustration only and other embodiments can be used without departing from the scope of the present disclosure.

In one example, a UE report includes two parts or two stages. A parameter is updated based on the UE report. The parameter is updated after a time T1 from the UE report and after acknowledgement of the UE report. In one example, the acknowledgement can be for the first part/stage only. In one example, the acknowledgment can be for the second part/stage only. In one example, there is an acknowledgment for the first part/stage and an acknowledgement for the second part/stage.

In one example, with reference to FIG. 28 Example 1, the update of the parameter is at time T1 from the start of the first part/stage of the UE report as long as the acknowledgement for the UE report is transmitted by the gNB/TRP/network or the acknowledgement for the UE report is received by the UE.

In one example, with reference to FIG. 28 Example 2, the update of the parameter is at time T1 from the end of the first part/stage of the UE report as long as the acknowledgement for the UE report is transmitted by the gNB/TRP/network or the acknowledgement for the UE report is received by the UE.

In one example, with reference to FIG. 28 Example 3, the update of the parameter is at time T1 from the start of the second part/stage of the UE report as long as the acknowledgement for the UE report is transmitted by the gNB/TRP/network or the acknowledgement for the UE report is received by the UE.

In one example, with reference to FIG. 28 Example 3, the update of the parameter is at time T1 from the end of the second part/stage of the UE report as long as the acknowledgement for the UE report is transmitted by the gNB/TRP/network or the acknowledgement for the UE report is received by the UE.

In one example, the update of the parameter is at the first symbol boundary at or after time T1 from the start of the first stage/part of the UE (e.g., the UE 116) report, and as long as the acknowledgement for the UE report is transmitted by the gNB/TRP/network or the acknowledgement for the UE report is received by the UE.

In one example, the update of the parameter is at the first symbol boundary at or after time T1 from the end of the first stage/part of the UE report, and as long as the acknowledgement for the UE report is transmitted by the gNB/TRP/network or the acknowledgement for the UE report is received by the UE.

In one example, the update of the parameter is at the first symbol boundary at or after time T1 from the start of the first stage/part of the UE report, and as long as the acknowledgement for the UE report is transmitted by the gNB/TRP/network or the acknowledgement for the UE report is received by the UE.

In one example, the update of the parameter is at the first symbol boundary at or after time T1 from the end of the first stage/part of the UE report, and as long as the acknowledgement for the UE report is transmitted by the gNB/TRP/network or the acknowledgement for the UE report is received by the UE.

In one example, the update of the parameter is at the first slot boundary at or after time T1 from the start of the first stage/part of the UE report, and as long as the acknowledgement for the UE report is transmitted by the gNB/TRP/network or the acknowledgement for the UE report is received by the UE.

In one example, the update of the parameter is at the first slot boundary at or after time T1 from the end of the first stage/part of the UE report, and as long as the acknowledgement for the UE report is transmitted by the gNB/TRP/network or the acknowledgement for the UE report is received by the UE.

In one example, the update of the parameter is at the first slot boundary at or after time T1 from the start of the second stage/part of the UE report, and as long as the acknowledgement for the UE report is transmitted by the gNB/TRP/network or the acknowledgement for the UE report is received by the UE.

In one example, the update of the parameter is at the first slot boundary at or after time T1 from the end of the second stage/part of the UE report, and as long as the acknowledgement for the UE report is transmitted by the gNB/TRP/network or the acknowledgement for the UE report is received by the UE.

In one example, the update of the parameter is at the first sub-frame boundary at or after time T1 from the start of the first stage/part of the UE report, and as long as the acknowledgement for the UE report is transmitted by the gNB/TRP/network or the acknowledgement for the UE report is received by the UE.

In one example, the update of the parameter is at the first sub-frame boundary at or after time T1 from the end of the first stage/part of the UE report, and as long as the acknowledgement for the UE report is transmitted by the gNB/TRP/network or the acknowledgement for the UE report is received by the UE.

In one example, the update of the parameter is at the first sub-frame boundary at or after time T1 from the start of the second stage/part of the UE report, and as long as the acknowledgement for the UE report is transmitted by the gNB/TRP/network or the acknowledgement for the UE report is received by the UE.

In one example, the update of the parameter is at the first sub-frame boundary at or after time T1 from the end of the second stage/part of the UE report, and as long as the acknowledgement for the UE report is transmitted by the gNB/TRP/network or the acknowledgement for the UE report is received by the UE.

In one example, the update of the parameter is at the first frame boundary at or after time T1 from the start of the first stage/part of the UE report, and as long as the acknowledgement for the UE report is transmitted by the gNB/TRP/network or the acknowledgement for the UE report is received by the UE.

In one example, the update of the parameter is at the first frame boundary at or after time T1 from the end of the first stage/part of the UE report, and as long as the acknowledgement for the UE report is transmitted by the gNB/TRP/network or the acknowledgement for the UE report is received by the UE.

In one example, the update of the parameter is at the first frame boundary at or after time T1 from the start of the second stage/part of the UE report, and as long as the acknowledgement for the UE report is transmitted by the gNB/TRP/network or the acknowledgement for the UE report is received by the UE.

In one example, the update of the parameter is at the first frame boundary at or after time T1 from the end of the second stage/part of the UE report, and as long as the acknowledgement for the UE report is transmitted by the gNB/TRP/network or the acknowledgement for the UE report is received by the UE.

In one example, the update of the parameter is at the first SFN roll-over boundary (SFN=0) at or after time T1 from the start of the first stage/part of the UE report, and as long as the acknowledgement for the UE report is transmitted by the gNB/TRP/network or the acknowledgement for the UE report is received by the UE.

In one example, the update of the parameter is at the first SFN roll-over boundary (SFN=0) at or after time T1 from the end of the first stage/part of the UE report, and as long as the acknowledgement for the UE report is transmitted by the gNB/TRP/network or the acknowledgement for the UE report is received by the UE.

In one example, the update of the parameter is at the first SFN roll-over boundary (SFN=0) at or after time T1 from the start of the second stage/part of the UE report, and as long as the acknowledgement for the UE report is transmitted by the gNB/TRP/network or the acknowledgement for the UE report is received by the UE.

In one example, the update of the parameter is at the first SFN roll-over boundary (SFN=0) at or after time T1 from the end of the second stage/part of the UE report, and as long as the acknowledgement for the UE report is transmitted by the gNB/TRP/network or the acknowledgement for the UE report is received by the UE.

In one example, T1 is specified by system specifications and/or configured or updated by RRC signaling and/or MAC CE signaling and/or L1 control (e.g., DCI Format) signaling.

In one example, T1 can depend on the sub-carrier spacing of the signal/channel that includes the report (first part/stage and/or second part/stage) and/or the signal/channel of the acknowledgment (for the first part/stage and/or second part/stage) and/or BWP or carrier to which the parameter update is associated. In one example, T1 depends on the minimum (smallest) sub-carrier spacing of the signal/channel that includes the report (first part/stage and/or second part/stage) and/or the signal/channel of the acknowledgment (for the first part/stage and/or second part/stage) and/or BWP or carrier to which the parameter update is associated. In one example, T1 depends on the maximum (largest) sub-carrier spacing of the signal/channel that includes the report (first part/stage and/or second part/stage) and/or the signal/channel of the acknowledgment (for the first part/stage and/or second part/stage) and/or BWP or carrier to which the parameter update is associated.

In one example, T1 can depend on a UE capability.

In one example, T1 can be in units of symbols.

In one example, T1 can be in units of slots.

In one example, T1 can be in units of sub-frames.

In one example, T1 can be in units of frames.

In one example, T1 can be in units of time (e.g., millisecond, seconds, . . . ).

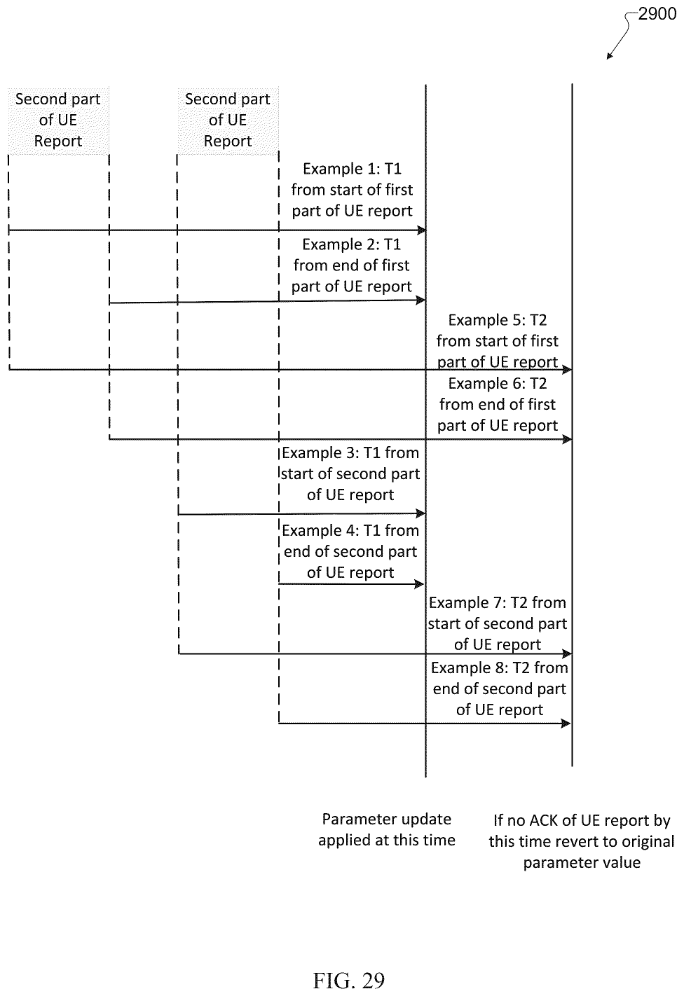

FIG. 29 illustrates timelines 2900 for parameter updates based on a UE report according to embodiments of the present disclosure. For example, timelines 2900 for parameter updates based on a UE report can be followed by any of the UEs 111-116 of FIG. 1, such as the UE 111, and/or the gNB 102 and/or network 130 in the wireless network 100 of FIG. 1. This example is for illustration only and other embodiments can be used without departing from the scope of the present disclosure.

In one example, a UE report includes two parts or two stages. A parameter is updated based on the UE report. The parameter is updated after a time T1 from the UE report. If no acknowledgement is received by time T2 for the UE report, or if the UE doesn't perceive that the parameter has changed at the gNB (e.g., the gNB 102) by time T2, the UE reverts back to the original parameter setting. In one example, the acknowledgement can be for the first part/stage only. In one example, the acknowledgment can be for the second part/stage only. In one example, there is an acknowledgment for the first part/stage and an acknowledgement for the second part/stage.

In one example, with reference to FIG. 29 Example 1, the update of the parameter is at time T1 from the start of the first part/stage of the UE report.

In one example, with reference to FIG. 29 Example 2, the update of the parameter is at time T1 from the end of the first part/stage of the UE report.

In one example, with reference to FIG. 29 Example 3, the update of the parameter is at time T1 from the start of the second part/stage of the UE report.

In one example, with reference to FIG. 29 Example 4, the update of the parameter is at time T1 from the end of the second part/stage of the UE report.

In one example, with reference to FIG. 29 Example 5, parameter reverts back to original value (original parameter setting) at (or at or after) time T2 from the start of the first part/stage of the UE report, if no acknowledgement is received for the UE report, or if the UE doesn't perceive that the parameter has changed at the gNB.

In one example, with reference to FIG. 29 Example 6, parameter reverts back to original value (original parameter setting) at (or at or after) time T2 from the end of the first part/stage of the UE report, if no acknowledgement is received for the UE report, or if the UE doesn't perceive that the parameter has changed at the gNB.

In one example, with reference to FIG. 29 Example 7, parameter reverts back to original value (original parameter setting) at (or at or after) time T2 from the start of the second part/stage of the UE report, if no acknowledgement is received for the UE report, or if the UE doesn't perceive that the parameter has changed at the gNB.

In one example, with reference to FIG. 29 Example 8, parameter reverts back to original value (original parameter setting) at (or at or after) time T2 from the end of the second part/stage of the UE report, if no acknowledgement is received for the UE report, or if the UE doesn't perceive that the parameter has changed at the gNB.

In one example, the update of the parameter is at the first symbol boundary at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first symbol boundary at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first symbol boundary at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first symbol boundary at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first slot boundary at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first slot boundary at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first slot boundary at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first slot boundary at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first sub-frame boundary at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first sub-frame boundary at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first sub-frame boundary at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first sub-frame boundary at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first frame boundary at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first frame boundary at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first frame boundary at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first frame boundary at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first SFN roll-over boundary (SFN=0) at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first SFN roll-over boundary (SFN=0) at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first SFN roll-over boundary (SFN=0) at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one example, the update of the parameter is at the first SFN roll-over boundary (SFN=0) at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one example, T1 and/or T2 is/are specified by system specifications and/or configured or updated by RRC signaling and/or MAC CE signaling and/or L1 control (e.g., DCI Format) signaling.

In one example, T1 and/or T2 can depend on the sub-carrier spacing of the signal/channel that includes the report (first part/stage and/or second part/stage) and/or BWP or carrier to which the parameter update is associated. In one example, T1 and/or T2 depends on the minimum (smallest) sub-carrier spacing of the signal/channel that includes the report (first part/stage and/or second part/stage) and/or BWP or carrier to which the parameter update is associated. In one example, T1 and/or T2 depends on the maximum (largest) sub-carrier spacing of the signal/channel that includes the report (first part/stage and/or second part/stage) and/or BWP or carrier to which the parameter update is associated.

In one example, T1 and/or T2 can depend on a UE capability.

In one example, T1 and/or T2 can be in units of symbols.

In one example, T1 and/or T2 can be in units of slots.

In one example, T1 and/or T2 can be in units of sub-frames.

In one example, T1 and/or T2 can be in units of frames.

In one example, T1 and/or T2 can be in units of time (e.g., millisecond, seconds, . . . ).

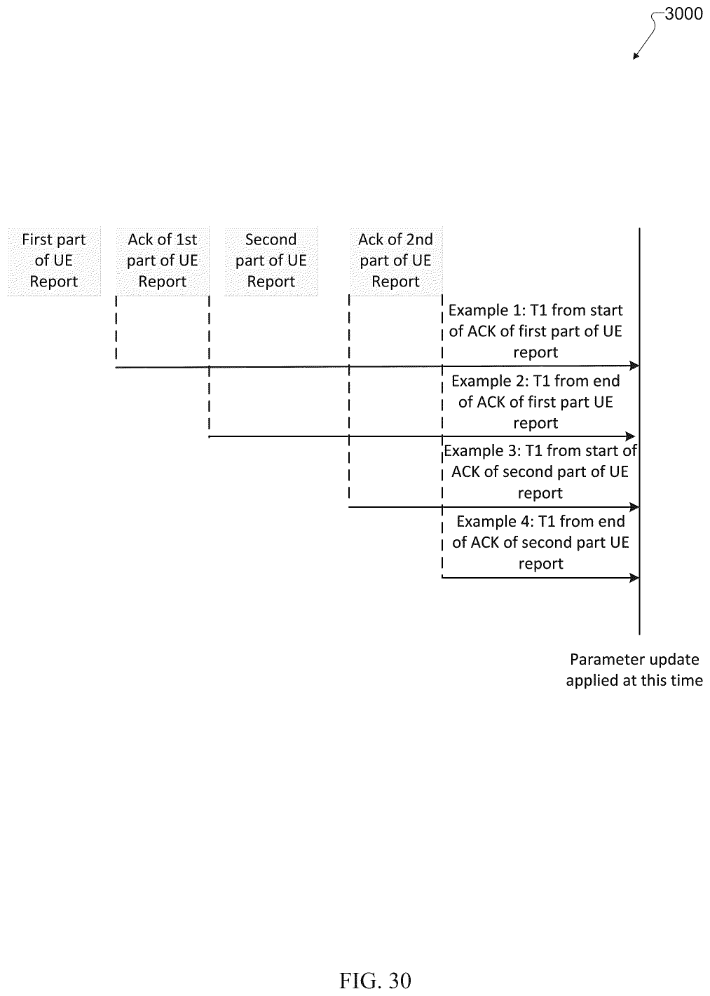

FIG. 30 illustrates timelines 3000 for parameter updates based on a UE report according to embodiments of the present disclosure. For example, timelines 3000 for parameter updates based on a UE report can be followed by any of the UEs 111-116 of FIG. 1, such as the UE 113, and/or the gNB 102 and/or network 130 in the wireless network 100 of FIG. 1. This example is for illustration only and other embodiments can be used without departing from the scope of the present disclosure.

In one example, a UE report includes two parts or two stages. A parameter is updated based on the UE report. The parameter is updated after a time T1 from the acknowledgment of the UE report. In one example, the acknowledgement can be for the first part/stage only. In one example, the acknowledgment can be for the second part/stage only. In one example, there is an acknowledgment for the first part/stage and an acknowledgement for the second part/stage.

In one example, with reference to FIG. 30 Example 1, the update of the parameter is at time T1 from the start of the acknowledgement of the first part/stage of the UE report.

In one example, with reference to FIG. 30 Example 2, the update of the parameter is at time T1 from the end of the acknowledgement of the first part/stage of the UE report.

In one example, with reference to FIG. 30 Example 3, the update of the parameter is at time T1 from the start of the acknowledgement of the second part/stage of the UE report.

In one example, with reference to FIG. 30 Example 4, the update of the parameter is at time T1 from the end of the acknowledgement of the second part/stage of the UE report.

In one example, the update of the parameter is at the first symbol boundary at or after time T1 from the start of the acknowledgement of the first part/stage of the UE report.

In one example, the update of the parameter is at the first symbol boundary at or after time T1 from the end of the acknowledgement of the first part/stage of the UE report.

In one example, the update of the parameter is at the first symbol boundary at or after time T1 from the start of the acknowledgement of the second part/stage of the UE report.

In one example, the update of the parameter is at the first symbol boundary at or after time T1 from the end of the acknowledgement of the second part/stage of the UE report.

In one example, the update of the parameter is at the first slot boundary at or after time T1 from the start of the acknowledgement of the first part/stage of the UE report.

In one example, the update of the parameter is at the first slot boundary at or after time T1 from the end of the acknowledgement of the first part/stage of the UE report.

In one example, the update of the parameter is at the first slot boundary at or after time T1 from the start of the acknowledgement of the second part/stage of the UE report.

In one example, the update of the parameter is at the first slot boundary at or after time T1 from the end of the acknowledgement of the second part/stage of the UE report.

In one example, the update of the parameter is at the first sub-frame boundary at or after time T1 from the start of the acknowledgement of the first part/stage of the UE report.

In one example, the update of the parameter is at the first sub-frame boundary at or after time T1 from the end of the acknowledgement of the first part/stage of the UE report.

In one example, the update of the parameter is at the first sub-frame boundary at or after time T1 from the start of the acknowledgement of the second part/stage of the UE report.

In one example, the update of the parameter is at the first sub-frame boundary at or after time T1 from the end of the acknowledgement of the second part/stage of the UE report.

In one example, the update of the parameter is at the first frame boundary at or after time T1 from the start of the acknowledgement of the first part/stage of the UE report.

In one example, the update of the parameter is at the first frame boundary at or after time T1 from the end of the acknowledgement of the first part/stage of the UE report.

In one example, the update of the parameter is at the first frame boundary at or after time T1 from the start of the acknowledgement of the second part/stage of the UE report.

In one example, the update of the parameter is at the first frame boundary at or after time T1 from the end of the acknowledgement of the second part/stage of the UE report.

In one example, the update of the parameter is at the first SFN roll-over boundary (SFN=0) at or after time T1 from the start of the acknowledgement of the first part/stage of the UE report.

In one example, the update of the parameter is at the first SFN roll-over boundary (SFN=0) at or after time T1 from the end of the acknowledgement of the first part/stage of the UE report.

In one example, the update of the parameter is at the first SFN roll-over boundary (SFN=0) at or after time T1 from the start of the acknowledgement of the second part/stage of the UE report.

In one example, the update of the parameter is at the first SFN roll-over boundary (SFN=0) at or after time T1 from the end of the acknowledgement of the second part/stage of the UE report.

In one example, T1 is specified by system specifications and/or configured or updated by RRC signaling and/or MAC CE signaling and/or L1 control (e.g., DCI Format) signaling.

In one example, T1 can depend on the sub-carrier spacing of the signal/channel that includes the report (first part/stage and/or second part/stage) and/or the signal/channel of the acknowledgment (for the first part/stage and/or second part/stage) and/or BWP or carrier to which the parameter update is associated. In one example, T1 depends on the minimum (smallest) sub-carrier spacing of the signal/channel that includes the report (first part/stage and/or second part/stage) and/or the signal/channel of the acknowledgment (for the first part/stage and/or second part/stage) and/or BWP or carrier to which the parameter update is associated. In one example, T1 depends on the maximum (largest) sub-carrier spacing of the signal/channel that includes the report (first part/stage and/or second part/stage) and/or the signal/channel of the acknowledgment (for the first part/stage and/or second part/stage) and/or BWP or carrier to which the parameter update is associated.

In one example, T1 can depend on a UE capability.

In one example, T1 can be in units of symbols.

In one example, T1 can be in units of slots.

In one example, T1 can be in units of sub-frames.

In one example, T1 can be in units of frames.

In one example, T1 can be in units of time (e.g., millisecond, seconds, . . . ).

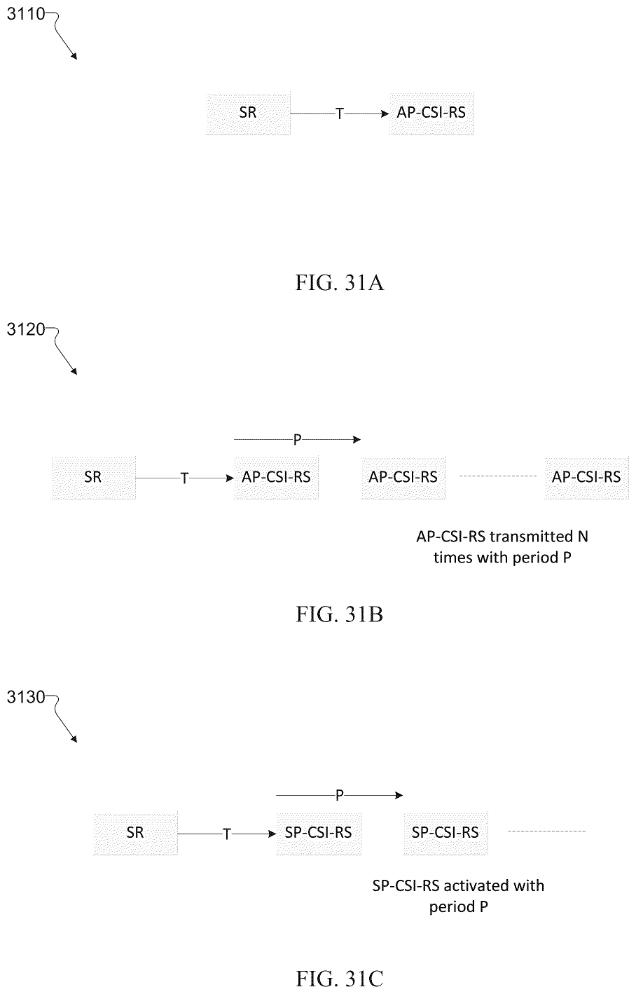

FIGS. 31A, 31B and 31C illustrate timelines 3110, 3120, and 3130, respectively, for example response(s) to a SR according to embodiments of the present disclosure. For example, timelines 3110, 3120, and 3130, respectively, for example response(s) to a SR can be followed by the gNB 102 and/or network 130 in the wireless network 100 of FIG. 1. This example is for illustration only and other embodiments can be used without departing from the scope of the present disclosure.

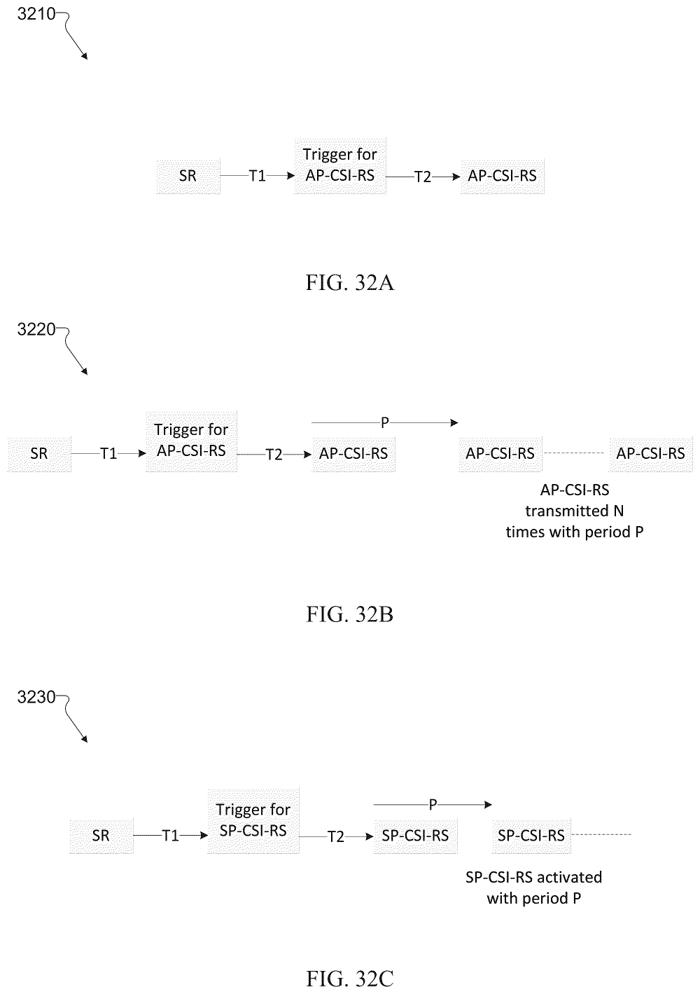

FIGS. 32A, 32B, and 32C illustrate timelines 3210, 3220, and 3230, respectively, for example response(s) to a SR according to embodiments of the present disclosure. For example, timelines 3210, 3220, and 3230, respectively, for example response(s) to a SR can be followed by the gNB 103 and/or network 130 in the wireless network 100 of FIG. 1. This example is for illustration only and other embodiments can be used without departing from the scope of the present disclosure.

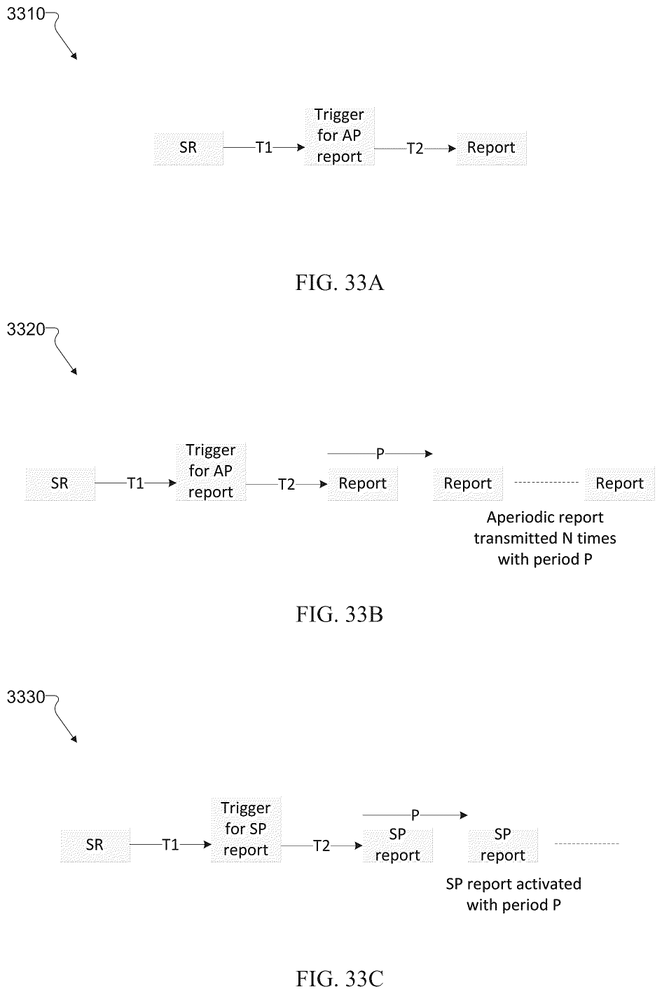

FIGS. 33A, 33B, and 33C illustrate timelines 3310, 3320, and 3330, respectively, for example response(s) to a SR according to embodiments of the present disclosure. For example, timelines 3310, 3320, and 3330, respectively, for example response(s) to a SR can be followed by the gNB 102 and/or network 130 in the wireless network 100 of FIG. 1. This example is for illustration only and other embodiments can be used without departing from the scope of the present disclosure.

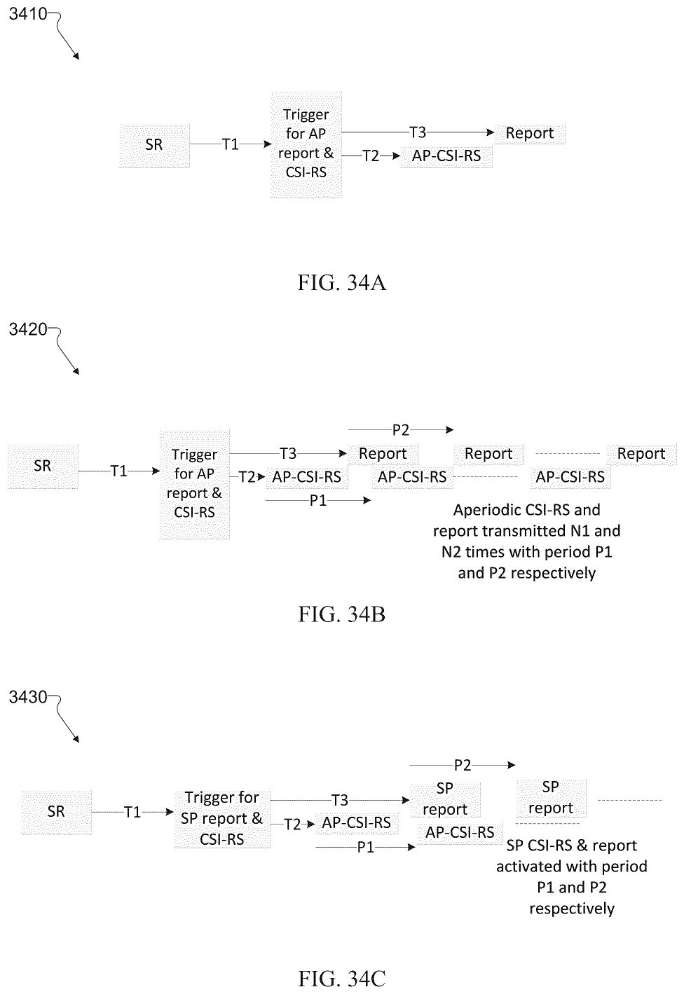

FIGS. 34A, 34B, and 34C illustrate timelines 3410, 3420, and 3430, respectively, for example response(s) to a SR according to embodiments of the present disclosure. For example, timelines 3410, 3420, and 3430, respectively, for example response(s) to a SR can be followed by the gNB 103 and/or network 130 in the wireless network 100 of FIG. 1. This example is for illustration only and other embodiments can be used without departing from the scope of the present disclosure.

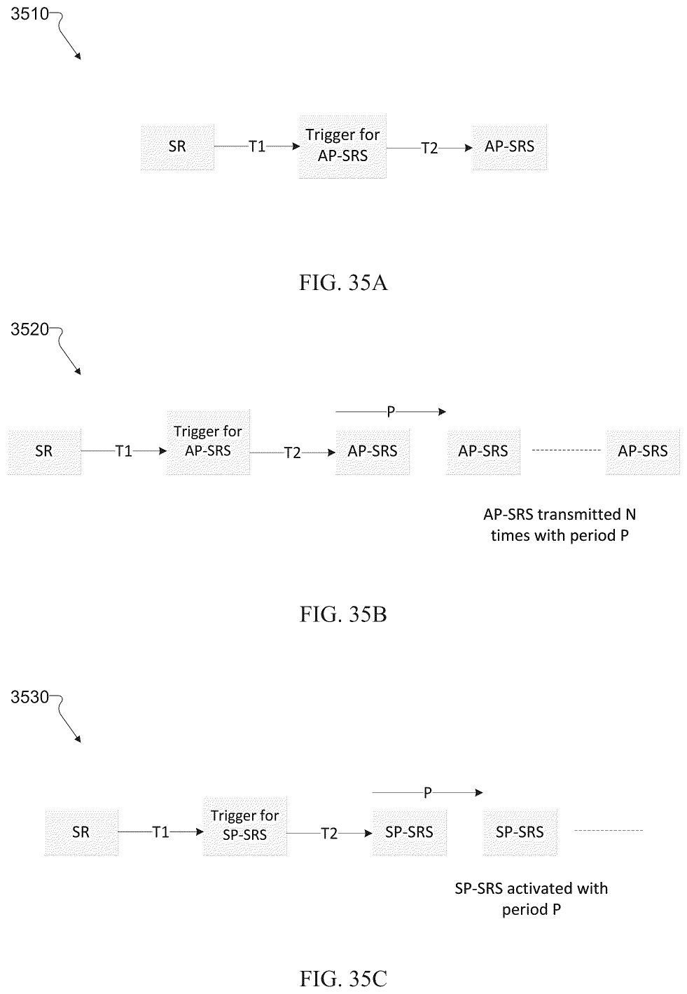

FIGS. 35A, 35B, and 35C illustrate timelines 3510, 3520, and 3530, respectively, for example response(s) to a SR according to embodiments of the present disclosure. For example, timelines 3510, 3520, and 3530, respectively, for example response(s) to a SR can be followed by the gNB 102 and/or network 130 in the wireless network 100 of FIG. 1. This example is for illustration only and other embodiments can be used without departing from the scope of the present disclosure.

A UE (e.g., the UE 116) can initiate a request to the network. This request can be transmitted in one or more the following:
Uplink control information (UCI) on PUCCH or PUSCH. In one example, UCI is transmitted on PUCCH Format 0 or PUCCH Format 1 (e.g., UCI is one bit or UCI is two bits). In one example UCI is transmitted on PUCCH Format 2 or PUCCH Format 3 or PUCCH Format 4. In one example, the request can be a scheduling request. In one example, signal/channel can be a pre-notification signal as aforementioned.
MAC CE on PUSCH.

In one example, based on a measurement of channel quality, when the channel quality falls to or below a threshold, the UE can initiate the request. In one example, the channel quality can be based on L1-RSRP and/or L3-RSRP (e.g., sliding window averaged RSRP, or exponential averaged RSRP) and/or SINR and/or CQI and/or BLER. In one example, the channel quality can be based on measurement on a CSI-RS resource (e.g., CSI-RS using a same beam as the channel used for communication between the gNB and the UE). In one example, the channel quality can be based on measurement on PDCCH DMRS and/or PDSCH DMRS and/or PDCCH and/or PDSCH. In one example, the threshold can be configured and/or updated by SIB and/or RRC and/or MAC and/or L1 control (e.g., DCI Format) signaling.

In one example, the network and/or UE doesn't transmit periodically a reference signal (RS) for beam identification and/or mobility and/or for CSI measurement. The RS can be transmitted on a demand when a condition occurs as aforementioned. In one example, the RS can be transmitted for finding a new beam (e.g., when the quality of the current beam falls to or below a threshold). In one example, the RS can be transmitted for mobility measurements, e.g., RS transmitted from or to another cell to identify a candidate cell (e.g., when the quality of signal from a current cell falls to or below a threshold). In one example, the RS can be transmitted for CSI measurement.

In one example, the network and/or UE transmits periodically, with a long periodic time, a RS for beam identification and/or mobility measurements and/or for CSI measurement. An RS can be requested or activated aperiodically or semi-persistently with a lower latency, to reduce the corresponding measurement latency.

In one example, the on-demand trigger of a RS transmitted from the network and/or UE can be for network energy savings (NES) or UE power savings. The RS is transmitted when a certain condition occurs. In one example, the RS can be transmitted on different beams for beam measurements. In one example, the RS can be transmitted to/from different cells for mobility measurements. In one example, the RS can be transmitted for CSI measurements.

In response to this request, the network (e.g., the network 130) can;
Transmit CSI-RS resources, e.g., as shown in FIG. 31.
Transmit a channel/signal (e.g., DCI Format) that indicates or triggers the transmission of CSI-RS resources, e.g., as shown in FIG. 32.
Transmit a channel/signal (e.g., DCI Format) that allocates resources for a report from UE, e.g., as shown in FIG. 33. The UE can convey information as aforementioned.
Transmit a channel/signal (e.g., DCI Format) that indicates or triggers the transmission of CSI-RS resources, and allocates resources for a report from UE, e.g., as shown in FIG. 34.
Transmit a channel signal (e.g. DCI Format) that allocates resources for a reference signal from the UE to be measured at the gNB (e.g., the gNB 102) (e.g., SRS), e.g., as shown in FIG. 35.
No trigger is transmitted from the network, the network expects a transmission from the UE (e.g., SRS) based on a pre-notification message from the UE as aforementioned.

In one example, the UE transmits a request to the network, and in response the network transmits CSI-RS. In one example, the request, as aforementioned, is transmitted on UCI (e.g., scheduling request-SR). In one example, the request is transmitted using MAC CE.

The network, in response to the request, transmits CSI-RS.
In one example, with reference to FIG. 31A the CSI-RS is aperiodic (AP) CSI-RS and the AP-CSI-RS is one shot as shown.
In one example, with reference to FIG. 31B, the CSI-RS is aperiodic (AP) CSI-RS and the AP-CSI-RS is repeated N times with a periodicity P. In one example, N and/or P can be specified in the system specification, and/or configured by RRC signaling and/or MAC CE signaling and/or L1 control signaling. In one example, the UE can indicate to the network N and/or P for example in the request message or separate from the request message. In a further example, N and/or P indicated by the UE can be from values configured by the network.
In one example, the CSI-RS is aperiodic (AP) CSI-RS and the AP-CSI-RS is repeated a number of times within a period Tn with a periodicity P. In one example, Tn and/or P can be specified in the system specification, and/or configured by RRC signaling and/or MAC CE signaling and/or L1 control signaling. In one example, the UE can indicate to the network Tn and/or P for example in the request message or separate from the request message. In a further example, Tn and/or P indicated by the UE can be from values configured by the network.
In one example, with reference to FIG. 31C, the CSI-RS is semi-persistent (SP) CSI-RS and the SP-CSI-RS is repeated (e.g., until deactivated) with a periodicity P. In one example, P can be specified in the system specification, and/or configured by RRC signaling and/or MAC CE signaling and/or L1 control signaling. In one example, the UE can indicate to the network P for example in the request message or separate from the request message. In a further example, P indicated by the UE can be from values configured by the network. In one example, the deactivation of the SP CSI-RS can be requested by the UE, e.g., the UE sends a request to the network to deactivate the SP CSI-RS. In one example, the deactivation of the SP CSI-RS can be by the network, the network can send a signal/channel to indicate the deactivation of the SP CSI-RS.

In one example, the first CSI-RS is transmitted after a period T (or a period that is greater than T or a period that is greater than or equal to T) from the channel or signal of the request from the UE. In one example, T is from the start of the signal/channel with the request. In one example, T is from the end of the signal/channel with the request. In one example T, is to the start of the CSI-RS (e.g., first instance of CSI-RS). In one example T, is to the end of the CSI-RS (e.g., first instance of CSI-RS). In one example T, is to the start of the slot/subframe/frame containing the CSI-RS (e.g., first instance of CSI-RS). In one example T, is to the end of the slot/subframe/frame containing the CSI-RS (e.g., first instance of CSI-RS). In one example, T is specified by system specifications and/or configured or updated by RRC signaling and/or MAC CE signaling and/or L1 control (e.g., DCI Format) signaling. In one example T, depends on the sub-carrier spacing of the signal/channel of the request and/or the CSI-RS. In one example, T depends on the minimum (smallest) sub-carrier spacing of the signal/channel of the request and/or the CSI-RS. In one example, T depends on the maximum (largest) sub-carrier spacing of the signal/channel of the request and/or the CSI-RS. In one example, the UE can indicate to the network T for example in the request message or separate from the request message. In a further example, T indicated by the UE can be from values configured by the network. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, . . . ). In one example, if the UE doesn't receive a CSI-RS at time T as aforementioned, the UE can retransmit the request.

In one example, the gNB transmits CSI-RS at or after time T in a symbol or slot or sub-frame or frame that satisfies a condition. For example, the condition can be: the first time unit at or after T with a time unit number (or index) % M=O, or alternatively the condition can be: the first time unit at or after T with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In one example, for a SP CSI-RS, the UE transmits a signal/channel to deactivate the SP CSI-RS. In one example, for a SP CSI-RS, the gNB transmits a signal/channel to deactivate the SP CSI-RS. In one example, the CSI-RS is deactivated after a period Td (or a period that is greater than Td or a period that is greater than or equal to Td) from the UE signal/channel or from the gNB signal/channel. In one example, Td is from the start of the UE signal/channel or the gNB signal/channel. In one example, Td is from the end of the UE signal/channel or the gNB signal/channel. In one example Td, depends on the sub-carrier spacing of the UE signal/channel and/or the gNB signal/channel and/or CSI-RS. In one example, Td depends on the minimum (smallest) sub-carrier spacing of the UE signal/channel and/or the gNB signal/channel and/or CSI-RS. In one example, Td depends on the maximum (largest) sub-carrier spacing of the UE signal/channel and/or the gNB signal/channel and/or CSI-RS. In one example, the UE or gNB can indicate to the network Td. In a further example, Td indicated by the UE or gNB can be from values configured by the network. In one example, Td depends on a UE capability. In one example, Td can be in units of symbols. In one example, Td can be in units of slots. In one example, Td can be in units of sub-frames. In one example, Td can be in units of frames. In one example, Td can be in units of time (e.g., millisecond, seconds, . . . ).

In one example, the UE transmits a request to the network, and in response the network transmits a DL channel or signal that indicates or triggers CSI-RS. In one example, the request, as aforementioned, is transmitted on UCI (e.g., scheduling request-SR). In one example, the request is transmitted using MAC CE. In one example, the channel or signal that indicates or triggers CSI-RS is a PDCCH, e.g., a DCI format transmitted in a PDCCH. In one example, the channel or signal that indicates or triggers CSI-RS is a PDSCH, e.g., a MAC CE transmitted in a PDSCH.

After the channel or signal that triggers or indicates CSI-RS (e.g., a DCI format), the network transmits CSI-RS.
In one example, with reference to FIG. 32A, the CSI-RS is aperiodic (AP) CSI-RS and the AP-CSI-RS is one shot as shown
In one example, with reference to FIG. 32B, the CSI-RS is aperiodic (AP) CSI-RS and the AP-CSI-RS is repeated N times with a periodicity P. In one example, N and/or P can be specified in the system specification, and/or configured by RRC signaling and/or MAC CE signaling and/or L1 control signaling. In one example, N and/or P can be indicated in the channel or signal that triggers or indicates CSI-RS (e.g., a DCI Format). In a further example, N and/or P indicated in the channel or signal that triggers or indicates CSI-RS can be from values configured by the network. In one example, the UE can indicate to the network N and/or P for example in the request message or separate from the request message. In a further example, N and/or P indicated by the UE can be from values configured by the network.
In one example, the CSI-RS is aperiodic (AP) CSI-RS and the AP-CSI-RS is repeated a number of times within a period Tn with a periodicity P. In one example, Tn and/or P can be specified in the system specification, and/or configured by RRC signaling and/or MAC CE signaling and/or L1 control signaling. In one example, Tn and/or P can be indicated in the channel or signal that triggers or indicates CSI-RS (e.g., a DCI Format). In a further example, Tn and/or P indicated in the channel or signal that triggers or indicates CSI-RS can be from values configured by the network. In one example, the UE can indicate to the network Tn and/or P for example in the request message or separate from the request message. In a further example, Tn and/or P indicated by the UE can be from values configured by the network.
In one example, with reference to FIG. 32C, the CSI-RS is semi-persistent (SP) CSI-RS and the SP-CSI-RS is repeated (e.g., until deactivated) with a periodicity P. In one example, P can be specified in the system specification, and/or configured by RRC signaling and/or MAC CE signaling and/or L1 control signaling. In one example, P can be indicated in the channel or signal that triggers or indicates CSI-RS (e.g., a DCI Format). In a further example, P indicated in the channel or signal that triggers or indicates CSI-RS can be from values configured by the network. In one example, the UE can indicate to the network P for example in the request message or separate from the request message. In a further example, P indicated by the UE can be from values configured by the network. In one example, the deactivation of the SP CSI-RS can be requested by the UE, e.g., the UE sends a request to the network to deactivate the SP CSI-RS. In one example, the deactivation of the SP CSI-RS can be by the network, the network can send a signal/channel to indicate the deactivation of the SP CSI-RS.

In one example, the channel or signal that triggers or indicates CSI-RS (e.g., a DCI format) is transmitted after a period T1 (or a period that is greater than T1 or a period that is greater than or equal to T1). In one example, T1 is from the start of the channel or signal with the request. In one example, T1 is from the end of channel or signal with the request. In one example T1, is to the start of the channel or signal that triggers or indicates CSI-RS (e.g., a DCI format). In one example T1, is to the end of the channel or signal that triggers or indicates CSI-RS (e.g., a DCI format)). In one example T1, is to the start of the slot/subframe/frame containing the channel or signal that triggers or indicates CSI-RS (e.g., a DCI format). In one example T1, is to the end of the slot/subframe/frame containing the channel or signal that triggers or indicates CSI-RS (e.g., a DCI format). In one example, T1 is specified by system specifications and/or configured or updated by RRC signaling and/or MAC CE signaling and/or L1 control (e.g., DCI Format) signaling. In one example T1, depends on the sub-carrier spacing of the signal/channel of the request and/or the channel or signal that triggers or indicates CSI-RS (e.g., a DCI format) and/or the CSI-RS. In one example, T1 depends on the minimum (smallest) sub-carrier spacing of the signal/channel of the request and/or the channel or signal that triggers or indicates CSI-RS (e.g., a DCI format) and/or the CSI-RS. In one example, T1 depends on the maximum (largest) sub-carrier spacing of the signal/channel of the request and/or the channel or signal that triggers or indicates CSI-RS (e.g., a DCI format) and/or the CSI-RS. In one example, the UE can indicate to the network T1 for example in the request message or separate from the request message. In a further example, T1 indicated by the UE can be from values configured by the network. In one example, T1 depends on a UE capability. In one example, T1 can be in units of symbols. In one example, T1 can be in units of slots. In one example, T1 can be in units of sub-frames. In one example, T1 can be in units of frames. In one example, T1 can be in units of time (e.g., millisecond, seconds, . . . ). In one example, if the UE doesn't receive a channel or signal that triggers or indicates CSI-RS (e.g., a DCI format) at time T1 as aforementioned, the UE can retransmit the request.

In one example, the gNB transmits the channel or signal that triggers or indicates CSI-RS (e.g., a DCI format) at or after time T1 in a symbol or slot or sub-frame or frame that satisfies a condition. For example, the condition can be: the first time unit at or after T1 with a time unit number (or index) % M=O, or alternatively the condition can be: the first time unit at or after T1 with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In one example, the first CSI-RS is transmitted after a period T2 (or a period that is greater than T2 or a period that is greater than or equal to T2). In one example, T2 is from the start of the channel or signal that triggers or indicates CSI-RS (e.g., a DCI format). In one example, T2 is from the end of channel or signal that triggers or indicates CSI-RS (e.g., a DCI format). In one example, T2 is from the start of the channel or signal that contains the acknowledgment of the channel or signal that triggers or indicates CSI-RS (e.g., a DCI format). In one example, T2 is from the end of channel or signal that contains the acknowledgment of the channel or signal that triggers or indicates CSI-RS (e.g., a DCI format). In one example T2, is to the start of the CSI-RS (e.g., first instance of CSI-RS). In one example T2, is to the end of the CSI-RS (e.g., first instance of CSI-RS). In one example T2, is to the start of the slot/subframe/frame containing the CSI-RS (e.g., first instance of CSI-RS). In one example T2, is to the end of the slot/subframe/frame containing the CSI-RS (e.g., first instance of CSI-RS). In one example, T2 is specified by system specifications and/or configured or updated by RRC signaling and/or MAC CE signaling and/or L1 control (e.g., DCI Format) signaling. In one example T2, depends on the sub-carrier spacing of the signal/channel of the request and/or the channel or signal that triggers or indicates CSI-RS (e.g., a DCI format) and/or the CSI-RS. In one example, T2 depends on the minimum (smallest) sub-carrier spacing of the signal/channel of the request and/or the channel or signal that triggers or indicates CSI-RS (e.g., a DCI format) and/or the CSI-RS. In one example, T2 depends on the maximum (largest) sub-carrier spacing of the signal/channel of the request and/or the channel or signal that triggers or indicates CSI-RS (e.g., a DCI format) and/or the CSI-RS. In one example, T2 can be indicated in the channel or signal that triggers or indicates CSI-RS (e.g., a DCI Format). In a further example, T2 indicated in the channel or signal that triggers or indicates CSI-RS can be from values configured by the network. In one example, the UE can indicate to the network T2 for example in the request message or separate from the request message. In a further example, T2 indicated by the UE can be from values configured by the network. In one example, T2 depends on a UE capability. In one example, T2 can be in units of symbols. In one example, T2 can be in units of slots. In one example, T2 can be in units of sub-frames. In one example, T2 can be in units of frames. In one example, T2 can be in units of time (e.g., millisecond, seconds, . . . ).

In one example, the gNB transmits CSI-RS at or after time T2 in a symbol or slot or sub-frame or frame that satisfies a condition. For example, the condition can be: the first time unit at or after T2 with a time unit number (or index) % M=O, or alternatively the condition can be: the first time unit at or after T2 with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In a variant example of the examples herein, T2 can be replaced by T3, where T3 is time between be the channel or signal with the request and the first CSI-RS instance. The examples herein can apply to T3.

In one example, for a SP CSI-RS, the UE transmits a signal/channel to deactivate the SP CSI-RS. In one example, for a SP CSI-RS, the gNB transmits a signal/channel to deactivate the SP CSI-RS. In one example, the CSI-RS is deactivated after a period Td (or a period that is greater than Td or a period that is greater than or equal to Td) from the UE signal/channel or from the gNB signal/channel. In one example, Td is from the start of the UE signal/channel or the gNB signal/channel. In one example, Td is from the end of the UE signal/channel or the gNB signal/channel. In one example Td, depends on the sub-carrier spacing of the UE signal/channel and/or the gNB signal/channel and/or CSI-RS. In one example, Td depends on the minimum (smallest) sub-carrier spacing of the UE signal/channel and/or the gNB signal/channel and/or CSI-RS. In one example, Td depends on the maximum (largest) sub-carrier spacing of the UE signal/channel and/or the gNB signal/channel and/or CSI-RS. In one example, the UE or gNB can indicate to the network Td. In a further example, Td indicated by the UE or gNB can be from values configured by the network. In one example, Td depends on a UE capability. In one example, Td can be in units of symbols. In one example, Td can be in units of slots. In one example, Td can be in units of sub-frames. In one example, Td can be in units of frames. In one example, Td can be in units of time (e.g., millisecond, seconds, . . . ).

In one example, the UE transmits a request to the network, and in response the network transmits a DL channel or signal that triggers a report from the UE. In one example, the request, as aforementioned, is transmitted on UCI (e.g., scheduling request-SR). In one example, the request is transmitted using MAC CE. In one example, the channel or signal, from the gNB, that triggers the report from the UE is a PDCCH, e.g., a DCI format transmitted in a PDCCH. In one example, the channel or signal, from the gNB, that triggers the report from the UE is a PDSCH, e.g., a MAC CE transmitted in a PDSCH. In one example, the channel or signal, from the gNB, that triggers the report from the UE (e.g., a DCI format) indicates the resources to be used for the report. In a variant example, the UE sends a pre-notification message that is followed by a report from the UE with no trigger from the network as aforementioned.

After the channel or signal, from the gNB, that triggers the report from the UE (e.g., a DCI format), the UE transmits the report.
In one example, with reference to FIG. 33A, the report is aperiodic and the aperiodic report is one shot shown.
In one example, with reference to FIG. 33B, the report is aperiodic and the aperiodic report is repeated N times with a periodicity P. In one example, N and/or P can be specified in the system specification, and/or configured by RRC signaling and/or MAC CE signaling and/or L1 control signaling. In one example, N and/or P can be indicated in the channel or signal that triggers the report (e.g., a DCI Format). In a further example, N and/or P indicated in the channel or signal that triggers the report can be from values configured by the network. In one example, the UE can indicate to the network N and/or P for example in the request message or separate from the request message. In a further example, N and/or P indicated by the UE can be from values configured by the network.
In one example, the report is aperiodic and the aperiodic report is repeated a number of times within a period Tn with a periodicity P. In one example, Tn and/or P can be specified in the system specification, and/or configured by RRC signaling and/or MAC CE signaling and/or L1 control signaling. In one example, Tn and/or P can be indicated in the channel or signal that triggers the report (e.g., a DCI Format). In a further example, Tn and/or P indicated in the channel or signal that triggers the report can be from values configured by the network. In one example, the UE can indicate to the network Tn and/or P for example in the request message or separate from the request message. In a further example, Tn and/or P indicated by the UE can be from values configured by the network.
In one example, with reference to FIG. 33C, the report is semi-persistent and the semi-persistent (SP) report is repeated (e.g., until deactivated) with a periodicity P. In one example, P can be specified in the system specification, and/or configured by RRC signaling and/or MAC CE signaling and/or L1 control signaling. In one example, P can be indicated in the channel or signal that triggers the report (e.g., a DCI Format). In a further example, P indicated in the channel or signal that triggers the report can be from values configured by the network. In one example, the UE can indicate to the network P for example in the request message or separate from the request message. In a further example, P indicated by the UE can be from values configured by the network. In one example, the deactivation of the SP report can be requested/indicated by the UE, e.g., the UE sends a request to the network to deactivate the SP report. In one example, the deactivation of the SP report can be by the network, the network can send a signal/channel to indicate the deactivation of the SP report.

In one example, the channel or signal that triggers the report (e.g., a DCI format) is transmitted after a period T1 (or a period that is greater than T1 or a period that is greater than or equal to T1). In one example, T1 is from the start of the channel or signal with the request. In one example, T1 is from the end of channel or signal with the request. In one example T1, is to the start of the channel or signal that triggers the report (e.g., a DCI format). In one example T1, is to the end of the channel or signal that triggers the report (e.g., a DCI format)). In one example T1, is to the start of the slot/subframe/frame containing the channel or signal that triggers the report (e.g., a DCI format). In one example T1, is to the end of the slot/subframe/frame containing the channel or signal that triggers the report (e.g., a DCI format). In one example, T1 is specified by system specifications and/or configured or updated by RRC signaling and/or MAC CE signaling and/or L1 control (e.g., DCI Format) signaling. In one example T1, depends on the sub-carrier spacing of the signal/channel of the request and/or the channel or signal that triggers the report (e.g., a DCI format) and/or the report from the UE. In one example, T1 depends on the minimum (smallest) sub-carrier spacing of the signal/channel of the request and/or the channel or signal that triggers the report (e.g., a DCI format) and/or the report from the UE. In one example, T1 depends on the maximum (largest) sub-carrier spacing of the signal/channel of the request and/or the channel or signal that triggers the report (e.g., a DCI format) and/or the report from the UE. In one example, the UE can indicate to the network T1 for example in the request message or separate from the request message. In a further example, T1 indicated by the UE can be from values configured by the network. In one example, T1 depends on a UE capability. In one example, T1 can be in units of symbols. In one example, T1 can be in units of slots. In one example, T1 can be in units of sub-frames. In one example, T1 can be in units of frames. In one example, T1 can be in units of time (e.g., millisecond, seconds, . . . ). In one example, if the UE doesn't receive a channel or signal that triggers the report (e.g., a DCI format) at time T1 as aforementioned, the UE can retransmit the request.

In one example, the gNB transmits the channel or signal that triggers the report (e.g., a DCI format) at or after time T1 in a symbol or slot or sub-frame or frame that satisfies a condition. For example, the condition can be: the first time unit at or after T1 with a time unit number (or index) % M=O, or alternatively the condition can be: the first time unit at or after T1 with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In one example, the first report is transmitted after a period T2 (or a period that is greater than T2 or a period that is greater than or equal to T2). In one example, T2 is from the start of the channel or signal that triggers the report (e.g., a DCI format). In one example, T2 is from the end of channel or signal that triggers the report (e.g., a DCI format). In one example, T2 is from the start of the channel or signal that contains the acknowledgment of the channel or signal that triggers the report (e.g., a DCI format). In one example, T2 is from the end of channel or signal that contains the acknowledgment of the channel or signal that triggers the report (e.g., a DCI format). In one example T2, is to the start of the report (e.g., first instance of the report). In one example T2, is to the end of the report (e.g., first instance of the report). In one example T2, is to the start of the slot/subframe/frame containing the report (e.g., first instance of the report). In one example T2, is to the end of the slot/subframe/frame containing the report (e.g., first instance of the report). In one example, T2 is specified by system specifications and/or configured or updated by RRC signaling and/or MAC CE signaling and/or L1 control (e.g., DCI Format) signaling. In one example T2, depends on the sub-carrier spacing of the signal/channel of the request and/or the channel or signal that triggers the report (e.g., a DCI format) and/or the report from the UE. In one example, T2 depends on the minimum (smallest) sub-carrier spacing of the signal/channel of the request and/or the channel or signal that triggers the report (e.g., a DCI format) and/or the report from the UE. In one example, T2 depends on the maximum (largest) sub-carrier spacing of the signal/channel of the request and/or the channel or signal that triggers the report (e.g., a DCI format) and/or the report from the UE. In one example, T2 can be indicated in the channel or signal that triggers the report (e.g., a DCI Format). In a further example, T2 indicated in the channel or signal that triggers the report can be from values configured by the network. In one example, the UE can indicate to the network T2 for example in the request message or separate from the request message. In a further example, T2 indicated by the UE can be from values configured by the network. In one example, T2 depends on a UE capability. In one example, T2 can be in units of symbols. In one example, T2 can be in units of slots. In one example, T2 can be in units of sub-frames. In one example, T2 can be in units of frames. In one example, T2 can be in units of time (e.g., millisecond, seconds, . . . ).

In one example, the UE transmits the report at or after time T2 in a symbol or slot or sub-frame or frame that satisfies a condition. For example, the condition can be: the first time unit at or after T2 with a time unit number (or index) % M=O, or alternatively the condition can be: the first time unit at or after T2 with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In a variant example of the examples herein, T2 can be replaced by T3, where T3 is time between be the channel or signal with the request and the first report instance. The examples herein can apply to T3.

In one example, for a SP report, the UE transmits a signal/channel to deactivate the SP report. In one example, for a SP report, the gNB transmits a signal/channel to deactivate the SP report. In one example, the report is deactivated after a period Td (or a period that is greater than Td or a period that is greater than or equal to Td) from the UE signal/channel or from the gNB signal/channel. In one example, Td is from the start of the UE signal/channel or the gNB signal/channel. In one example, Td is from the end of the UE signal/channel or the gNB signal/channel. In one example Td, depends on the sub-carrier spacing of the UE signal/channel and/or the gNB signal/channel and/or report. In one example, Td depends on the minimum (smallest) sub-carrier spacing of the UE signal/channel and/or the gNB signal/channel and/or report. In one example, Td depends on the maximum (largest) sub-carrier spacing of the UE signal/channel and/or the gNB signal/channel and/or report. In one example, the UE or gNB can indicate to the network Td. In a further example, Td indicated by the UE or gNB can be from values configured by the network. In one example, Td depends on a UE capability. In one example, Td can be in units of symbols. In one example, Td can be in units of slots. In one example, Td can be in units of sub-frames. In one example, Td can be in units of frames. In one example, Td can be in units of time (e.g., millisecond, seconds, . . . ).

In one example, the UE transmits a request to the network, and in response the network transmits a DL channel or signal that indicates or triggers CSI-RS and triggers a report from the UE. The DL channel or signal that indicates or triggers CSI-RS and triggers a report from the UE is referred to as the “trigger” for brevity. In one example, the request, as aforementioned, is transmitted on UCI (e.g., scheduling request-SR). In one example, the request is transmitted using MAC CE. In one example, the trigger is transmitted in a PDCCH, e.g., a DCI format transmitted in a PDCCH. In one example, the trigger is transmitted in a PDSCH, e.g., a MAC CE transmitted in a PDSCH.

After the trigger, the network transmits CSI-RS and the UE transmits the report.
In one example, with reference to FIG. 34A, the CSI-RS is aperiodic (AP) CSI-RS and the AP-CSI-RS is one shot as shown.
In one example, with reference to FIG. 34A, the report is aperiodic and the aperiodic report is one shot as shown.

In one example, with reference to FIG. 34B, the CSI-RS is aperiodic (AP) CSI-RS and the AP-CSI-RS is repeated N1 times with a periodicity P1. In one example, N1 and/or P1 can be specified in the system specification, and/or configured by RRC signaling and/or MAC CE signaling and/or L1 control signaling. In one example, N1 and/or P1 can be indicated in the channel or signal that triggers or indicates CSI-RS (e.g., a DCI Format). In a further example, N1 and/or P1 indicated in the channel or signal that triggers or indicates CSI-RS can be from values configured by the network. In one example, the UE (e.g., the UE 116) can indicate to the network (e.g., the network 130) N1 and/or P1 for example in the request message or separate from the request message. In a further example, N1 and/or P1 indicated by the UE can be from values configured by the network.
In one example, with reference to FIG. 34B, the report is aperiodic and the aperiodic report is repeated N2 times with a periodicity P2. In one example, N2 and/or P2 can be specified in the system specification, and/or configured by RRC signaling and/or MAC CE signaling and/or L1 control signaling. In one example, N2 and/or P2 can be indicated in the channel or signal that triggers the report (e.g., a DCI Format). In a further example, N2 and/or P2 indicated in the channel or signal that triggers the report can be from values configured by the network. In one example, the UE can indicate to the network N2 and/or P2 for example in the request message or separate from the request message. In a further example, N2 and/or P2 indicated by the UE can be from values configured by the network. In one example, N2=N1. In one example, P2=P1.
In one example, the CSI-RS is aperiodic (AP) CSI-RS and the AP-CSI-RS is repeated a number of times within a period Tn1 with a periodicity P1. In one example, Tn1 and/or P1 can be specified in the system specification, and/or configured by RRC signaling and/or MAC CE signaling and/or L1 control signaling. In one example, Tn1 and/or P1 can be indicated in the channel or signal that triggers or indicates CSI-RS (e.g., a DCI Format). In a further example, Tn1 and/or P1 indicated in the channel or signal that triggers or indicates CSI-RS can be from values configured by the network. In one example, the UE can indicate to the network Tn1 and/or P1 for example in the request message or separate from the request message. In a further example, Tn1 and/or P1 indicated by the UE can be from values configured by the network.
In one example, the report is aperiodic and the aperiodic report is repeated a number of times within a period Tn2 with a periodicity P2. In one example, Tn2 and/or P2 can be specified in the system specification, and/or configured by RRC signaling and/or MAC CE signaling and/or L1 control signaling. In one example, Tn2 and/or P2 can be indicated in the channel or signal that triggers the report (e.g., a DCI Format). In a further example, Tn2 and/or P2 indicated in the channel or signal that triggers the report can be from values configured by the network. In one example, the UE can indicate to the network Tn2 and/or P2 for example in the request message or separate from the request message. In a further example, Tn2 and/or P2 indicated by the UE can be from values configured by the network. In one example, Tn2-Tn1. In one example P2=P1.
In one example, with reference to FIG. 34C, the CSI-RS is semi-persistent (SP) CSI-RS and the SP-CSI-RS is repeated (e.g., until deactivated) with a periodicity P1. In one example, P1 can be specified in the system specification, and/or configured by RRC signaling and/or MAC CE signaling and/or L1 control signaling. In one example, P1 can be indicated in the channel or signal that triggers or indicates CSI-RS (e.g., a DCI Format). In a further example, P1 indicated in the channel or signal that triggers or indicates CSI-RS can be from values configured by the network. In one example, the UE can indicate to the network P1 for example in the request message or separate from the request message. In a further example, P1 indicated by the UE can be from values configured by the network. In one example, the deactivation of the SP CSI-RS can be requested by the UE, e.g., the UE sends a request to the network to deactivate the SP CSI-RS. In one example, the deactivation of the SP CSI-RS can be by the network, the network can send a signal/channel to indicate the deactivation of the SP CSI-RS.
In one example, with reference to FIG. 34C, the report is semi-persistent and the semi-persistent (SP) report is repeated (e.g., until deactivated) with a periodicity P2. In one example, P2 can be specified in the system specification, and/or configured by RRC signaling and/or MAC CE signaling and/or L1 control signaling. In one example, P2 can be indicated in the channel or signal that triggers the report (e.g., a DCI Format). In a further example, P2 indicated in the channel or signal that triggers the report can be from values configured by the network. In one example, the UE can indicate to the network P2 for example in the request message or separate from the request message. In a further example, P2 indicated by the UE can be from values configured by the network. In one example, P2=P1. In one example, the deactivation of the SP report can be requested by the UE, e.g., the UE sends a request to the network to deactivate the SP report. In one example, the deactivation of the SP report can be by the network, the network can send a signal/channel to indicate the deactivation of the SP report. In one example, the deactivation of the SP CSI-RS and SP report can be requested by the UE in same message. In one example, the deactivation of the SP CSI-RS and SP report can be requested by the UE in different messages. In one example, the deactivation of the SP CSI-RS and SP report can be indicated by the network in same message. In one example, the deactivation of the SP CSI-RS and SP report can be indicated by the network in different messages.

With reference to FIG. 34, a one shot aperiodic CSI-RS paired with a one shot aperiodic report, and an N shot aperiodic CSI-RS paired with an N shot aperiodic report, and a semi-persistent CSI-RS paired with a semi-persistent report is shown. This is just an example, any CSI-RS time configuration (e.g., one shot aperiodic, N shot aperiodic, aperiodic within time period Tn, or semi-persistent) can be associated or paired with any report time configuration (e.g., one shot aperiodic, N shot aperiodic, aperiodic within time period Tn, or semi-persistent). For example,
N shot CSI-RS can be associated or paired with a one shot aperiodic report, for example the report can be after N instances of CSI-RS.
CSI-RS instances transmitted within a time period Tn can be associated or paired with a one shot aperiodic report, e.g., after the CSI-RS instances.
Semi-persistent CSI-RS can be associated or paired with a one shot aperiodic report, or N shot report or multiple reports transmitted within a period N.

In one example, N1=N2.

In one example, N1 and N2 can be different. In one example N2≤N1. In one example, N2<N1. In one example N1≤N2. In one example, N1<N2.

In one example, P1=P2.

In one example, P1 and P2 can be different. In one example P1≤P2. In one example, P1<P2. In one example P2≤P1. In one example, P2<P1.

In one example, the trigger is transmitted after a period T1 (or a period that is greater than T1 or a period that is greater than or equal to T1). In one example, T1 is from the start of the channel or signal with the request. In one example, T1 is from the end of channel or signal with the request. In one example T1, is to the start of the channel or signal of the trigger. In one example T1, is to the end of the channel or signal of the trigger. In one example T1, is to the start of the slot/subframe/frame containing the channel or signal of the trigger. In one example T1, is to the end of the slot/subframe/frame containing the channel or signal of the trigger. In one example, T1 is specified by system specifications and/or configured or updated by RRC signaling and/or MAC CE signaling and/or L1 control (e.g., DCI Format) signaling. In one example T1, depends on the sub-carrier spacing of the signal/channel of the request and/or the channel or signal of the trigger and/or the CSI-RS and/or the report from the UE. In one example, T1 depends on the minimum (smallest) sub-carrier spacing of the signal/channel of the request and/or the channel or signal of the trigger and/or the CSI-RS and/or the report from the UE. In one example, T1 depends on the maximum (largest) sub-carrier spacing of the signal/channel of the request and/or the channel or signal of the trigger and/or the CSI-RS and/or the report from the UE. In one example, the UE can indicate to the network T1 for example in the request message or separate from the request message. In a further example, T1 indicated by the UE can be from values configured by the network. In one example, T1 depends on a UE capability. In one example, T1 can be in units of symbols. In one example, T1 can be in units of slots. In one example, T1 can be in units of sub-frames. In one example, T1 can be in units of frames. In one example, T1 can be in units of time (e.g., millisecond, seconds, . . . ). In one example, if the UE doesn't receive a trigger at time T1 as aforementioned, the UE can retransmit the request.

In one example, the gNB transmits the channel or signal of the trigger at or after time T1 in a symbol or slot or sub-frame or frame that satisfies a condition. For example, the condition can be: the first time unit at or after T1 with a time unit number (or index) % M=O, or alternatively the condition can be: the first time unit at or after T1 with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In one example, the first CSI-RS is transmitted after a period T2 (or a period that is greater than T2 or a period that is greater than or equal to T2). In one example, T2 is from the start of the channel or signal of the trigger. In one example, T2 is from the end of channel or signal of the trigger. In one example, T2 is from the start of the channel or signal that contains the acknowledgment of the channel or signal of the trigger. In one example, T2 is from the end of channel or signal that contains the acknowledgment of the channel or signal of the trigger. In one example T2, is to the start of the CSI-RS (e.g., first instance of CSI-RS). In one example T2, is to the end of the CSI-RS (e.g., first instance of CSI-RS). In one example T2, is to the start of the slot/subframe/frame containing the CSI-RS (e.g., first instance of CSI-RS). In one example T2, is to the end of the slot/subframe/frame containing the CSI-RS (e.g., first instance of CSI-RS). In one example, T2 is specified by system specifications and/or configured or updated by RRC signaling and/or MAC CE signaling and/or L1 control (e.g., DCI Format) signaling. In one example T2, depends on the sub-carrier spacing of the signal/channel of the request and/or the channel or signal of the trigger and/or the CSI-RS and/or the report from the UE. In one example, T2 depends on the minimum (smallest) sub-carrier spacing of the signal/channel of the request and/or the channel or signal of the trigger and/or the CSI-RS and/or the report from the UE. In one example, T2 depends on the maximum (largest) sub-carrier spacing of the signal/channel of the request and/or the channel or signal of the trigger and/or the CSI-RS and/or the report from the UE. In one example, T2 can be indicated in the channel or signal of the trigger. In a further example, T2 indicated in the channel or signal of the trigger can be from values configured by the network. In one example, the UE can indicate to the network T2 for example in the request message or separate from the request message. In a further example, T2 indicated by the UE can be from values configured by the network. In one example, T2 depends on a UE capability. In one example, T2 can be in units of symbols. In one example, T2 can be in units of slots. In one example, T2 can be in units of sub-frames. In one example, T2 can be in units of frames. In one example, T2 can be in units of time (e.g., millisecond, seconds, . . . ).

In one example, the gNB transmits CSI-RS at or after time T2 in a symbol or slot or sub-frame or frame that satisfies a condition. For example, the condition can be: the first time unit at or after T2 with a time unit number (or index) % M=O, or alternatively the condition can be: the first time unit at or after T2 with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In a variant example of the examples herein, T2 can be replaced by T4, where T4 is time between be the channel or signal with the request and the first CSI-RS instance. The examples herein can apply to T4.

In one example, the first report is transmitted after a period T3 (or a period that is greater than T3 or a period that is greater than or equal to T3). In one example, T3 is from the start of the channel or signal of the trigger. In one example, T3 is from the end of channel or signal of the trigger. In one example, T3 is from the start of the channel or signal that contains the acknowledgment of the channel or signal of the trigger. In one example, T3 is from the end of channel or signal that contains the acknowledgment of the channel or signal of the trigger. In one example T3, is to the start of the report (e.g., first instance of the report). In one example T3, is to the end of the report (e.g., first instance of the report). In one example T3, is to the start of the slot/subframe/frame containing the report (e.g., first instance of the report). In one example T3, is to the end of the slot/subframe/frame containing the report (e.g., first instance of the report). In one example, T3 is specified by system specifications and/or configured or updated by RRC signaling and/or MAC CE signaling and/or L1 control (e.g., DCI Format) signaling. In one example T3, depends on the sub-carrier spacing of the signal/channel of the request and/or the channel or signal of the trigger and/or the report from the UE and/or the CSI-RS. In one example, T3 depends on the minimum (smallest) sub-carrier spacing of the signal/channel of the request and/or the channel or signal of the trigger and/or the report from the UE and/or the CSI-RS. In one example, T3 depends on the maximum (largest) sub-carrier spacing of the signal/channel of the request and/or the channel or signal of the trigger and/or the report from the UE and/or CSI-RS. In one example, T3 can be indicated in the channel or signal of the trigger. In a further example, T3 indicated in the channel or signal of the trigger can be from values configured by the network. In one example, the UE can indicate to the network T3 for example in the request message or separate from the request message. In a further example, T3 indicated by the UE can be from values configured by the network. In one example, T3 depends on a UE capability. In one example, T3 can be in units of symbols. In one example, T3 can be in units of slots. In one example, T3 can be in units of sub-frames. In one example, T3 can be in units of frames. In one example, T2 can be in units of time (e.g., millisecond, seconds, . . . ).

In one example, the UE transmits the report at or after time T3 in a symbol or slot or sub-frame or frame that satisfies a condition. For example, the condition can be: the first time unit at or after T3 with a time unit number (or index) % M=O, or alternatively the condition can be: the first time unit at or after T3 with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame, or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point. In one example, T3>T2.

In a variant example of the examples herein, T3 can be replaced by T5, where T5 is time between be the channel or signal with the request and the first report instance. The examples herein can apply to T5. In one example, T5>T4.

In a variant example of the examples herein, T3 can be replaced by T6, where T6 is time between a CSI-RS and a corresponding channel or signal of a report. The examples herein can apply to T6.

In one example there is a report instance every M CSI-RS instances, wherein a report includes information based on M instances of CSI-RS (e.g., the previous M instances of CSI-RS, or the previous M instances of CSI-RS talking into account the latency (e.g., processing latency) between a CSI-RS and a report). Wherein, M can be specified in the system specifications and/or configured or updated by RRC signaling and/or MAC CE signaling and/or L1 control (e.g., DCI Format) signaling and/or indicated by the UE.

In one example, for a SP CSI-RS and/or SP report, the UE transmits a signal/channel to deactivate the SP CSI-RS and/or SP report. In one example, for a SP CSI-RS and/or SP report, the gNB transmits a signal/channel to deactivate the SP CSI-RS and/or SP report. In one example, the CSI-RS and/or report is deactivated after a period Td (or a period that is greater than Td or a period that is greater than or equal to Td) from the UE signal/channel or from the gNB signal/channel. In one example, Td is from the start of the UE signal/channel or the gNB signal/channel. In one example, Td is from the end of the UE signal/channel or the gNB signal/channel. In one example Td, depends on the sub-carrier spacing of the UE signal/channel and/or the gNB signal/channel and/or CSI-RS and/or report. In one example, Td depends on the minimum (smallest) sub-carrier spacing of the UE signal/channel and/or the gNB signal/channel and/or CSI-RS and/or report. In one example, Td depends on the maximum (largest) sub-carrier spacing of the UE signal/channel and/or the gNB signal/channel and/or CSI-RS and/or report. In one example, the UE or gNB can indicate to the network Td. In a further example, Td indicated by the UE or gNB can be from values configured by the network. In one example, Td depends on a UE capability. In one example, Td can be in units of symbols. In one example, Td can be in units of slots. In one example, Td can be in units of sub-frames. In one example, Td can be in units of frames. In one example, Td can be in units of time (e.g., millisecond, seconds, . . . ).

In one example, the UE transmits a request to the network, and in response the network transmits a DL channel or signal that triggers a reference signal (e.g., SRS) from the UE. In one example, the request, as aforementioned, is transmitted on UCI (e.g., scheduling request-SR). In one example, the request is transmitted using MAC CE. In one example, the channel or signal, from the gNB, that triggers the reference signal (e.g., SRS) from the UE is a PDCCH, e.g., a DCI format transmitted in a PDCCH. In one example, the channel or signal, from the gNB, that triggers the reference signal (e.g., SRS) from the UE is a PDSCH, e.g., a MAC CE transmitted in a PDSCH. In one example, the channel or signal, from the gNB, that triggers the reference signal (e.g., SRS) from the UE (e.g., a DCI format) indicates the resources to be used for the report. In a variant example, the UE sends a pre-notification message that is followed by a reference signal (e.g., SRS) from the UE with no trigger from the network as aforementioned.

After the channel or signal, from the gNB, that triggers the reference signal (e.g., SRS) from the UE (e.g., a DCI format), the UE transmits the reference signal (e.g., SRS).
In one example, with reference to FIG. 35A, the reference signal (e.g., SRS) is aperiodic and the aperiodic reference signal (e.g., aperiodic SRS) is one shot as shown.
In one example, with reference to FIG. 35B, the reference signal (e.g., SRS) is aperiodic and the aperiodic reference signal (e.g., aperiodic SRS) is repeated N times with a periodicity P. In one example, N and/or P can be specified in the system specification, and/or configured by RRC signaling and/or MAC CE signaling and/or L1 control signaling. In one example, N and/or P can be indicated in the channel or signal that triggers the reference signal (e.g., SRS) (e.g., a DCI Format). In a further example, N and/or P indicated in the channel or signal that triggers the reference signal (e.g., SRS) can be from values configured by the network. In one example, the UE can indicate to the network N and/or P for example in the request message or separate from the request message. In a further example, N and/or P indicated by the UE can be from values configured by the network.
In one example, the reference signal (e.g., SRS) is aperiodic and the aperiodic reference signal (e.g., aperiodic SRS) is repeated a number of times within a period Tn with a periodicity P. In one example, Tn and/or P can be specified in the system specification, and/or configured by RRC signaling and/or MAC CE signaling and/or L1 control signaling. In one example, Tn and/or P can be indicated in the channel or signal that triggers the reference signal (e.g., SRS) (e.g., a DCI Format). In a further example, Tn and/or P indicated in the channel or signal that triggers the reference signal (e.g., SRS) can be from values configured by the network. In one example, the UE can indicate to the network Tn and/or P for example in the request message or separate from the request message. In a further example, Tn and/or P indicated by the UE can be from values configured by the network.
In one example, with reference to FIG. 35C, the reference signal (e.g., SRS) is semi-persistent and the semi-persistent (SP) reference signal (e.g., SP-SRS) is repeated (e.g., until deactivated) with a periodicity P. In one example, P can be specified in the system specification, and/or configured by RRC signaling and/or MAC CE signaling and/or L1 control signaling. In one example, P can be indicated in the channel or signal that triggers the reference signal (e.g., SRS) (e.g., a DCI Format). In a further example, P indicated in the channel or signal that triggers the reference signal (e.g., SRS) can be from values configured by the network. In one example, the UE can indicate to the network P for example in the request message or separate from the request message. In a further example, P indicated by the UE can be from values configured by the network. In one example, the deactivation of the SP reference signal (e.g., SRS) can be requested/indicated by the UE, e.g., the UE sends a request to the network to deactivate the SP reference signal (e.g., SRS). In one example, the deactivation of the SP reference signal (e.g., SRS) can be by the network, the network can send a signal/channel to indicate the deactivation of the SP reference signal (e.g., SRS).

In one example, the channel or signal that triggers the reference signal (e.g., SRS) (e.g., a DCI format) is transmitted after a period T1 (or a period that is greater than T1 or a period that is greater than or equal to T1). In one example, T1 is from the start of the channel or signal with the request. In one example, T1 is from the end of channel or signal with the request. In one example T1, is to the start of the channel or signal that triggers the reference signal (e.g., SRS) (e.g., a DCI format). In one example T1, is to the end of the channel or signal that triggers the reference signal (e.g., SRS) (e.g., a DCI format)). In one example T1, is to the start of the slot/subframe/frame containing the channel or signal that triggers the reference signal (e.g., SRS) (e.g., a DCI format). In one example T1, is to the end of the slot/subframe/frame containing the channel or signal that triggers the reference signal (e.g., SRS) (e.g., a DCI format). In one example, T1 is specified by system specifications and/or configured or updated by RRC signaling and/or MAC CE signaling and/or L1 control (e.g., DCI Format) signaling. In one example T1, depends on the sub-carrier spacing of the signal/channel of the request and/or the channel or signal that triggers the reference signal (e.g., SRS) (e.g., a DCI format) and/or the reference signal (e.g., SRS) from the UE. In one example, T1 depends on the minimum (smallest) sub-carrier spacing of the signal/channel of the request and/or the channel or signal that triggers the reference signal (e.g., SRS) (e.g., a DCI format) and/or the reference signal (e.g., SRS) from the UE. In one example, T1 depends on the maximum (largest) sub-carrier spacing of the signal/channel of the request and/or the channel or signal that triggers the reference signal (e.g., SRS) (e.g., a DCI format) and/or the reference signal (e.g., SRS) from the UE. In one example, the UE can indicate to the network T1 for example in the request message or separate from the request message. In a further example, T1 indicated by the UE can be from values configured by the network. In one example, T1 depends on a UE capability. In one example, T1 can be in units of symbols. In one example, T1 can be in units of slots. In one example, T1 can be in units of sub-frames. In one example, T1 can be in units of frames. In one example, T1 can be in units of time (e.g., millisecond, seconds, . . . ). In one example, if the UE doesn't receive a channel or signal that triggers the reference signal (e.g., SRS) (e.g., a DCI format) at time T1 as aforementioned, the UE can retransmit the request.

In one example, the gNB transmits the channel or signal that triggers the reference signal (e.g., SRS) (e.g., a DCI format) at or after time T1 in a symbol or slot or sub-frame or frame that satisfies a condition. For example, the condition can be: the first time unit at or after T1 with a time unit number (or index) % M=O, or alternatively the condition can be: the first time unit at or after T1 with (time unit number (or index)+O) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In one example, the first reference signal (e.g., first SRS) is transmitted after a period T2 (or a period that is greater than T2 or a period that is greater than or equal to T2). In one example, T2 is from the start of the channel or signal that triggers the reference signal (e.g., SRS) (e.g., a DCI format). In one example, T2 is from the end of channel or signal that triggers the reference signal (e.g., SRS) (e.g., a DCI format). In one example, T2 is from the start of the channel or signal that contains the acknowledgment of the channel or signal that triggers the reference signal (e.g., SRS) (e.g., a DCI format). In one example, T2 is from the end of channel or signal that contains the acknowledgment of the channel or signal that triggers the reference signal (e.g., SRS) (e.g., a DCI format). In one example T2, is to the start of the reference signal (e.g., SRS) (e.g., first instance of the reference signal (e.g., SRS)). In one example T2, is to the end of the reference signal (e.g., SRS) (e.g., first instance of the reference signal (e.g., SRS)). In one example T2, is to the start of the slot/subframe/frame containing the reference signal (e.g., SRS) (e.g., first instance of the reference signal (e.g., SRS)). In one example T2, is to the end of the slot/subframe/frame containing the reference signal (e.g., SRS) (e.g., first instance of the reference signal (e.g., SRS)). In one example, T2 is specified by system specifications and/or configured or updated by RRC signaling and/or MAC CE signaling and/or L1 control (e.g., DCI Format) signaling. In one example T2, depends on the sub-carrier spacing of the signal/channel of the request and/or the channel or signal that triggers the reference signal (e.g., SRS) (e.g., a DCI format) and/or the reference signal (e.g., SRS) from the UE. In one example, T2 depends on the minimum (smallest) sub-carrier spacing of the signal/channel of the request and/or the channel or signal that triggers the reference signal (e.g., SRS) (e.g., a DCI format) and/or the reference signal (e.g., SRS) from the UE. In one example, T2 depends on the maximum (largest) sub-carrier spacing of the signal/channel of the request and/or the channel or signal that triggers the reference signal (e.g., SRS) (e.g., a DCI format) and/or the reference signal (e.g., SRS) from the UE. In one example, T2 can be indicated in the channel or signal that triggers the reference signal (e.g., SRS) (e.g., a DCI Format). In a further example, T2 indicated in the channel or signal that triggers the reference signal (e.g., SRS) can be from values configured by the network. In one example, the UE can indicate to the network T2 for example in the request message or separate from the request message. In a further example, T2 indicated by the UE can be from values configured by the network. In one example, T2 depends on a UE capability. In one example, T2 can be in units of symbols. In one example, T2 can be in units of slots. In one example, T2 can be in units of sub-frames. In one example, T2 can be in units of frames. In one example, T2 can be in units of time (e.g., millisecond, seconds, . . . ).

In one example, the UE (e.g., the UE 116) transmits the reference signal (e.g., SRS) at or after time T2 in a symbol or slot or sub-frame or frame that satisfies a condition. For example, the condition can be: the first time unit at or after T2 with a time unit number (or index) % M=O, or alternatively the condition can be: the first time unit at or after T2 with (time unit number (or index)+0) % M=0. Wherein M and/or O can be specified in the system specification and/or configured or updated by RRC signaling and/or MAC CE signaling and/or L1 control (e.g., DCI Format) signaling and/or indicated by the UE. A time unit can be, for example, a symbol, a slot, a sub-frame or a frame or multiple of these, and a time unit number or index is the number of the time unit counted from a reference point, the time unit number or index at or just after the reference point is 0 and is incremented by 1 for every time unit after that. A reference point can be a start of slot or a start of a subframe or a start of a frame or a SFN roll-over point.

In a variant example of the examples herein, T2 can be replaced by T3, where T3 is time between be the channel or signal with the request and the first reference signal (e.g., first SRS) instance. The examples herein can apply to T3.

In one example, for a SP reference signal (e.g., SRS), the UE transmits a signal/channel to deactivate the SP reference signal (e.g., SRS). In one example, for a SP reference signal (e.g., SRS), the gNB transmits a signal/channel to deactivate the SP reference signal (e.g., SRS). In one example, the reference signal (e.g., SRS) is deactivated after a period Td (or a period that is greater than Td or a period that is greater than or equal to Td) from the UE signal/channel or from the gNB signal/channel. In one example, Td is from the start of the UE signal/channel or the gNB signal/channel. In one example, Td is from the end of the UE signal/channel or the gNB signal/channel. In one example Td, depends on the sub-carrier spacing of the UE signal/channel and/or the gNB signal/channel and/or reference signal (e.g., SRS). In one example, Td depends on the minimum (smallest) sub-carrier spacing of the UE signal/channel and/or the gNB signal/channel and/or reference signal (e.g., SRS). In one example, Td depends on the maximum (largest) sub-carrier spacing of the UE signal/channel and/or the gNB signal/channel and/or reference signal (e.g., SRS). In one example, the UE or gNB can indicate to the network Td. In a further example, Td indicated by the UE or gNB can be from values configured by the network. In one example, Td depends on a UE capability. In one example, Td can be in units of symbols. In one example, Td can be in units of slots. In one example, Td can be in units of sub-frames. In one example, Td can be in units of frames. In one example, Td can be in units of time (e.g., millisecond, seconds, . . . ).

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
transmit a first uplink (UL) signal,
receive, in response to the first UL signal, a first downlink (DL) signal indicating resources for a second DL signal and a second UL signal, and
receive the second DL signal based on the indicated resources for the second DL signal; and
a processor operably coupled to the transceiver, the processor configured to:
measure the second DL signal, and
determine a report based on the measurement,
wherein the transceiver is further configured to transmit the report based on the indicated resources for the second UL signal, and
wherein the second UL signal is a physical UL shared channel (PUSCH) or a physical uplink control channel (PUCCH).

2. The UE of claim 1, wherein the first UL signal is a PUCCH with format 0 or a PUCCH with format 1.

3. The UE of claim 1, wherein:
the first DL signal is a physical DL control channel (PDCCH) carrying a DL control information (DCI) format, and
the DCI format includes at least one of:
an indication of a transmission time of the second DL signal, and
an indication of a transmission time of the second UL signal.

4. The UE of claim 1, wherein the second DL signal is a channel state information reference signal (CSI-RS).

5. The UE of claim 1, wherein;
the transceiver is further configured to:
transmit a third UL signal, and
transmit a fourth UL signal based on the third UL signal, and
the fourth UL signal is a sounding reference signal (SRS).

6. The UE of claim 1, wherein:
the transceiver is further configured to:
transmit a third UL signal,
receive, in response to the third UL signal, a third DL signal indicating resources for a fourth UL signal, and
transmit the fourth UL signal, and
the fourth UL signal is a sounding reference signal (SRS).

7. The UE of claim 6, wherein:
the third DL signal is a physical DL control channel (PDCCH) carrying a DL control information (DCI) format, and
the DCI format includes an indication of a transmission time of the fourth UL signal.

8. A base station (BS), comprising:
a transceiver configured to receive a first uplink (UL) signal; and
a processor operably coupled to the transceiver, the processor configured to determine, in response to the first UL signal, resources for a second downlink (DL) signal and a second UL signal,
wherein the transceiver is further configured to:
transmit a first DL signal indicating the resources for the second DL signal and the second UL signal,
transmit the second DL signal based on the indicated resources for the second DL signal, and
receive a report about the second DL signal based on the indicated resources for the second UL signal, and
wherein the second UL signal is a physical UL shared channel (PUSCH) or a physical uplink control channel (PUCCH).

9. The BS of claim 8, wherein the first UL signal is a PUCCH with format 0 or a PUCCH with format 1.

10. The BS of claim 8, wherein:
the first DL signal is a physical DL control channel (PDCCH) carrying a DL control information (DCI) format, and
the DCI format includes at least one of:
an indication of a transmission time of the second DL signal, and
an indication of a transmission time of the second UL signal.

11. The BS of claim 8, wherein the second DL signal is a channel state information reference signal (CSI-RS).

12. The BS of claim 8, wherein;
the transceiver is further configured to:
receive a third UL signal, and
receive a fourth UL signal based on the third UL signal, and
the fourth UL signal is a sounding reference signal (SRS).

13. The BS of claim 8, wherein:
the transceiver is further configured to receive a third UL signal,
the processor is further configured to determine, in response to the third UL signal, resources for a fourth UL signal, and
the transceiver is further configured to:
transmit a third DL signal indicating resources for the fourth UL signal, and
receive the fourth UL signal, and
the fourth UL signal is a sounding reference signal (SRS).

14. The BS of claim 13, wherein:
the third DL signal is a physical DL control channel (PDCCH) carrying a DL control information (DCI) format, and
the DCI format includes an indication of a transmission time of the fourth UL signal.

15. A method of operating a user equipment (UE), the method comprising:
transmitting a first uplink (UL) signal;
receiving, in response to the first UL signal, a first downlink (DL) signal indicating resources for a second DL signal, and a second UL signal;
receiving the second DL signal based on the indicated resources for the second DL signal;
measuring the second DL signal;
determining a report based on the measurement; and
transmitting the report based on the indicated resources for the second UL signal, wherein the second UL signal is a physical UL shared channel (PUSCH) or a physical uplink control channel (PUCCH).

16. The method of claim 15, wherein the first UL signal is a PUCCH with format 0 or a PUCCH with format 1.

17. The method of claim 15, wherein:
the first DL signal is a physical DL control channel (PDCCH) carrying a DL control information (DCI) format, and
the DCI format includes at least one of:
an indication of a transmission time of the second DL signal, and
an indication of a transmission time of the second UL signal.

18. The method of claim 15, wherein the second DL signal is a channel state information reference signal (CSI-RS).

19. The method of claim 15, further comprising:
transmitting a third UL signal; and
transmitting a fourth UL signal based on the third UL signal,
wherein the fourth UL signal is a sounding reference signal (SRS).

20. The method of claim 15, further comprising:
transmitting a third UL signal,
receiving, in response to the third UL signal, a third DL signal indicating resources for a fourth UL signal, and
transmitting the fourth UL signal,
wherein the fourth UL signal is a sounding reference signal (SRS).
